(19) United States
(12) Patent Application Publication
(10) Pub. No.: US 2025/0178495 A1
(43) Pub. Date: Jun. 5, 2025

(54) CONVEYANCE SEAT

(71) Applicant: TS TECH CO., LTD., Asaka-shi, Saitama (JP)

(72) Inventors: Kotaro TOMIOKA, Tochigi (JP); Sadahiro KINOSHITA, Tochigi (JP); Tsubasa HITOMI, Tochigi (JP)

(21) Appl. No.: 18/696,794

(22) PCT Filed: Sep. 27, 2022
(86) PCT No.: PCT/JP2022/036029

§ 371 Date: Dec. 23, 2024

Related U.S. Application Data
(60) Provisional application No. 63/261,811, filed on Sep. 29, 2021.
(60) Provisional application No. 63/261,887, filed on Sep. 30, 2021.
(60) Provisional application No. 63/270,008, filed on Oct. 20, 2021.
(60) Provisional application No. 63/263,244, filed on Oct. 29, 2021.

(30) Foreign Application Priority Data
Dec. 27, 2021 (JP) 2021-213382
Feb. 4, 2022 (JP) 2022-016635
Mar. 22, 2022 (JP) 2022-045917
May 13, 2022 (JP) 2022-079731

(51) Int. Cl. B60N 2/28; B60N 2/60

(52) U.S. Cl. CPC B60N 2/289; B60N 2/6018

(57) ABSTRACT

Provided is a conveyance seat provided with that includes a cover member configured to protect an anchor member to which an object-to-be-connected is connected, and has high attachment rigidity of the cover member. A conveyance seat S includes a cover member 50 configured to protect an anchor member 40 that extends from a seat main body to a seat forward side for connection with a child safety seat. The cover member 50 includes an outer cover 60 that is attached to the seat main body and covers the anchor member 40, and an inner cover 70 that is attached in a state of being accommodated inside the outer cover 60, and includes an anchor engagement portion 78 that engages with the anchor member 40. When the cover member 50 engages with the anchor member 40, an extension portion of the anchor member 40 which extends from the seat main body to a seat forward side is sandwiched between the outer cover 60 and the inner cover 70 in a seat width direction.

### TECHNICAL FIELD

The present invention relates a conveyance seat, and more particularly, to a conveyance seat including a cover member that protects an anchor member connecting an object to be connected (a child safety seat).

### BACKGROUND ART

In the related art, there are known vehicle seats including an anchor member (a tether anchor) that is attached to a seat frame (back frame) that is a skeleton of a seat main body, and extends from the back frame to a seat forward side for connection with the child safety seat. Among these, a vehicle seat that further includes a cover member that protects the anchor member from the outside is known.

Note that, as the vehicle seat capable of connecting the child safety seat, for example, in addition to a type in which the anchor member is attached to the seat frame, there is a type in which the anchor member is attached directly to a vehicle body frame that is a skeleton of a vehicle body (for example, refer to Patent Literature 1).

The conveyance seat described in Patent Literature 1 includes a cover member that protects an anchor member that extends from the vehicle body frame to a seat forward side for connection with the child safety seat.

The cover member is attached to the anchor member that passes through a lower end portion of the seat back from the seat forward side. In addition, the conveyance seat includes an outer cover that is attached to a lower end portion of the seat back and covers the anchor member, and an inner cover that is attached to the outer cover in a state of being accommodated inside the outer cover and includes an anchor engagement portion that engages with the anchor member.

In the above-described configuration, the cover member is attached to the seat back so that a part of a covering material of the conveyance seat (an outer peripheral portion of an opening hole formed on the covering material) is sandwiched between the inner cover and the outer cover. Therefore, the appearance of the periphery of the cover member becomes satisfactory.

### CITATION LIST

### Patent Literature

Patent Literature 1: JP 2018-79708 A

### SUMMARY OF INVENTION

### Technical Problem

By the way, in the conveyance seat including the cover member that protects the anchor member for connection with the child safety seat as in Patent Literature 1, in a state in which the cover member is attached to the seat frame (seat back) and the anchor member, it is required to increase attachment rigidity of the cover member so as to suppress the cover member from shaking while the conveyance is traveling.

In addition, there is a demand for a conveyance seat in which the cover member is easily attached while securing the experience of the periphery of the cover member.

The present invention has been made in consideration of the problem, and an object thereof is to provide a conveyance seat that includes a cover member that protects an anchor member for connection with an object to be connected, and is capable of increasing attachment rigidity of the cover member.

In addition, another object of the present invention is to provide a conveyance seat in which the cover member can be easily attached while securing the appearance of the periphery of the cover member that protects the anchor member.

### Solution to Problem

The problem is solved by the following conveyance seat of the present invention. Specifically, the conveyance seat includes a cover member that protects an anchor member extending from a conveyance main body or a seat main body to an outer side for connection with an object to be connected. The cover member includes an outer cover that is attached to the seat main body and covers the anchor member, and an inner cover that is attached to the outer cover in a state of being accommodated inside the outer cover, and includes an anchor engagement portion that engages with the anchor member. When the cover member engages with the anchor member, an extension portion of the anchor member which extends to an outer side from the conveyance main body or the seat main body is sandwiched between the outer cover and the inner cover.

According to the above-described configuration, it is possible to realize a conveyance seat that includes the cover member configured to protect the anchor member for connection with an object to be connected, and has high attachment rigidity of the cover member.

Specifically, when the cover member engages with the anchor member, since the extension portion of the anchor member which extends to an outer side from the conveyance main body or the seat main body is sandwiched between the outer cover and the inner cover, attachment rigidity of the cover member with respect to the anchor member can be raised as compared with the related art.

Note that, the anchor member may be attached to the seat main body or may be attached to the conveyance main body.

At this time, the cover member may be configured to protect the anchor member that extends from the conveyance main body or the seat main body to a seat forward side for connection with a child safety seat, and when the cover member engages with the anchor member, an extension portion of the anchor member which extends to a seat forward side from the conveyance main body or the seat main body may be sandwiched between the outer cover and the inner cover in a seat width direction.

According to the above-described configuration, it is possible to realize a conveyance seat that includes the cover member configured to protect the anchor member for connection with the child safety seat, and has high attachment rigidity of the cover member.

In addition, as described above, in the cover member, since the extension portion of the anchor member is sandwiched between the outer cover and the inner cover in a seat width direction, the extension portion of the anchor member can be suppressed from being exposed to the outside. That is, the appearance of the periphery of the anchor member (the periphery of the cover member) can be made satisfactory.

At this time, the inner cover may further include an anchor passing hole into which the anchor member is introduced, and which extends in the extension direction of the anchor member, and the anchor engagement portion may be formed at a portion of the anchor passing hole which is opposite to the anchor member side and extends continuously from the anchor passing hole in a direction intersecting the extension direction of the anchor passing hole.

According to the above-described configuration, the cover member (inner cover) can be easily attached with respect to the anchor member. In addition, the attachment rigidity of the cover member with respect to the anchor member can be raised.

At this time, an engagement claw, which engages with an engagement hole provided in the outer cover in a state of being accommodated inside the outer cover, may be formed at least one side between both end portions in an up to down direction and both end portions in a width direction in the inner cover.

According to the above-described configuration, the inner cover portion can be easily attached to the outer cover attached to the seat main body. In addition, the attachment rigidity of the outer cover and the inner cover can be raised.

In addition, as described above, since the engagement claw is formed on the inner cover, for example, even in a case where the engagement claw is deformed and does not function, the cover member can be established by replacing only the inner cover having a small volume. That is, it is possible to reduce the cost as compared with a case of replacing the outer cover with a large member volume.

At this time, the outer cover may include an anchor accommodation hole into which the anchor member is introduced and which accommodates the extension portion of the anchor member when the cover member engages with the anchor member, and an anchor fitting portion that is formed on an inner surface of the anchor accommodation hole and fits around the extension portion of the anchor member.

According to the above-described configuration, the cover member (outer cover) can be easily attached with respect to the anchor member. In addition, the attachment rigidity of the cover member with respect to the anchor member can be raised.

At this time, the cover member may detachably engage with the anchor member from a seat forward side, and a frame attachment portion that protrudes toward a seat frame that is a skeleton of the seat main body and is attached to an attached portion provided in the seat frame may be formed on a seat rear end portion of the outer cover.

According to the above-described configuration, the cover member (outer cover) can be easily attached with respect to the seat frame. In addition, the attachment rigidity of the cover member with respect to the seat frame can be raised.

### Advantageous Effects of Invention

According to the present invention, it is possible to realize a conveyance seat that includes a cover member configured to protect an anchor member for connection with an object to be connected (a child safety seat), and has high attachment rigidity of the cover member.

In addition, according to the present invention, an extension portion of the anchor member can be suppressed from being exposed to the outside. That is, the appearance of the periphery of the anchor member (the periphery of the cover member) can be made satisfactory.

In addition, according to the present invention, the cover member (an inner cover and an outer cover) can be easily attached with respect to the anchor member. In addition, the attachment rigidity of the cover member can be raised.

In addition, according to the present invention, the inner cover portion can be easily attached with respect to the outer cover attached to the seat main body. In addition, the attachment rigidity of the outer cover and the inner cover can be raised. In addition, the cost of the cove member can be reduced.

In addition, according to the present invention, the cover member (outer cover) can be easily attached with respect to the seat frame. In addition, the attachment rigidity of the cover member can be raised.

### BRIEF DESCRIPTION OF DRAWINGS

FIG. 1 is an external perspective view of a conveyance seat of an embodiment.

FIG. 2 is a perspective view of a seat frame and an anchor member.

FIG. 3A is an exploded perspective view of a cover member (a cap, an inner cover, and an outer cover) and the anchor member.

FIG. 3B is an assembly view of FIG. 3A.

FIG. 4A is an exploded perspective view of the cover member and the anchor member when viewed from another angle.

FIG. 4B is an assembly view of FIG. 4A.

FIG. 5A is an exploded perspective view of the inner cover, a skin material, and the outer cover.

FIG. 5B is an assembly view of FIG. 5A.

FIG. 6 is a longitudinal cross-sectional view of the cover member, and illustrates a state in which a part of the skin material is sandwiched between the inner cover and the outer cover.

FIG. 7 is a longitudinal cross-sectional view of the cover member, and illustrates a state in which the anchor member is sandwiched between the inner cover and the outer cover.

FIG. 8A is an exploded perspective view of a cover member of a second embodiment.

FIG. 8B is an assembly view of FIG. 8A.

FIG. 9 is a perspective view of a conveyance seat according to the second embodiment of the present invention.

FIG. 10 is a perspective view of a seat frame that is a skeleton of the conveyance seat.

FIG. 11 is a side view of the conveyance seat in a “use state”.

FIG. 12 is a perspective view of the conveyance seat in an “accommodation state”.

FIG. 13 is a rear view of a seat main body, a base member, and a cover member in the accommodation state.

FIG. 14A is a cross-sectional view taken along line XIV-XIV in FIG. 13.

FIG. 14B is a cross-sectional view taken along line XIV-XIV in FIG. 13 and illustrates a modification example of the cover member.

FIG. 15 is a side view of the conveyance seat in the use state, and illustrates a state of the cover member.

FIG. 16 is a side view of the conveyance seat that is moving from the use state to the accommodation state, and illustrates a state of the cover member (first state).

FIG. 17 is a side view of the conveyance seat that is moving from the use state to the accommodation state, and illustrates a state of the cover member (second state).

FIG. 18 is a side view of the conveyance seat in the accommodation state and illustrates a state of the cover member.

FIG. 19 is a perspective view when a vehicle seat of a third embodiment of the present invention is viewed diagonally from a forward side.

FIG. 20 is a view when a cushion pad of the vehicle seat is viewed from a forward side.

FIG. 21 is a cross-sectional view taken along line A-A in FIG. 20.

FIG. 22 is a cross-sectional view taken along line B-B in FIG. 20, and illustrates a first example.

FIG. 23 is a perspective view illustrating a stay cloth and a trim J-hook attached to a skin.

FIG. 24 is a perspective view illustrating another example of the stay cloth and the trim J-hook attached to the skin.

FIG. 25 is a view illustrating a modification example of the first example.

FIG. 26 is a cross-sectional view illustrating a second example.

FIG. 27 is a perspective view illustrating the stay cloth and a trim plate attached to the skin.

FIG. 28 is a view illustrating a modification example of the second example.

FIG. 29 is a cross-sectional view illustrating a third example.

FIG. 30 is a cross-sectional view illustrating another example of the third example.

FIG. 31 is a cross-sectional view illustrating a fourth example.

FIG. 32 is a perspective view when a vehicle seat of a fifth example is viewed diagonally from a forward side.

FIG. 33 is a view when a cushion pad of the vehicle seat of the fifth example is viewed from a forward side.

FIG. 34 is a cross-sectional view taken along line A-A in FIG. 33.

FIG. 35 is a perspective view when a vehicle seat according to a fourth embodiment of the present invention when viewed diagonally from a forward side.

FIG. 36 is a cross-sectional view taken along line B-B in FIG. 35, and illustrates a structure of fixing a stay cloth by using a clip.

FIG. 37 is a cross-sectional view taken along line A-A in FIG. 35, and illustrates a first example.

FIG. 38 is a view illustrating another example of the first example, and illustrates a configuration in which the stay cloth and a pad are bonded at a position avoiding an air cell.

FIG. 39 is a view illustrating another example of the first example, and illustrates a configuration in which the stay cloth and the pad are bonded at a position overlapping the air cell.

FIG. 40 is a cross-sectional view taken along line A-A in FIG. 35, and illustrates a second example.

FIG. 41 is a cross-sectional view illustrating another example the second example, and illustrates a configuration in which the stay cloth and the cushion pad are bonded at a position avoiding the air cell.

FIG. 42 is a cross-sectional view illustrating another example of the second example, and illustrates a configuration in which the stay cloth and the cushion pad are bonded at a position overlapping the air cell.

FIG. 43 is a view taken along line A-A in FIG. 35, and illustrates a third example.

FIG. 44 is a cross-sectional view illustrating another example of the third example, and illustrates a configuration in which the skin and the cushion pad are bonded at a position avoiding the air cell.

FIG. 45 is a view illustrating another example of the third example, and illustrates a configuration in which the skin and the cushion pad are bonded at a position where the air cell is formed.

FIG. 46 is a cross-sectional view taken along line A-A in FIG. 35, and illustrates a fourth example.

FIG. 47 is a cross-sectional view taken along line A-A in FIG. 35, and illustrates a fifth example.

FIG. 48 is a cross-sectional view taken along line A-A in FIG. 35, and illustrates a sixth example.

FIG. 49 is a cross-sectional view taken along line A-A in FIG. 35, and illustrates a seventh example.

FIG. 50 is a cross-sectional view taken along line A-A in FIG. 35, and illustrates an eighth example.

FIG. 51 is a cross-sectional view taken along line A-A in FIG. 35, and illustrates a ninth example.

FIG. 52 is a cross-sectional view taken along line A-A in FIG. 35, and illustrates a tenth example.

FIG. 53 is a cross-sectional view taken along line A-A in FIG. 35, and illustrates an eleventh example.

FIG. 54 is a view illustrating the skin applied with adhesive.

FIG. 55 is a perspective view illustrating another example of the cushion pad.

FIG. 56 is a schematic view illustrating the cushion pad in which a concave portion into which the stay cloth enters is formed.

FIG. 57 is a view illustrating an example of a conveyance seat in which a condition correction unit is mounted according to a fifth embodiment of the present invention.

FIG. 58 is a block diagram illustrating a configuration of the condition correction unit.

FIG. 59 is a view illustrating a screen for confirming a physical condition of a seated occupant.

FIG. 60 is a view illustrating a functional configuration of an ECU as a control device.

FIG. 61 is a view illustrating a correction plan and a plan management table stored in a storage unit.

FIG. 62A is an explanatory view relating to a correction method when correcting a stooped posture.

FIG. 62B is a view illustrating a state in an ideal posture.

FIG. 62C is an explanatory view relating to a correction method when correcting a warped back posture.

FIG. 63 is a view illustrating a screen example when showing a posture determination result.

FIG. 64 is a view illustrating a screen example when presenting a correction plan.

FIG. 65 is a view illustrating a screen example when showing a posture comparison result.

FIG. 66 is a view illustrating a flow of a first time flow of posture correction (first part thereof).

FIG. 67 is a view illustrating the flow of the first time flow of the posture correction (second part thereof).

FIG. 68 is a view illustrating a procedure relating to ideal correction of the posture.

FIG. 69 is a view illustrating a procedure relating to correction mode setting.

FIG. 70 is a view illustrating a flow of a normal flow of posture correction.

### DESCRIPTION OF EMBODIMENTS

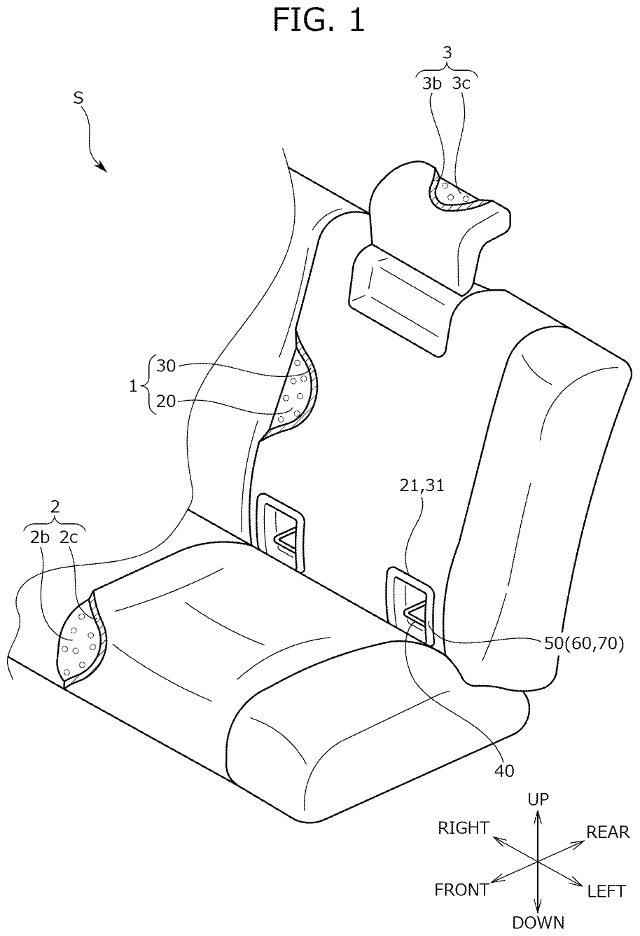

Hereinafter, a conveyance seat according to a first embodiment of the present invention will be described with reference to FIG. 1 to FIGS. 8A and 8B.

This embodiment relates to an invention of a conveyance seat including a cover member that protects an anchor member extending from a seat main body to a seat forward side for connection with an object to be connected (child safety seat). The conveyance seat is mainly characterized as follows. The cover member includes an outer cover that is attached to the seat main body and covers the anchor member, and an inner cover that is attached to the outer cover in a state of being accommodated inside the outer cover, and includes an anchor engagement portion that engages with the anchor member. When the cover member engages with the anchor member, an extension portion of the anchor member which extends to a seat forward side from the seat main body is sandwiched between the outer cover and the inner cover in a seat width direction.

Note that, a side where an occupant (seated occupant) is seated with respect to a seat back of the conveyance seat is a seat forward side.

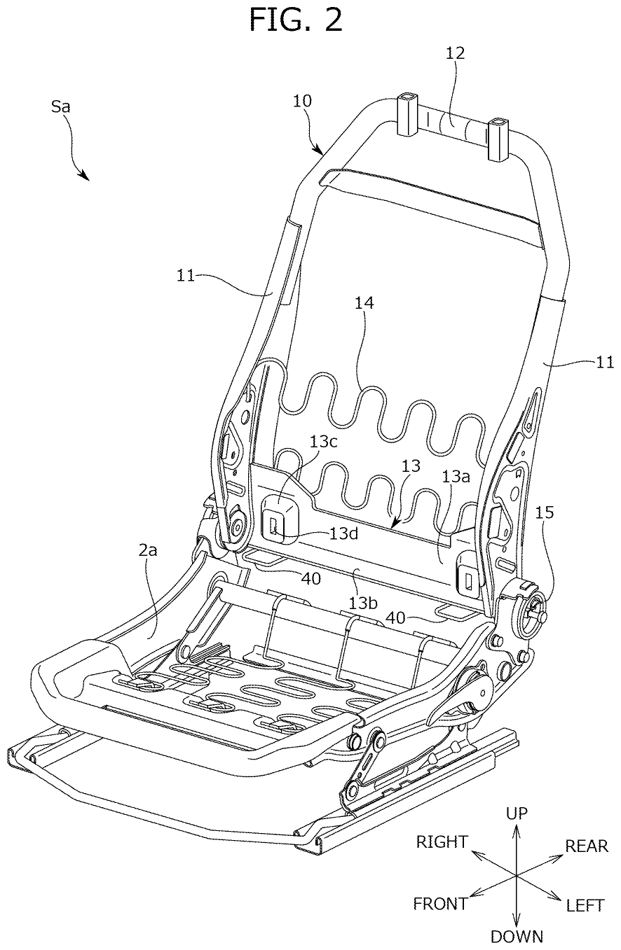

A conveyance seat S of this embodiment is a vehicle seat capable of connecting a child safety seat, and mainly includes a seat main body including a seat back 1, a seat cushion 2, and a headrest 3 as illustrated in FIG. 1, an anchor member 40 that is attached to a seat frame Sa that is a skeleton of the seat main body and extends in a seat forward side, and a cover member 50 that is attached to the seat frame Sa and protects the anchor member 40 from the outside as illustrated in FIG. 1 and FIG. 2.

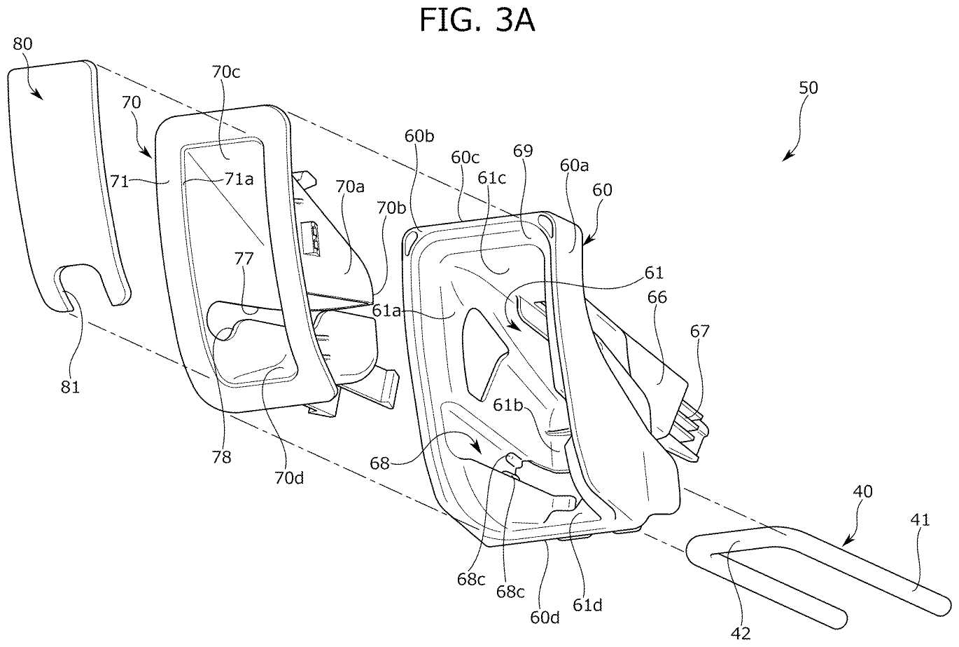

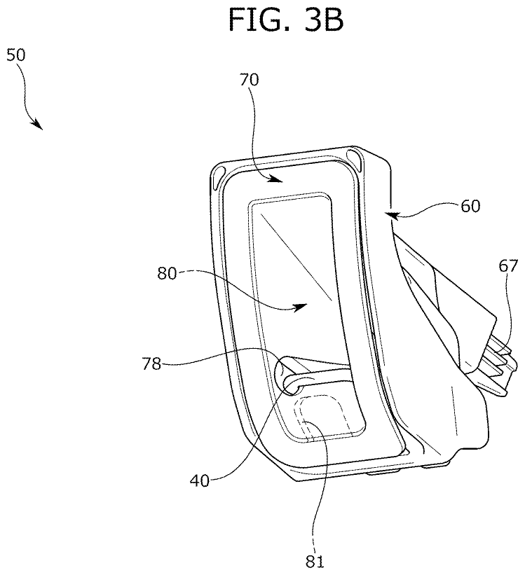

As illustrated in FIGS. 3A and 3B, the cover member 50 mainly includes an outer cover 60 that covers the anchor member 40 from the seat forward side, an inner cover 70 that is attached in a state of being accommodated inside the outer cover 60 from the seat forward side, and engages with the anchor member 40, and a cap 80 that is attached to the inner cover 70 from the seat forward side.

As illustrated in FIG. 1 and FIG. 2, the seat back 1 is a backrest that supports the back of a seated occupant, and has a configuration in which a pad member 20 is placed on a back frame 10 as a skeleton, and is covered with a skin material 30.

The seat cushion 2 is a seating portion that supports the seated occupant from a downward side, and has a configuration in which a pad member 2b is placed on a cushion frame 2a that is a skeleton, and is covered with a skin material 2c from an upper side of the pad member 2b.

The headrest 3 is a head portion that supports the head of the seated occupant from a rearward side, and has a configuration in which a pad member 3b is placed on a headrest pillar as a core material, and is covered with a skin material 3c.

As illustrated in FIG. 2, the back frame 10 is constituted by a rectangular frame body, and mainly includes right and left side frames 11 which are disposed on right and left lateral sides and extend in an up to down direction, an inverted U-shaped upper frame 12 that connects upper end portions of the side frames 11, an approximately plate-shaped lower frame 13 that connects lower end portions of the side frames 11, and a plurality of elastic springs 14 which are hooked to the side frames 11 and extend in a serpentine shape.

Each of the side frames 11 is a sheet metal member having an approximately C-shaped transverse cross-section, extends in the up to down direction, and connects the upper frame 12 and the cushion frame 2a.

Specifically, upper portions of the side frames 11 are attached to sandwich the upper frame 12 having a pipe shape from outer sides in a seat width direction. In addition, the lower end portion of each of the side frames is connected to a rear end portion of the cushion frame 2a through a reclining device 15. In this state, the back frame 10 can relatively rotate with respect to the cushion frame 2a.

The lower frame 13 is a sheet metal member having an approximately L-shaped longitudinal cross-section, and extends in the seat width direction and is attached to inner side surfaces of the right and left side frames 11.

The lower frame 13 includes a side wall portion 13a that extends in the up to down direction, and a bottom wall portion 13b that is bent continuously from a lower end portion of the side wall portion 13a and extends to a seat forward side.

A frame convex portion 13c that protrudes to bulge to the seat forward side is formed on front surfaces of both right and left end portions of the lower frame 13 (side wall portion 13a). In addition, an attachment portion 13d (attachment hole) for attaching the cover member 50 (frame attachment portion 67) is formed in a front surface of the frame convex portion 13c.

In addition, the anchor member 40 that protrudes to the seat forward side is attached to bottom surfaces of both the right and left end portions of the lower frame 13 (bottom wall portion 13b) through welding, respectively.

As illustrated in FIG. 1, the pad member 20 is a cushion material of the seat back 1, and is attached to a front surface of the back frame 10.

Pad opening holes 21 through which the anchor member 40 (cover member 50) passes in a seat front to rear direction are formed in a portion corresponding to the anchor member 40 (cover member 50) in the pad member 20.

The pad opening holes 21 are opening holes having an approximately rectangular cross-section, are formed in lower end portions of the seat back 1, and are disposed on right and left sides with an interval in the seat width direction.

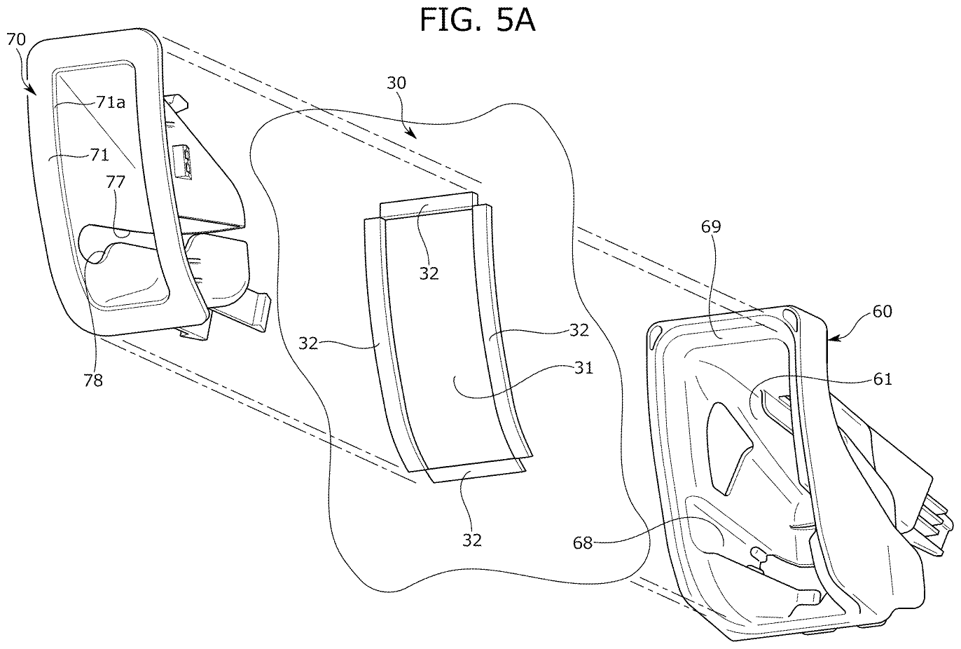

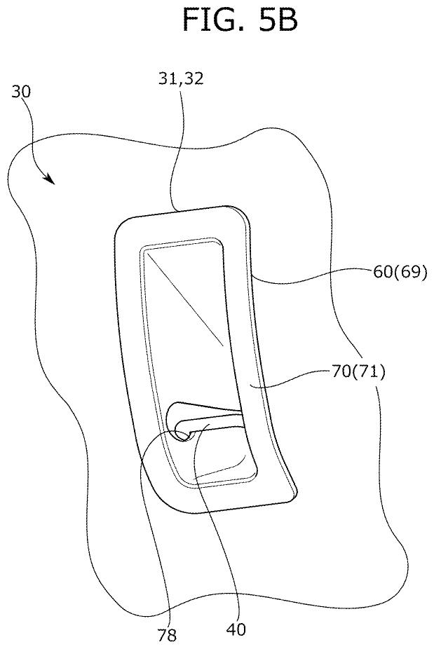

As illustrated in FIG. 1 and FIG. 5A, the skin material 30 is a covering material of the seat back 1, and covers outer surfaces of the back frame 10 and the pad member 20.

A skin opening hole 31 from which the anchor member 40 is exposed, and a skin locking member 32 that is attached to an outer peripheral portion of the skin opening hole 31 and is locked to the cover member 50 are provided at a portion corresponding to the anchor member 40 (cover member 50) in the skin material 30.

The skin opening hole 31 is an approximately square-shaped opening hole, is formed at a lower end portion of the seat back 1, and is disposed on the right and the left with an interval in the seat width direction.

The skin locking member 32 is a trim plate that is made of a resin or leather and has an approximately rectangular plate shape, and is sewed to an outer peripheral portion of the skin opening hole 31.

A plurality of the skin locking members 32 are disposed at the outer peripheral portion of the skin opening hole 31 with an interval. Specifically, the skin locking members 32 are disposed at an upper end portion, both right and left end portions, and a lower end portion of the skin opening hole 31, respectively, and are disposed at position avoiding corner portions (four corners) of the skin opening hole 31.

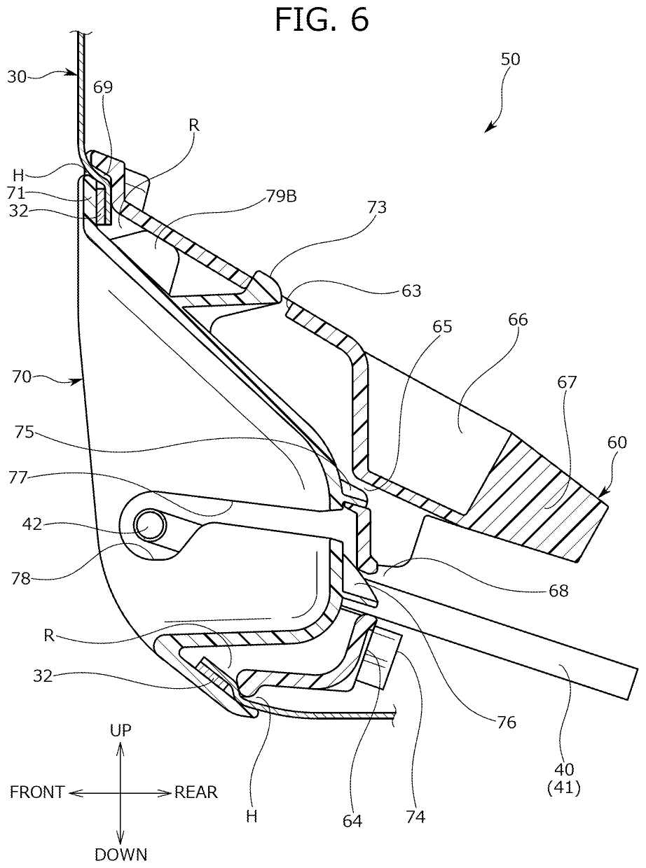

In the above-described configuration, as illustrated in FIGS. 5A and 5B, and FIG. 6, the outer peripheral portion of the skin opening hole 31 and the skin locking members 32 are sandwiched between the outer cover 60 and the inner cover 70 in the seat front to rear direction.

As illustrated in FIG. 2 and FIG. 3A, the anchor member 40 is an approximately U-shaped wire member for connection with a child safety seat, and is attached to a bottom surface of the back frame 10 (lower frame 13).

Specifically, the anchor member 40 mainly includes right and left anchor extension portions 41 extends from the bottom surface of the back frame 10 to a seat forward side, and an anchor connecting portion 42 that extends in the seat width direction for connecting anchor extension end portions of the right and left anchor extension portions 41.

A connecting portion (connecting hook) provided in a child safety seat (not illustrated) is detachably connected to the anchor connecting portion 42 of the anchor member 40.

As illustrated in FIG. 1, the cover member 50 is a cover that is fitted into the pad opening hole 21 (skin opening hole 31) of the seat back 1 from a seat forward side and protects the anchor member 40 from an outer side, and engages with the back frame 10 and the anchor member 40, respectively.

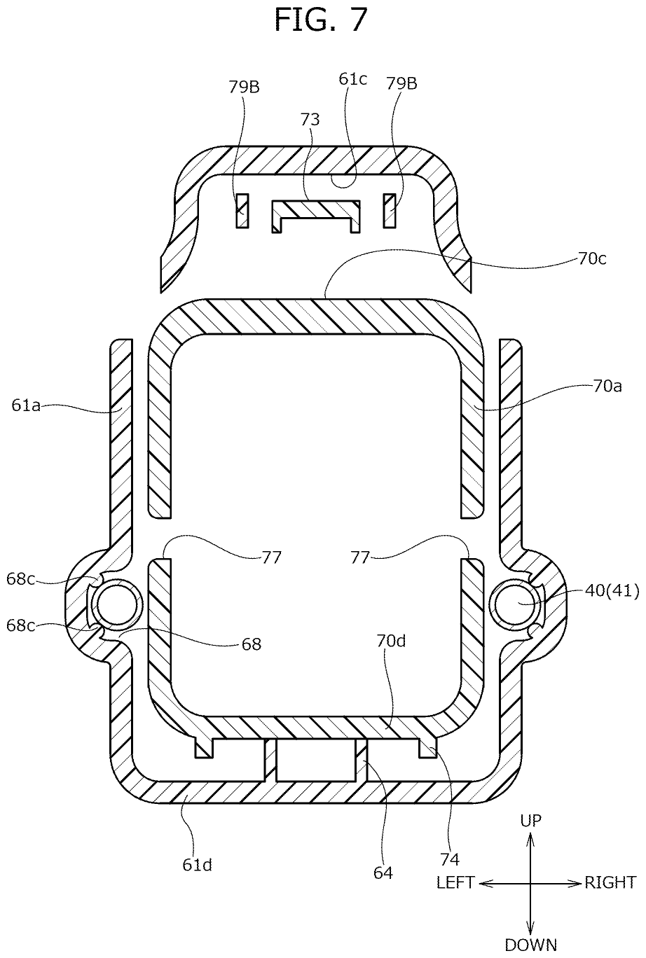

As illustrated in FIGS. 3A and 3B, the cover member 50 includes the outer cover 60, the inner cover 70, and the cap 80. In addition, when engaging with the anchor member 40, the right and left anchor extension portions 41 of the anchor member 40 are sandwiched between the outer cover 60 and the inner cover 70 in the seat width direction (refer to FIG. 7).

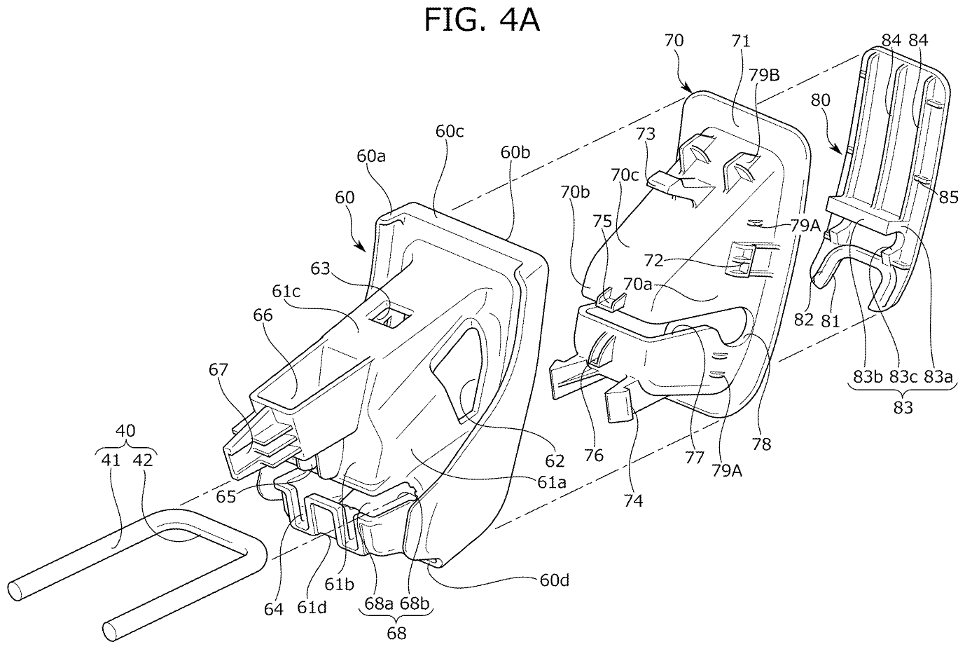

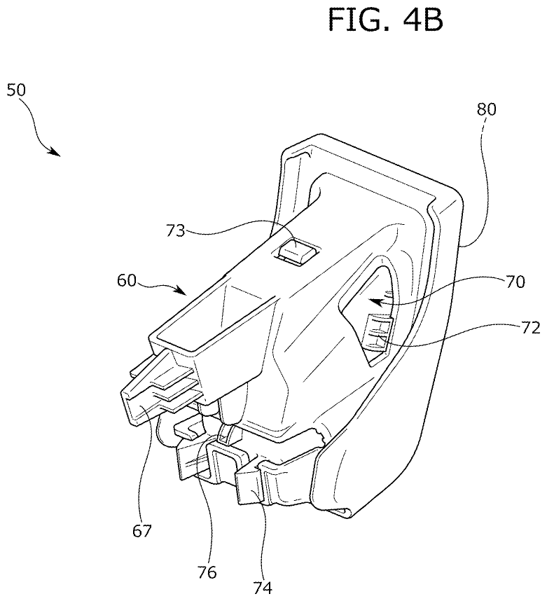

As illustrated in FIG. 3A to FIG. 4B, the outer cover 60 is a cover material including an anchor accommodation hole into which the anchor member 40 is introduced from a seat rearward side and which is capable of accommodating the anchor member 40, and a cover accommodation concave portion capable of accommodating the inner cover 70 from the seat forward side. The outer cover 60 is inserted into the pad opening hole 21 and is attached to the back frame 10 (attachment portion 13d).

Specifically, the outer cover 60 includes right and left side wall portions 60a which are provided with an interval in the seat width direction and extend in the seat front to rear direction, a front wall portion 60b that connects front end portions of the right and left side wall portions 60a, an upper wall portion 60c that connects upper end portions of the right and left side wall portions 60a and the front wall portion 60b, and a bottom wall portion 60d that connects lower end portions of the right and left side wall portions 60a and the front wall portion 60b.

A cover accommodation concave portion 61 that is provided to be recessed to the seat rearward side, and is capable of accommodating the inner cover 70 is formed in a front surface of the outer cover 60 (front wall portion 60b).

The cover accommodation concave portion 61 includes right and left second side wall portions 61a which are provided with an interval in the seat width direction and extend in the seat front to rear direction, a rear wall portion 61b that connects rear end portions of the right and left second side wall portions 61a, a second upper wall portion 61c that connects upper end portions of the right and left second side wall portions 61a and the rear wall portion 61b, and a second bottom wall portion 61d that connects lower end portions of the second side wall portions 61a and the rear wall portion 61b.

Right and left lateral engagement holes 62 which engage with right and left lateral engagement claws 72 provided in the inner cover 70 are formed in the right and left second side wall portions 61a of the cover accommodation concave portion 61. Similarly, an upward engagement hole 63 that engages with an upward engagement claw 73 provided in the inner cover 70 is formed in the second upper wall portion 61c.

In addition, a first rearward engagement hole 64 and a second rearward engagement hole 65 which engage with a first rearward engagement claw 74 and a second rearward engagement claw 75 provided in the inner cover 70 are formed in the rear wall portion 61b. A pair of the first rearward engagement holes 64 are formed with an interval in the seat width direction.

The lateral engagement holes 62, the upward engagement hole 63, the first rearward engagement hole 64, and the second rearward engagement hole 65 are opening holes passing through the cover accommodation concave portion 61 in a thickness direction thereof.

In the rear wall portion 61b of the cover accommodation concave portion 61, a box-shaped cover convex portion 66 protruding to the seat rearward side is formed at an upward position as compared with the first rearward engagement hole 64 and the second rearward engagement hole 65. In addition, a frame attachment portion 67 to be attached to the attachment portion 13d of the back frame 10 is formed on the rear surface of the cover convex portion 66.

The frame attachment portion 67 is a grating-shaped attachment protrusion that protrudes from the rear surface of the cover convex portion 66 toward the seat rearward side, and is inserted into the attachment portion 13d (attachment hole) of the back frame 10.

In addition, in the cover accommodation concave portion 61, an anchor accommodation hole 68 that is notched toward the seat forward side so as to introduce the anchor member 40 and accommodates the anchor member 40 (right and left anchor extension portions 41) is provided in the right and left second side wall portions 61a and the rear wall portion 61b.

Specifically, the anchor accommodation hole 68 includes an opening hole portion 68a into which the anchor member 40 is introduced, and an accommodation hole portion 68b that extends continuously from the opening hole portion 68a to the seat forward side and is surrounded by the right and left second side wall portions 61a.

In the anchor accommodation hole 68, anchor fitting portions 68c to be fitted around the anchor member 40 (anchor extension portion 41) are formed in an inner side surface of the accommodation hole portion 68b.

As illustrated in FIG. 3A and FIG. 7, the anchor fitting portions 68c are fitting protrusions formed with a predetermined interval in the up to down direction, and are disposed to sandwich the anchor member 40 (anchor extension portion 41) in the up to down direction.

As illustrated in FIG. 3A to FIG. 4B, the inner cover 70 is a cover material including an anchor engagement portion into which the anchor member 40 is introduced from the seat rearward side and which is capable of engaging with the anchor member 40, and is attached to the outer cover 60 in a state of being accommodated inside the outer cover 60. Specifically, the inner cover 70 includes right and left side wall portions 70a which are provided with an interval in the seat width direction and extend in the seat front to rear direction, a rear wall portion 70b that connects rear end portions of the right and left side wall portions 70a, an upper wall portion 70c that connects upper end portions of the right and left side wall portions 70a and the rear wall portion 70b, and a bottom wall portion 70d that connects lower end portions of the right and left side wall portions 70a and the rear wall portion 70b.

In addition, a frame-shaped outer peripheral flange 71 that protrudes to an upward side, a downward side, a rightward side, and a leftward side toward the outer side of the inner cover 70 is formed at an outer peripheral portion of a front surface of the inner cover 70.

The right and left lateral engagement claws 72 which engage with the right and left lateral engagement holes 62 of the outer cover 60 are formed on the right and left side wall portions 70a of the inner cover 70. Similarly, an upward engagement claw 73 that engages with the upward engagement hole 63 of the outer cover 60 is formed in the upper wall portion 70c.

In addition, the first rearward engagement claw 74, the second rearward engagement claw 75, and a third rearward engagement claw 76 which engage with the first rearward engagement hole 64, the second rearward engagement hole 65, and the anchor accommodation hole 68 of the outer cover 60 are formed on the rear wall portion 70b.

A pair of the first rearward engagement claw 74 are formed with an interval in the seat width direction.

The lateral engagement claw 72, the upward engagement claw 73, and the second rearward engagement claw 75 are disposed at upward positions as compared with the anchor member 40. The first rearward engagement claw 74 and the third rearward engagement claw 76 are disposed at downward positions as compared with the anchor member 40.

In the inner cover 70, an anchor passing hole 77 that is notched toward the seat forward side (seat diagonal forward side) so as to introduce the anchor member 40, and extends in the extension direction of the anchor member 40 (right and left anchor extension portions 41) is provided in the right and left side wall portions 70a and the rear wall portion 70b.

In addition, an anchor engagement portion 78 is formed at a front end portion opposite to the anchor member 40 side in the anchor passing hole 77, and extends continuously from the anchor passing hole 77 in a direction intersecting the extension direction of the anchor passing hole 77.

The anchor engagement portion 78 is an approximately semicircular engagement groove formed to be notched downward from the front end portion of the anchor passing hole 77, and is disposed to detachably engage with the anchor member 40 (anchor connecting portion 42).

Note that, a contact rib 79 that comes into contact with the right and left second side wall portions 61a and the second upper wall portion 61c of the outer cover 60 is formed on the right and left side wall portions 70a and the upper wall portion 70c of the inner cover 70.

The contact rib 79 has a function of coming into contact with an outer surface of the outer cover 60 and holding the inner cover 70, and a function of reinforcing the inner cover 70.

A contact rib 79A is formed at an upper end portion and a lower end portion of the right and left side wall portions 70a, and is disposed at positions where the lateral engagement claw 72 and the anchor passing hole 77 are sandwiched therebetween in the up to down direction.

A contact rib 79B is an approximately cross-shaped rib and is disposed at a peripheral portion of the upward engagement claw 73.

As illustrated in FIG. 3A and FIG. 4A, the cap 80 is a lid of the cover member 50. The cap 80 is detached from an opening portion of the inner cover 70 when the anchor member 40 is used, and is attached to the opening portion of the inner cover 70 when the anchor member 40 is not used.

A hook portion 81 on which an occupant hooks his or her finger, and an approximately U-shaped reinforcement bulge portion 82 provided at an outer peripheral portion of the hook portion 81 are formed at a lower end portion of the cap 80.

The hook portion 81 is an approximately rectangular hook hole, and is formed by notching a lower end portion of the cap 80.

The reinforcement bulge portion 82 is a bulged portion obtained by bulging a part of a rear surface of the cap 80 to a rearward side, and is formed along an outer peripheral portion of the hook portion 81.

In addition, an anchor grip portion 83 that protrudes toward the anchor member 40 and is configured to grip the anchor member 40 (anchor connecting portion 42) is formed on a rear surface of the downward end portion of the cap 80. The anchor grip portion 83 is constituted by an approximately inverted U-shaped body, and includes right and left side wall portions 83a which are formed with an interval in a right and left width direction and extend to a rearward side, an upper wall portion 83b that connects upper end portions of the right and left side wall portion 83a, and right and left grip portions 83c (grip holes) which are formed at rear end portions of the right and left side wall portions 83a and sandwich the anchor member 40 in the up to down direction.

Note that, a plurality of vertical ribs 84 which are disposed with an interval in the right and left width direction and extend in the up to down direction, and a plurality of transverse ribs 85 which are disposed with an interval in the up to down direction and extend in the right and left width direction are formed on a rear surface of the cap 80, respectively.

The vertical ribs 84 and the transverse ribs 85 are reinforcement ribs configured to reinforce the cap 80 and are connected to each other. In addition, the vertical ribs 84 and the transverse ribs 85 are also connected to the anchor grip portion 83.

Specifically, the vertical ribs 84 extend downward from an upper end portion of the cap 80, and come into contact with the anchor grip portion 83. The transverse ribs 85 extend from both end portions in a right and left width direction of the cap 80 to a central side and come into contact with the anchor grip portion 83 or the vertical ribs 84.

In the above-described configuration, as illustrated in FIGS. 5A and 5B and FIG. 6, the cover member 50 is attached to the seat back 1 with an outer peripheral portion of the skin opening hole 31 and the skin locking member 32 sandwiched between the outer cover 60 and the inner cover 70.

At this time, an outer surface of the inner cover 70, an outer surface of the cap 80, and an outer surface of the skin material 30 are approximately flushed with each other. Specifically, a stepped concave portion 71a that accommodates the cap 80 and comes into contact with an outer peripheral portion of the cap 80 is formed in the front surface of the inner cover 70 (outer peripheral flange 71). Therefore, the appearance of the periphery of the cover member 50 can be made satisfactory.

In addition, in the above-described configuration, as illustrated in FIGS. 5A and 5B and FIG. 6, a flange accommodation concave portion 69 is formed in the front surface facing the inner cover 70 (outer peripheral flange 71) in the outer cover 60.

At this time, the skin locking member 32 is accommodated in the flange accommodation concave portion 69 in combination with the outer peripheral flange 71, and is sandwiched between the outer peripheral flange 71 and the flange accommodation concave portion 69.

Therefore, the cover member 50 can be easily attached with respect to the skin material 30. In addition, attachment rigidity of the cover member 50 with respect to the skin material 30 can be raised.

In addition, the skin locking member 32 is suppressed from being exposed to the outside. Therefore, the appearance of the periphery of the cover member 50 can be made satisfactory.

In addition, in the above-described configuration, as illustrated in FIG. 6, when the inner cover 70 is attached to the outer cover 60, an accommodation space R for accommodating the skin locking member 32 is formed between the outer peripheral flange 71 and the flange accommodation concave portion 69.

In addition, a skin passing hole H connected to the accommodation space R is formed in a gap between the outer peripheral portion of the front surface facing the inner cover 70 in the outer cover 60, and the outer peripheral flange 71 of the inner cover 70.

At this time, the skin passing hole H is formed to be narrower than the skin locking member 32.

Accordingly, the attachment rigidity of the cover member 50 with respect to the skin material 30 (skin locking member 32) can be raised. In addition, the skin locking member 32 is prevented from coming out from the cover member 50.

### Second Example of Cover Member

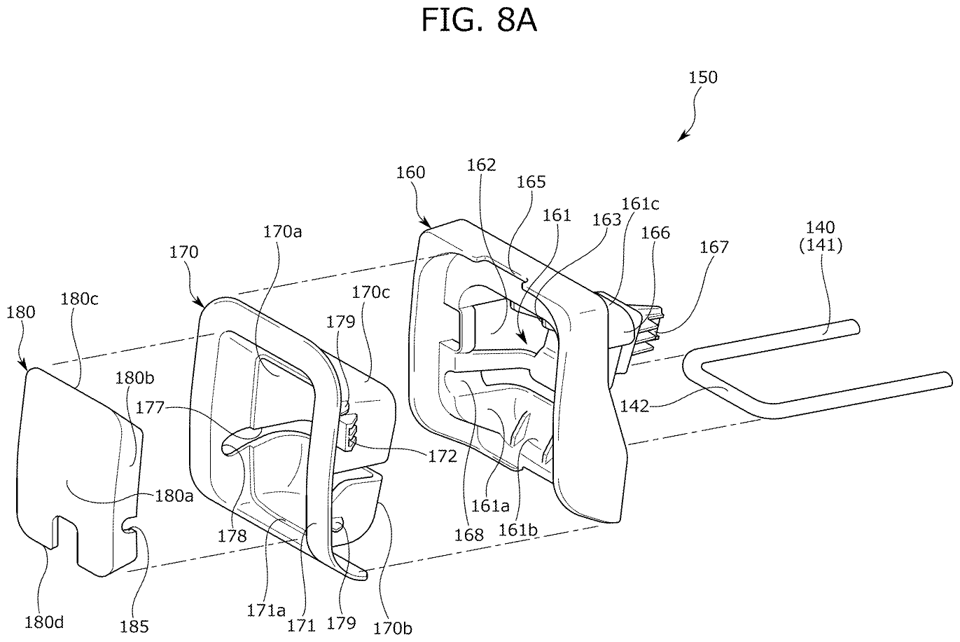

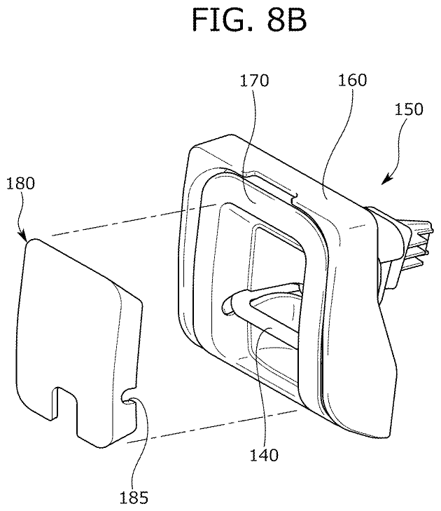

Next, a second example of the cover member will be described with reference to FIGS. 8A and 8B. Note that, Description of contents which are redundant with the above-described conveyance seat S will be omitted.

A cover member 150 of the second example includes an outer cover 160, an inner cover 170, and a cap 180. In addition, when engaging with an anchor member 140, right and left anchor extension portions 141 are sandwiched between the outer cover 160 and the inner cover 170 in the seat width direction.

A cover accommodation concave portion 161 is formed in a front surface of the outer cover 160.

Right and left lateral engagement holes 162 which engage with right and left lateral engagement claws 172 provided in the inner cover 170 are formed in right and left second side wall portions 161a of the cover accommodation concave portion 161. An upward contact rib 163 that comes into contact with the inner cover 170 is formed on a second upper wall portion 161c.

In addition, a rearward contact rib 164 that comes into contact with the inner cover 170 is formed on a rear wall portion 161b. A pair of the rearward contact ribs 164 are formed with an interval in the seat width direction.

A box-shaped cover convex portion 166 protruding to the seat rearward side is formed at the rear wall portion 161b of the cover accommodation concave portion 161. In addition, a frame attachment portion 167 that is attached to a back frame 110 is formed on a rear surface of the cover convex portion 166.

In addition, an anchor accommodation hole 168 into which the anchor member 140 is introduced and which accommodates right and left anchor extension portions 141 is provided in the right and left second side wall portions 161a and the rear wall portion 161b in the cover accommodation concave portion 161.

A frame-shaped outer peripheral flange 171 is formed at an outer peripheral portion of a front surface of the inner cover 170.

The lateral engagement claws 172 which engage with the right and left lateral engagement holes 162 of the outer cover 160 are formed on right and left side wall portions 170a of the inner cover 170.

An anchor passing hole 177 into which the anchor member 140 is introduced is provided in the right and left side wall portions 170a and the rear wall portion 170b in the inner cover 170.

In addition, an anchor engagement portion 178 is formed at a front end portion opposite to the anchor member 140 side in the anchor passing hole 177.

Note that, a contact rib 179 that comes into contact with the right and left second side wall portions 161a of the outer cover 160 is formed on the right and left side wall portion 170a of the inner cover 70.

In the above-described configuration, a detachment hole 165, which is notched toward a rearward side of the outer cover 160 and is used by an occupant to detach the inner cover 170 by hooking his or her finger thereon, is formed in an upper end portion and a lower end portion of the front surface of the outer cover 160.

Therefore, the inner cover 170 can be easily detached from the outer cover 160.

The cap 180 has an approximately U-shaped transverse cross-section, and includes a planar front wall portion 180a, right and left side wall portions 180b extending reward from both end portions in a right and left width direction of the front wall portion 180a, an upper wall portion 180c that connects upper end portions of the front wall portion 180a and the right and left side wall portions 180b, and a bottom wall portion 180d that connects lower end portions of the front wall portion 180a and the right and left side wall portions 180b.

When the cap 180 is accommodated in the inner cover 170, the front wall portion 180a, the right and left side wall portions 180b, and the bottom wall portion 180d come into contact with a stepped concave portion 171a of the inner cover 170.

In addition, right and left notched holes 185 for suppressing interference with the anchor member 140 are formed in the right and left side wall portions 180b of the cap 180.

### Other Examples

In the above-described embodiment, as illustrated in FIG. 1, the anchor member 40 is attached to the lower end portion of the seat back 1 (back frame 10), but may be modified without particular limitation.

For example, the anchor member 40 may be attached to a rear end portion of the seat cushion 2 (cushion frame 2a). In addition, the anchor member 40 may be attached to a vehicle body.

In the above-described embodiment, as illustrated in FIG. 1, the anchor member 40 is configured for connection with a child safety seat, but a modification can be made without particular limitation to the child safety seat.

For example, objects to be connected such as other conveyance articles (conveyance interior parts), and luggage may be connected to the anchor member 40.

In the above-described embodiment, as illustrated in FIG. 1, and FIGS. 5A and 5B, the cover member 50 is a cover that protects the anchor member 40, but may protect other conveyance e articles (conveyance interior parts) without particular limitation to the anchor member 40.

For example, the cover member 50 may be attached to a seat main body (a shoulder portion of the seat back, or a front end portion of the seat cushion) with the skin material 30 sandwiched between the outer cover 60 and the inner cover 70 to protect an operation lever configured to switch a state of the seat main body. Alternatively, the cover member 50 may protect a safety belt of a safety belt device (not illustrated). In this case, an extension direction of the safety belt may be guided.

In the above-described embodiment, as illustrated in FIGS. 3A and 3B, the cover member 50 includes the outer cover 60, the inner cover 70, and the cap 80, but the cap 80 may not be used without particular limitation.

In the above-described embodiment, as illustrated in FIGS. 3A and 3B, and FIG. 7, in the cover member 50, when engaging with the anchor member 40, the anchor extension portions 41 are sandwiched between the outer cover 60 and the inner cover 70 in the seat width direction, but a modification can be made without particular limitation.

For example, in the cover member 50, the anchor extension portions 41 may be sandwiched between the outer cover 60 and the inner cover 70 in the up to down direction. Alternatively, the anchor extension portions 41 may be sandwiched between the outer cover 60 and the inner cover 70 in the seat front to rear direction.

In the above-described embodiment, as illustrated in FIG. 3A, the anchor engagement portion 78 extends downward from the front end portion of the anchor passing hole 77, but a modification can be made without particular limitation. For example, the anchor engagement portion 78 may extend upward from the front end portion of the anchor passing hole 77. Alternatively, the anchor engagement portion 78 may further extend forward from the front end portion of the anchor passing hole 77 in a narrow width.

In the above-described embodiment, as illustrated in FIG. 4A, the inner cover 70 includes the right and left lateral engagement claws 72, the upward engagement claw 73, and the rearward engagement claws 74, 75, and 76, but a modification can be made without particular limitation.

For example, the inner cover 70 may include only the right and left lateral engagement claws 72. Alternatively, only the upward engagement claw 73 and the rearward engagement claw 74 may be provided. Alternatively, only the lateral engagement claw 72 and the upward engagement claw 73 may be provided.

In addition, an engagement hole may be formed in the outer cover 60 at a site corresponding to the engagement claw of the inner cover 70.

In the above-described embodiment, description has given of the conveyance seat that is used in automobiles as a specific example, but the conveyance seat can be used as not only conveyance seats of trains, buses, and the like, but also conveyance seats of airplanes, ships, and the like without particular limitation.

In this embodiment, the conveyance seat according to the present invention has been mainly described.

However, the above-described embodiment is merely one example for facilitating understanding of the present invention, and the present invention is not limited thereto. The present invention can be modified and improved without departing from the gist of the present invention, and the equivalents are also included in the present invention.

### Second Embodiment

Hereinafter, a second embodiment of the present invention will be described. The second embodiment of the present invention relates to a conveyance seat, and particularly to, a conveyance seat capable of switching a seat main body including a seat back and a seat cushion between a use state and an accommodation state.

In the related art, there is known a vehicle seat capable of being switched between a use state in which an occupant can be seated, and an accommodation state in which the seat back is folded and the seat main body is accommodated on a vehicle body floor side (for example, refer to JP 2006-204634 A).

The vehicle seat described in JP 2006-204634 A is provided with a cover structure in which a gap occurring between the seat back and the seat cushion is covered with a cover member, and the cover member is extendable and contractable by folding the cover member itself.

Specifically, the cover structure includes a cover member that is connected to a lower end portion of the seat back and a rear end portion of the seat cushion to cover a gap therebetween. In addition, with respect to a dimensional variation in the gap due to a relative movement of the seat back and the seat cushion, an intermediate portion of the cover member is folded by a fold forming portion to cope with the dimensional variation.

Therefore, even in a case where a state of the seat main body is switched, the gap between the seat back and the seat cushion can be covered and hidden without deteriorating the appearance.

### Technical Problem

By the way, in the vehicle seat including the cover structure as described in JP 2006-204634 A, even in a case where the state of the seat main body is switched, the gap with the seat main body can be appropriately covered and hidden, but since the cover structure is constituted by a plurality of constituent components, there is a concern that the number of assembly steps increases and the cost and the weight increase.

In addition, in the cover structure, since a plurality of resin boards are attached to the cover main body (skin material) so as to make the cover member foldable, and an elastic body applying a tensile force is attached, there is a concern that the size of the cover structure increases, and the size of the seat increases.

Furthermore, when an elastic force (tensile force) of an elastic body decreases due to deterioration with the passage of time and repetitive use, there is a concern that it is difficult to smoothly fold the cover member.

The second embodiment of the present invention has been made in consideration of the problem, and an object of the present invention is to provide a conveyance seat including a cover member that is capable of covering a gap with a seat main body even in a case of switching a state of the seat main body, and has a simple structure.

In addition, another object of the present invention is to provide a conveyance seat which is capable of appropriately covering and hiding the gap with the seat main body without deteriorating the appearance of a seat and in which the cover member is compactly disposed.

### Solution to Problem

According to the conveyance seat of the second embodiment, the problem is solved by the following conveyance seat that includes a seat main body including a seat back and a seat cushion, and is capable of being switched between a use state allowing an occupant to be seated, and an accommodation state in which the seat back is folded and the seat main body is moved to a vehicle body floor side. The conveyance seat includes a cover member that is provided to extend downward from a rear surface of the seat back and that covers a gap between the seat back and the seat cushion or the vehicle body floor in an up to down direction. The cover member includes a first extension member that extends from a rear surface of the seat back and is deformable in correspondence with a folding operation of the seat back, and a second extension member that extends downward from an extension end portion of the first extension member and cover the gap, a base end portion of the first extension member is attached to a rear surface of a downward portion of the seat back, an extension end portion of the second extension member is attached a rearward portion of the seat cushion or attached to a rearward portion of a base member that supports the seat main body from a downward side, in the use state, at least a part of the first extension member is accommodated between the seat back and the second extension member, and the base end portion in the first extension member is disposed on a downward position as compared with the extension end portion, and in the accommodation state, the first extension member is exposed to an outer side.

According to the above-described configuration, even in a case of switching the state of the seat main body, it is possible to realize a conveyance seat including a cover member that can appropriately cover a gap with the seat main body, and has a simple structure.

Specifically, the cover member has a simple structure including the first extension member that is deformable, and the second extension member. In addition, in the conveyance seat, the first extension member is deformed in accordance with a switching operation of the seat main body, the first extension member is accommodated and the gap can be covered with the second extension member in the use state, and the first extension member is exposed and the gap can be covered by the first extension member and the second extension member in the accommodation state. In this manner, the cover member can appropriately cover and hide the gap with the seat main body.

At this time, the first extension member may come into contact a rear surface of the seat back, and in switching between the use state and the accommodation state, a contact surface that comes into contact with the seat back in the first extension member may be switched between the front surface and the rear surface.

According to the above-described configuration, even in a case of switching the state of the seat main body, a state in which the first extension member of the cover member is in contact with the rear surface of the seat back is maintained, and thus the cover member can be compactly disposed. In addition, in a switching operation of the seat main body, the cover member (first extension member) can be deformed to appropriately follow the seat main body (seat back).

At this time, the base end portion of the first extension member may be disposed at an upward position in the accommodation state as compared with the extension end portion, and may move to a seat forward position as compared with a position in the accommodation state when being switched from the accommodation state to the use state.

In addition, a reclining device that rotatably connects the seat back to the vehicle body floor or the seat cushion and locks a rotating operation of the seat back may be provided. The reclining device may include a rotating shaft that becomes a rotation center of the seat back, and the base end portion of the first extension member may be disposed at a seat forward position as compared with the rotating shaft in the use state.

According to the above-described configuration, when the seat main body is switched from the accommodation state to the use state, the first extension member can be appropriately accommodated between the seat back and the second extension member. Therefore, it is possible to appropriately cover and hide the gap with the seat main body without deteriorating the appearance of the seat (without unintentionally exposing the first extension member). In addition, the cover member can be compactly disposed.

At this time, in the use state, the first extension member may be accommodated between the seat back and the second extension member, and the rear surface of the seat back and the second extension member may be in contact with each other.

In addition, in the accommodation state, the first extension member may be exposed to an outer side, and the rear surface of the seat back and the second extension member may be in contact with each other.

According to the above-described configuration, the gap with the seat main body can be appropriately covered and hidden while securing the design of the seat without deteriorating the appearance of the seat. In addition, the cover member can be disposed more compactly.

At this time, a base member that supports the seat main body from a downward side, and a reclining device that rotatably connects the seat back to the base member and locks a rotating operation of the seat back may be provided. An extension end portion of the second extension member may be attached to a rearward portion of the base member, and the second extension member may move in a seat front to rear direction with respect to the base member when being switched from the accommodation state to the use state.

According to the above-described configuration, when the seat main body is switched from the accommodation state to the use state, the first extension member can be deformed and the second extension member can be moved in the seat front to rear direction in conformity to the switching. Therefore, the gap with the seat main body can be more effectively covered and hidden.

At this time, the first extension member may be deformed in correspondence with a folding operation of the seat back, and may be disposed along the rear surface of the seat back in the accommodation state.

According to the above-described configuration, the appearance of the seat can be improved without deteriorating the appearance of the seat in the accommodation state.

At this time, a base member that supports the seat main body from a downward side may be provided, the second extension member may include a folded portion that is formed in an extension end portion of the second extension member and is folded upward from the extension end portion, and the folded portion in the second extension member may be attached to a rearward portion of the base member.

According to the above-described configuration, in a switching operation of the seat main body, the second extension member can be appropriately moved in the seat front to rear direction in conformity to a movement operation of the seat main body. In addition, in the switching operation of the seat main body, the second extension member can be suppressed from being unintentionally folded.

At this time, the first extension member may be made of a flexible member, and the second extension member may be made of a plate-shaped member.

According to the above-described configuration, it is possible to realize a cover member that has a simple structure and is capable of appropriately covering and hiding a gap with the seat main body.

### Advantageous Effects of Invention

According to the present invention, it is possible to realize a conveyance seat including a cover member that can appropriately cover a gap with a seat main body even in a case where a state of the seat main body is switched, and has a simple structure.

In addition, according to the present invention, the cover member can be compactly disposed. In addition, in a switching operation of the seat main body, the cover member can be deformed to appropriately follow the seat main body. In addition, according to the present invention, it is possible to appropriately cover and hide the gap with the seat main body while securing the design of the seat without deteriorating the appearance of the seat (without unintentionally exposing the first extension member).

In addition, according to the present invention, it is possible to improve the appearance of the seat without deteriorating the appearance of the seat in the accommodation state.

In addition, according to the present invention, the second extension member can be appropriately moved in the seat front to rear direction in conformity to the movement operation of the seat main body. In addition, it is possible to suppress the second extension member from being unintentionally folded.

### DESCRIPTION OF EMBODIMENTS

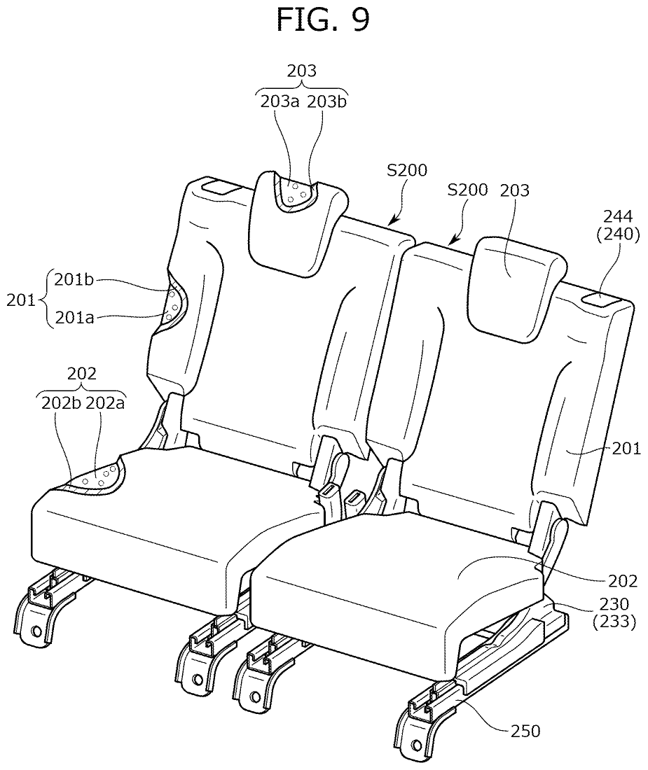

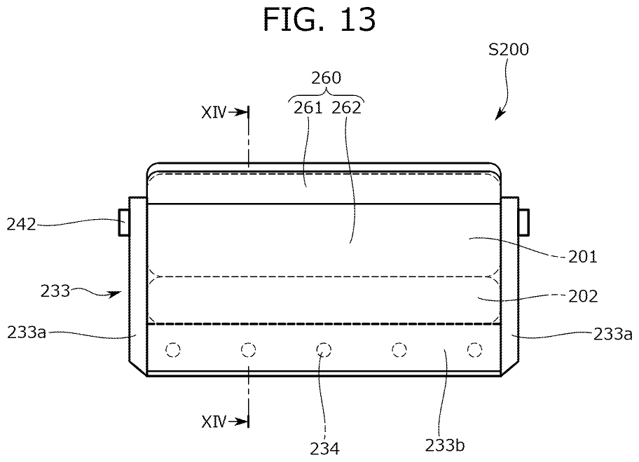

Hereinafter, the second embodiment of the present invention will be described with reference to FIG. 9 to FIG. 18.

This embodiment relates to a conveyance seat capable of being switched between a “use state” and an “accommodation state”. The conveyance seat has the following configuration as main characteristics. Specifically, the conveyance seat includes a cover member that is provided to extend downward from a rear surface of a seat back, and covers a gap between the seat back and a seat cushion in an up to down direction. The cover member includes a first extension member that is deformable in correspondence with a folding operation of the seat back, and a second extension member that extends downward from an extension end portion of the first extension member and covers the gap. The first extension member is accommodated between the seat back and the second extension member in the “use state”, and the first extension member is exposed to an outer side in the “accommodation state”.

Note that, a side where an occupant is seated with respect to the seat back of the conveyance seat is a seat forward side.

As illustrated in FIG. 9, a conveyance seat S200 of this embodiment is, for example, a rear seat corresponding to a rear seat of a vehicle. Note that, the conveyance seat S200 can also be used as a middle seat in a second row of a vehicle including three rows of seats in a vehicle front to rear direction.

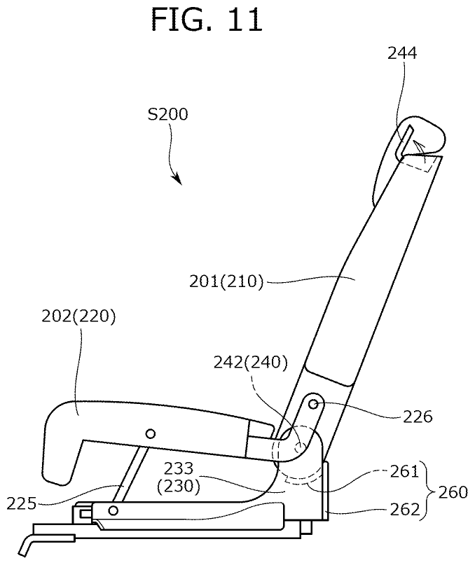

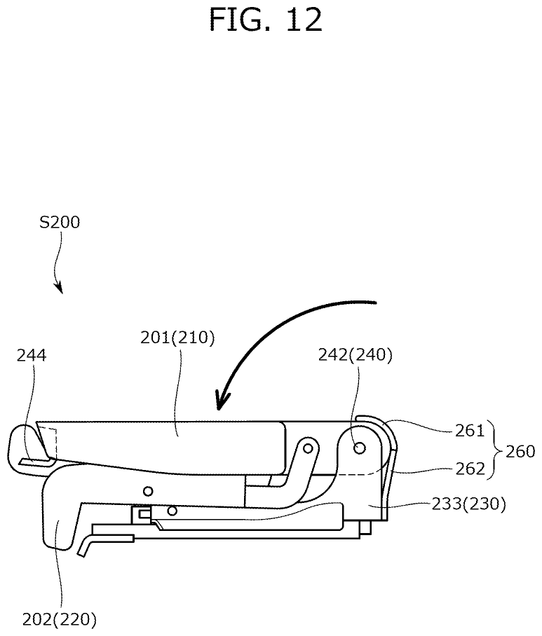

As illustrated in FIG. 11 and FIG. 12, the conveyance seat S200 is a seat in which two types seat arrangements including a “use state” in which an occupant can be seated and an “accommodation state” in which the seat back is folded and the seat main body is accommodated on a vehicle body floor side are possible.

Specifically, in the conveyance seat S200, when an occupant pulls a reclining operation lever 244 located at an upper end portion of a seat main body in the “use state” shown in FIG. 11, the seat main body is folded forward and the state is switched to the “accommodation state” in which the seat main body is accommodated in a vehicle body floor as illustrated in FIG. 12. In addition, when the occupant manually raises the seat main body to an upward side from the accommodation state, the state returns to the “use state”. Note that, the conveyance seat S200 can be switched between a “normal state” located at a reference position in a seat front to rear direction, and a “slide movement state” in which the seat main body has slid to a predetermined position in the seat front to rear direction.

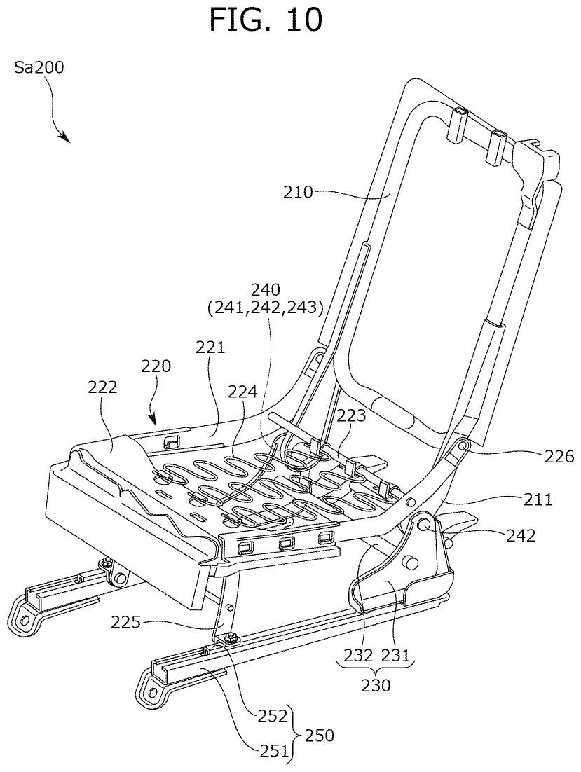

As illustrated in FIG. 9 and FIG. 10, the conveyance seat S200 includes the seat main body including a seat back 201, a seat cushion 202, and a headrest 203, a base member 230 that supports the seat main body from a downward side, a reclining device 240 that rotatably connects the seat back 201 to the base member 230, and locks a rotating operation of the seat back 201, and a rail device 250 that is attached between a vehicle body floor and the base member 230, supports the seat main body to be movable in a front to rear direction, and locks the movement operation of the seat main body.

In addition, as illustrated in FIG. 11 and FIG. 12, the conveyance seat S200 further includes a cover member 260 that is provided to extend downward from a rear surface of the seat back 201 and covers a gap between the seat back 201 and the seat cushion 202 in an up to down direction.

Note that, the cover member 260 is disposed to cover not only the gap between the seat back 201 and the seat cushion 202 in the up to down direction but also a gap between the seat back 201 and the base member 230 (vehicle body floor) in the up to down direction.

As illustrated in FIG. 9, the seat back 201 is a backrest that supports the back of an occupant from a rearward side, and has a configuration in which a pad material 201a is placed on a back frame 210 shown in FIG. 10 as a skeleton, and is covered with a skin material 201b. The seat cushion 202 is a seating portion that supports the occupant from a downward side, and has a configuration in which a pad material 202a is placed on a cushion frame 220 shown in FIG. 10 as a skeleton, and is covered with a skin material 202b from an upper side of the pad material 202a.

The headrest 203 is a head portion that supports the head of the occupant from a rearward side, and has a configuration in which a pad material 203a is placed on a pillar (not illustrated) as a core material, and is covered with a skin material 203b.

As illustrated in FIG. 10, the back frame 210 is constituted by a rectangular frame-shaped body that is a skeleton of the seat back 201, and right and left connecting brackets 211 for connection with the base member 230 are attached to a downward portion of an outer side surface of the back frame 210 in the seat width direction.

The connecting brackets 211 is constituted by a bow-shaped plate member extending in the up to down direction, and upper ends of the connecting brackets 211 are attached to the back frame 210, and lower ends thereof are attached to the base member 230.

A reclining device 240 (reclining main body 241) that rotatably connects the back frame 210 to the base member 230 is attached to a lower end portion of the right connecting bracket 211. In addition, a back rotating shaft 242 that is pivotally supported to the base member 230 in the seat width direction is attached to a lower end portion of the left connecting bracket 211.

As illustrated in FIG. 10, the cushion frame 220 is constituted by an approximately rectangular frame-shaped body that is a skeleton of the seat cushion 202, and mainly includes right and left side frames 221 which are disposed on lateral sides in the seat width direction, a plate-shaped pan frame 222 that connects forward portions of the side frames 221, a pipe-shaped rearward connecting frame 223 that connects rearward portions of the side frames 221, and a plurality of elastic springs 224 which are hooked to the pan frame 222 and the rearward connecting frame 223 and extend in a serpentine shape.

Each of the side frames 221 is constituted by a sheet metal member extending in the seat front to rear direction, and a connecting link 225 for connection with the rail device 250 is attached to a forward portion of an inner side surface of the side frame 221. In addition, a cushion rotating shaft 226 for connection with the back frame 210 is attached to a rearward portion of the inner side surface of the side frame 221.

The connecting link 225 is a rotating member for accommodating the seat main body (seat cushion 202) on a vehicle body floor side, and a pair of the connecting links 225 are attached between the cushion frame 220 and the rail device 250.

As illustrated in FIG. 9 to FIG. 13, the base member 230 is a support member that supports the seat main body, and connects the back frame 210 (connecting brackets 211) and the rail device 250 (upper rails 252) in the up to down direction.

Specifically, the base member 230 includes an approximately L-shaped side base portion 231 that is disposed at right and left lateral sides in the seat width direction and is attached to upper surfaces of the upper rails 252, a pipe-shaped base connecting portion 232 that connects the right and left side base portions 231, and a base cover 233 that covers the side base portion 231 and the base connecting portion 232 from an outer side.

As illustrated in FIG. 11 to FIG. 13, the base cover 233 is a resin-molded product that covers a main body of the base member 230, the reclining device 240, and the rail device 250 from an upward side.

The base cover 233 has a function of guiding a movement of the seat main body (connecting brackets 211) when the seat main body is switched from the “use state” to the “accommodation state” in addition to a function of protecting the reclining device 240 and the rail device 250 from an outer side.

The base cover 233 includes a cover lateral portion 233a that is disposed on right and left lateral sides in the seat width direction and is elongated in the seat front to rear direction, and a cover rearward portion 233b that connects the right and left cover lateral portions 233a.

The cover rearward portion 233b extends in the seat width direction, connects rear end portions of downward portions of the right and left cover lateral portions 233a, is disposed at a rearward position as compared with the back rotating shaft 242, and is disposed at a downward position as compared with the back rotating shaft 242.

A plurality of attachment holes 234 (portions to be attached) which are arranged with a predetermined interval in the seat width direction and to which one end portion (lower end portion) of the cover member 260 (second extension member 262) is attached are formed in the cover rearward portion 233b.

As illustrated in FIG. 10, the reclining device 240 is disposed between the right connecting bracket 211 and the right base member 230 (base connecting portion 232) in the seat width direction.

The reclining device 240 mainly includes a reclining main body 241 that is driven when rotating the back frame 210, a back rotating shaft 242, a spiral spring 243 that biases the back frame 210 to rotate forwardly around the back rotating shaft 242, a reclining operation lever 244 that is operated to release a locked state of the back frame 210 as illustrated in FIG. 9, and a reclining cable (not illustrated) that connects the reclining operation lever 244 and the reclining main body 241.

The reclining main body 241 includes a known lock mechanism, and can switch a state of the back frame 210 between a locked state of being fixed to the base member 230, and an unlocked state capable of rotating with respect to the base member 230.

The back rotating shaft 242 is pivotally supported to the back frame 210 side and the base member 230 side in the seat width direction, and one end of the spiral spring 243 is locked to the back frame 210 side and the other end thereof is locked to the base member 230 side.

Note that, the reclining cable (not illustrated) is pulled by an operation of the reclining operation lever 244, and operates to switch the seat back 201 from a locked state to an unlocked state.

In the above-described configuration, the reclining device 240 locks the seat back 201 in an erected posture in FIG. 11, and when the reclining operation lever 244 is operated, the locked state is released, and the seat back 201 is rotated to a forward side by a biasing force of the spiral spring 243, thereby folding the seat back 201 to a vehicle body floor side in combination with the seat cushion 202 (refer to FIG. 12).

As illustrated in FIG. 9 and FIG. 10, the rail device 250 is a device that supports the seat main body to be slidable in the seat front to rear direction, and is disposed between the seat main body and the vehicle body floor.

The rail device 250 mainly includes right and left lower rails 251 which are fixed to the vehicle body floor and extend in the seat front to rear direction, right and left upper rails 252 which are supported to be slidable along the lower rails 251, a lock member that locks the upper rails 252 not to be slidable with respect to the lower rails 251, a rail operation lever that is operated to release a locked state of the lock member, and a rail cable that connects the lock member and the rail operation lever.

### <Cover Member>

As illustrated in FIG. 11 to FIG. 18, the cover member 260 includes a first extension member 261 that extends from a rear surface of the seat back 201 and is deformable in correspondence with a folding operation of the seat back 201, and a second extension member 262 that extends downward from an extension end portion 261b of the first extension member 261 and covers a gap between the seat back 201 and the seat cushion 202.

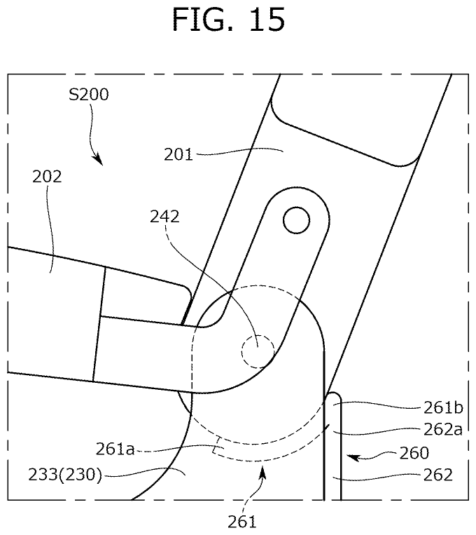

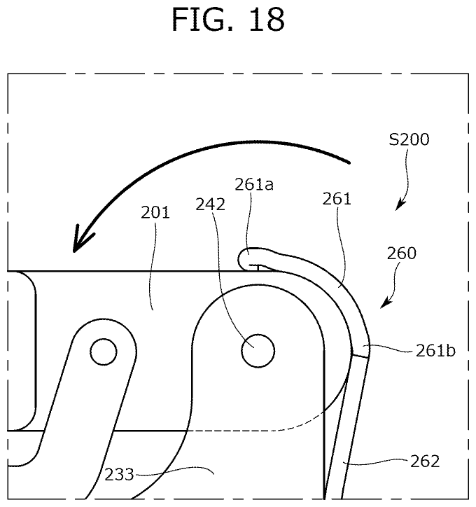

The first extension member 261 is a flexible member (for example, a skin), as illustrated in FIG. 15 and FIG. 18, a base end portion 261a of the first extension member 261 is attached to a rear surface of a downward portion (lower end portion) of the seat back, and the extension end portion 261b of the first extension member 261 is disposed in contact with the rear surface of the seat back 201 along the rear surface.

The first extension member 261 is deformed in correspondence with the folding operation of the seat back 201, is accommodated between the seat back 201 and the second extension member 262 in a “use state” shown in FIG. 15, and is exposed to an outer side in an “accommodation state” as illustrated in FIG. 18.

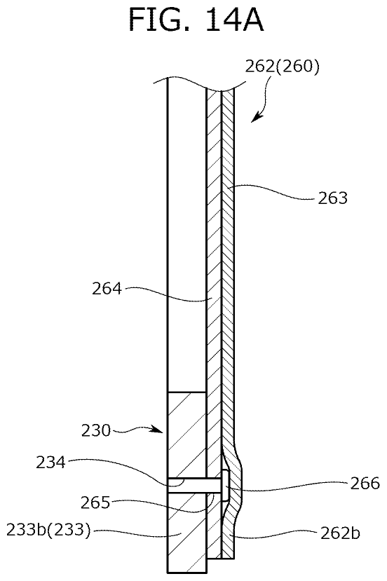

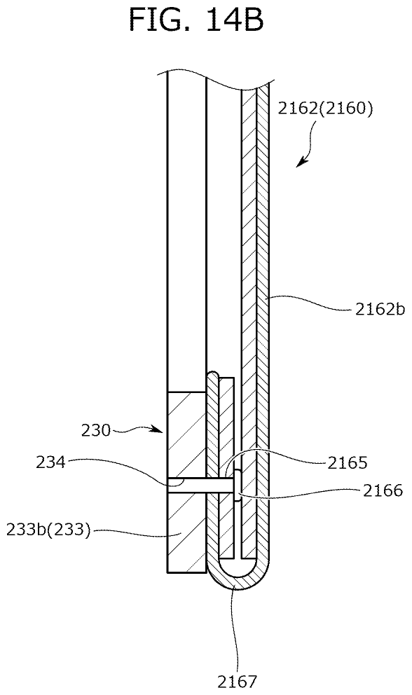

The second extension member 262 is a plate-shaped member. Specifically, as illustrated in FIG. 14A, the second extension member 262 includes a flexible skin 263 (first member) and a plate member 264 (second member) fixed to the skin 263.

The second extension member 262 extends long in the up to down direction, and as illustrated in FIG. 15, a base end portion 262a of the second extension member 262 is connected to the base end portion 261a of the first extension member 261. In addition, as illustrated in FIG. 14A, an extension end portion 262b of the second extension member 262 is attached to a rear end portion of the base member 230.

When being switched from the “use state” shown in FIG. 11 to the “accommodation state” shown in FIG. 12, the second extension member 262 is moved to be inclined to a seat rearward side with respect to the base member 230 in correspondence with (in conformity to) an accommodation operation of the seat back 201.

In the second extension member 262, as illustrated in FIG. 14A, a plurality of attachment holes 265 (attachment portions) which are arranged with a predetermined interval in the seat width direction and are used for attachment to the base member 230 are formed in a downward portion of the plate member 264.

Specifically, in a state in which the attachment holes 234 of the base member 230 and the attachment holes 265 of the second extension member 262 communicate with each other, a plurality of attachment members 266 (attachment bolts) are assembled to fix the second extension member 262 to the base member 230.

Note that, as illustrated in FIG. 14A, the attachment members 266 are arranged between the skin 263 and the plate member 264, and care is taken to prevent the attachment members 266 from being exposed from an outer side (from a seat rearward side).

Note that, as a modification example of the cover member 260, as illustrated in FIG. 14B, a second extension member 2162 may include a folded portion 2167 that is formed at an extension end portion 2162b of the second extension member 2162 and is folded upward from the extension end portion 2162b. In addition, the folded portion 2167 may be attached to a rear end portion of the base member 230.

At this time, an attachment hole 2165 formed in the folded portion 2167 and the attachment hole 234 of the base member 230 may be attached by an attachment member 2166.

### <Deformation Operation of Cover Member According to Seat Switching>

FIG. 15 to FIG. 18 are views illustrating a state in which the conveyance seat S200 is moving from the “use state” to the “accommodation state”. In addition, a state of the cover member 260 at this time is illustrated.

FIG. 15 is a side view of the conveyance seat S200 in the “use state”, and FIG. 18 is a side view of the conveyance seat S200 in the “accommodation state”.

In the “use state” illustrated in FIG. 15, the first extension member 261 is accommodated between the seat back 201 and the second extension member 262, the second extension member 262 extends along the up to down direction, and an upper end portion of the second extension member 262 is in contact with the rear surface of the seat back 201.

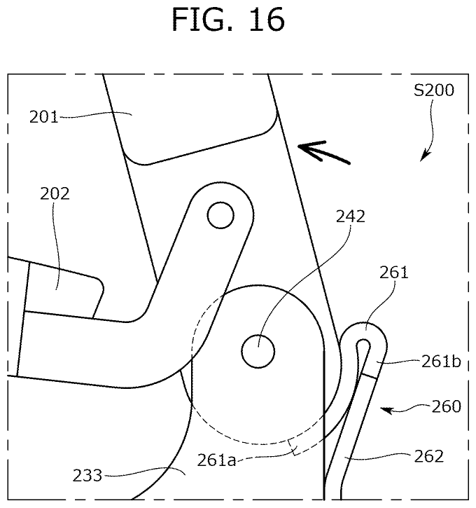

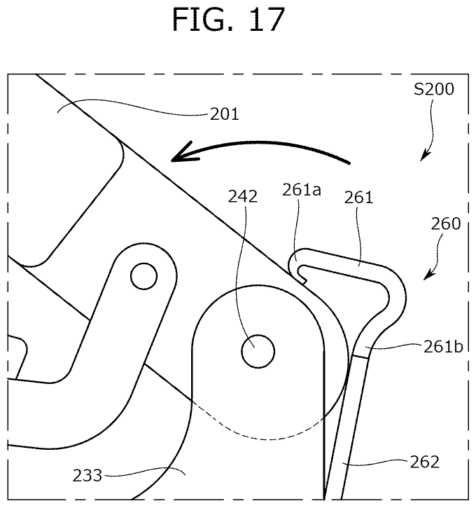

In addition, as illustrated in FIG. 16 and FIG. 17, the first extension member 261 is deformed in accordance with an accommodation operation of the seat main body, and the second extension member 262 is moved to be inclined to a seat rearward side.

In other words, since the first extension member 261 is attached to the seat back 201, the first extension member 261 is drawn into the seat in conformity to the accommodation operation of the seat back 201. In addition, the second extension member 262 is pushed to a rear end portion of the seat back 201 and is inclined to a seat rearward side.

In addition, in the “accommodation state” illustrated in FIG. 18, the first extension member 261 is exposed to an outer side, and the second extension member 262 is at a position inclined to the seat rearward side. An upper end portion of the second extension member 262 is in contact with the rear surface of the seat back 201.

In the above-described configuration, in the “use state” illustrated in FIG. 15, the base end portion 261a of the first extension member 261 is disposed at a downward position as compared with the extension end portion 261b. In addition, in the “accommodation state” illustrated in FIG. 18, the base end portion 261a is disposed at an upward position as compared with the extension end portion 261b.

According to this, the first extension member 261 can be deformed smoothly in conformity to the switching operation of the seat main body. That is, in the switching operation of the seat main body, the cover member 260 (first extension member 261) can be suppressed from being deformed into an unintended shape.

In addition, in the above-described configuration, when the conveyance seat S200 is switched between the “use state” and the “accommodation state”, in the first extension member 261, a contact surface that comes into contact with the seat back 201 is switched between a front surface and a rear surface.

According to this, even in a case of switching the state of the seat main body, a state in which the first extension member 261 is in contact with the rear surface of the seat back 201 is maintained, and thus the cover member 260 can be compactly disposed. In addition, the cover member 260 can cover and hide the gap with the seat main body without deteriorating the appearance of the seat.

In addition, in the above-described configuration, as illustrated in FIG. 15 and FIG. 18, when being reversely switched from the “accommodation state” to the “use state”, the base end portion 261a of the first extension member 261 moves a seat forward position as compared with the position in the “accommodation state”. Specifically, the base end portion 261a is disposed at a seat rearward position as compared with the back rotating shaft 242 2 in the “accommodation state”, and is disposed at a seat forward position as compared with the back rotating shaft 242 in the “use state”.

According to this, when the seat main body is switched from the “accommodation state” to the “use state”, the first extension member 261 can be appropriately accommodated between the seat back 201 and the second extension member 262. That is, it is possible to appropriately cover and hide the gap with the seat main body without unintentionally exposing the first extension member 261.

In addition, in the above-described configuration, the first extension member 261 is disposed to follow the rear surface of the seat back 201 in the “accommodation state”.

According to this, the appearance of the seat can be improved without deteriorating the appearance of the seat in the “accommodation state”.

### OTHER EMBODIMENTS

In the above-described embodiments, the conveyance seat S200 moves to the seat forward side for accommodation, but the conveyance seat S200 may move to a seat rearward side or a seat lateral side for accommodation without particular limitation.

In a case where the conveyance seat S200 moves to the seat rearward side for accommodation, when the seat main body is accommodated, it is preferable that a positional relationship between the seat back 201 and the seat cushion 202 in the up to down direction is reversed.

In the above-described embodiments, as illustrated in FIG. 9 and FIG. 10, the reclining device 240 rotatably connects the seat back 201 to the vehicle body floor (base member 230), but the seat back 201 may be rotatably connected to the seat cushion 202 without particular limitation.

In the above-described embodiments, as illustrated in FIG. 9 and FIG. 10, the base member 230 is fixed to the vehicle body floor through the rail device 250, but a modification can be made appropriately without particular limitation. For example, the rail device 250 may be unnecessary, and the base member 230 may be fixed directly to the vehicle body floor.

In addition, a support bracket (support member) (not illustrated) fixed onto the vehicle body floor may be used instead of the base member 230.

In the above-described embodiments, as illustrated in FIG. 11 and FIG. 12, the cover member 260 is disposed to cover not only the gap between the seat back 201 and the seat cushion 202 in the up to down direction, but also the gap between the seat back 201 and the base member 230 (vehicle body floor) in the up to down direction, but there is no particular limitation.

For example, the cover member 260 may simply cover the gap between the seat back 201 and the seat cushion 202 or may simply cover the gap between the seat back 201 and the base member 230 (vehicle body floor).

In the above-described embodiments, as illustrated in FIG. 11 and FIG. 15, in the “use state”, the first extension member 261 is accommodated between the seat back 201 and the second extension member 262, but there is no particular limitation.

For example, at least a part of the first extension member 261 may be accommodated between the seat back 201 and the second extension member 262.

In the above-described embodiment, as illustrated in FIG. 11 and FIG. 15, in the “use state”, the base end portion 261a of the first extension member 261 is disposed at a seat forward position as compared with the back rotating shaft 242. However, there is no particular limitation, and it is not necessary for the base end portion 261a to be located at the seat forward position as compared with the back rotating shaft 242.

For example, when being switched from the “accommodation state” to the “use state”, a positional relationship in which the first extension member 261 can be inserted inside the seat main body by the rotating operation of the seat back 201 may be employed.

In the above-described embodiments, description has been given of the accommodable conveyance seat that is used in automobiles as an example, but the conveyance seat can also be used as not only conveyance seats of trains, buses, and the like, but also conveyance seats of airplanes, ships, and the like without particular limitation.

In the above-described embodiments, description has been given mainly of the conveyance seat according to the present invention.

However, the above-described embodiments are merely one example for facilitating understanding of the present invention, and are not intended to limit the present invention. The present invention can be modified and improved without departing from the gist of the present invention, and equivalents thereof are also included in the present invention.

### Third Embodiment

A third embodiment of the present invention relates to a conveyance seat, and more particularly, to a conveyance seat including an airbag device.

In recent, a side airbag is provided in a vehicle seat to protect an occupant against impact from a lateral side. The side airbag protects the occupant by cushioning and distributing impact loads.

A side airbag provided in a seat back efficiently transfers inflation energy of the airbag to a sewn portion (tear line) that is a seam of a skin (seat cover) to fracture the sewn portion in a short time. In order to deploy the airbag without delay, a stay cloth and the skin are sewn at the sewn portion, and a base end portion opposite to the sewn portion is fixed to a back frame.

However, since a bracket or the like is used to fix the stay cloth to the back frame, there is a problem that a structure of the seat back becomes complicated. Therefore, for example, in a vehicle seat relating to JP 2015-003578 A, a pull-in member is formed in a base end portion of the stay cloth, and the stay cloth is fixed by using a clip (attachment member) provided in a pull-in groove of a cushion pad.

### Technical Problem

Even in a case where the stay cloth is fixed to the pull-in groove by the attachment member such as the clip, it is required to firmly fix the attachment member so that the attachment member is not detached from the pull-in groove when a side airbag is deployed. However, when the attachment member is firmly fixed, an excessive load may be applied to the attachment member when the airbag is deployed, and thus there is a possibility that the attachment member may be damaged.

The third embodiment of the present invention has been made in consideration of the problem, and an object thereof is to provide a conveyance seat in which a load applied to an attachment member when an airbag is deployed is reduced.

### Solution to Problem

The problem is solved by the following conveyance seat including an airbag and an inflator according to the present invention. Specifically, the conveyance seat includes: a frame; a pad disposed on the frame; a skin which covers the pad and in which a tear line to be fractured when the airbag is deployed is formed at a part; an attachment member that is provided in the pad; a first stay cloth which extends from the tear line toward the attachment member of the pad and of which the amount of tensile elongation is smaller as compared with the skin; a second stay cloth that extends from a part of the skin or the first stay cloth and of which the amount of tensile elongation is smaller as compared with the skin; a first engagement member that is directly or indirectly connected to the first stay cloth and engages with and is attached to the attachment member; and a second engagement member that is directly or indirectly connected to the second stay cloth and engages with and is attached to an engaged portion provided at a position different from a position of the attachment member in the pad.

Since the first stay cloth extending from the tear line and the second stay cloth are fixed by the first engagement member that is connected to the first stay cloth and engages with the attachment member, and the second engagement member that engages with the engaged portion provided at a position different from a position of the attachment member, a load applied to the attachment member when the airbag is deployed is reduced, and according to this, for example, damage of the attachment member is suppressed.

In addition, in the conveyance seat, the first stay cloth and the second stay cloth may be constituted by one sheet of stay cloth.

When the first stay cloth and the second stay cloth are constituted by one sheet of stay cloth, an increase in the number of components can be suppressed.

In addition, in the conveyance seat, the second engagement member may have higher hardness or higher heat resistance as compared with the first engagement member.

When the second stay cloth is supported by the second engagement member having higher hardness or higher heat resistance as compared with the first engagement member, elongation of the skin can be more firmly restricted when the airbag is deployed.

In addition, in the conveyance seat, the engaged portion may be provided to be located on a further tear line side as compared with the attachment member.

When the engaged portion is located on the further tear line side as compared with the attachment member, a structure of attaching the second stay cloth to the pad can be made compact.

In addition, in the conveyance seat, a plurality of the attachment members may be provided in a height direction of the conveyance seat, and the second engagement member may be disposed between the attachment members adjacent to each other.

When the second engagement member is disposed between the attachment members adjacent to each other, the first stay cloth and the second stay cloth can be more firmly supported when the airbag is deployed.

In addition, in the conveyance seat, the second engagement member may be disposed in a region other than a region where the first stay cloth is disposed.

When the second engagement member is disposed in a region other than the region where the first stay cloth is disposed, the second engagement member can be made small.

In addition, in the conveyance seat, a through-hole through which the second stay cloth passes toward a rear surface side of the pad may be formed at a boundary between a bank portion and the seat surface portion of the pad.

When the through-hole through which the second stay cloth passes to a rear surface side is formed at the boundary between the bank portion and the seat surface portion, the through-hole can also serve as a hole that allows an occupant to sink to the pad in a case where a large load is applied to the occupant at the time of rear collision.

In addition, in the conveyance seat, an assembly through-hole into which an arm for drawing the skin is inserted when assembling the skin to the pad may be formed in the vicinity of the attachment member, and the second stay cloth may pass through the assembly through-hole and may be taken around to a rear side of the pad.

When the assembly through-hole that is used when assembling the skin to the pad is used as a through-hole for taking around the second stay cloth to a rear surface side of the pad, the number of through-holes can be reduced, and a decrease in the rigidity of the pad can be suppressed.

In addition, the problem is solved by the following conveyance seat including an airbag and an inflator according to the present invention. Specifically, the conveyance seat includes: a frame; a pad which is disposed on the frame and in which a vertical pull-in groove extending in a height direction of the conveyance seat on a front surface side is formed; a skin which covers the pad and in which a tear line to be fractured when the airbag is deployed is formed at a part; an attachment member that is provided in the vertical pull-in groove of the pad; a first stay cloth which extends from the tear line toward the attachment member of the pad and of which the amount of tensile elongation is smaller as compared with the skin; a second stay cloth that extends from a part of the skin or the first stay cloth and of which the amount of tensile elongation is smaller as compared with the skin; a first engagement member that is directly or indirectly connected to the first stay cloth and engages with and is attached to the attachment member; and a second engagement member that is directly or indirectly connected to the second stay cloth and engages with and is attached to an engaged portion disposed at a position different from a position of the vertical pull-in groove in which the attachment member is provided in a seat width direction in the pad.

Since the first stay cloth extending from the tear line and the second stay cloth extending from a part of the skin or the first stay cloth are fixed by the first engagement member that engages with and is attached to the attachment member provided in the vertical pull-in groove, and the second engagement member that engages with and is attached to an engaged portion that is disposed at a position different from a position of the vertical pull-in groove in the seat width direction, a load applied to the attachment member when the airbag is deployed is reduced, and damage of the attachment member is suppressed.

In addition, since the second engagement member can support at a position different from a position of the first engagement member in the seat width direction, elongation of the skin can be more firmly restricted when the airbag is deployed.

### Advantageous Effects of Invention

According to the present invention, since the first stay cloth extending from the tear line and the second stay cloth extending from the first stay cloth are fixed by the first engagement member that is connected to the first stay cloth and engages with the attachment member, and the second engagement member that engages with an engaged portion provided at a position different from a position of the attachment member, a load applied to the attachment member when the airbag is deployed is reduced, and for example, damage of the attachment member can be suppressed.

In addition, when the first stay cloth and the second stay cloth are constituted by one sheet of stay cloth, an increase in the number of components can be suppressed.

In addition, when the second stay cloth is supported by the second engagement member having higher hardness or higher heat resistance as compared with the first engagement member, elongation of the skin can be more firmly restricted when the airbag is deployed.

When the engaged portion is located on the further tear line side as compared with the attachment member, a structure of attaching the second stay cloth to the pad can be made compact.

In addition, when the second engagement member is disposed between the plurality of attachment members, the first stay cloth and the second stay cloth can be more firmly supported when the airbag is deployed.

In addition, when the second engagement member is disposed in a region different from the region where the first stay cloth is disposed, the second engagement member can be made small.

In addition, when the through-hole through which the second stay cloth passes to a rear surface side is formed at the boundary between the bank portion and the seat surface portion, the through-hole can also serve as a hole that allows an occupant to sink to the pad in a case where a large load is applied to the occupant at the time of rear collision.

In addition, when the assembly through-hole that is used when assembling the skin to the pad is used as a through-hole for taking around the second stay cloth to a rear surface side of the pad, the number of through-holes can be reduced, and a decrease in the rigidity of the pad can be suppressed.

In addition, since the first stay cloth extending from the tear line and the second stay cloth extending from the first stay cloth are fixed by the first engagement member that engages with and is attached to the attachment member provided in the vertical pull-in groove, and the second engagement member that engages with and is attached to an engaged portion that is disposed at a position different from a position of the vertical pull-in groove in the seat width direction, a load applied to the attachment member when the airbag is deployed is reduced, and for example, damage of the attachment member is suppressed.

In addition, since the second engagement member can support the stay cloth at a position different from a position of the first engagement member in the seat width direction, elongation of the skin can be more firmly restricted when the airbag is deployed.

### DESCRIPTION OF EMBODIMENTS

Hereinafter, a configuration of the conveyance seat according to a first example of this embodiment will be described with reference to the accompanying drawings. However, the following embodiment is merely one example for facilitating understanding of the present invention, and is not intended to limit the present invention. That is, the present invention can be modified and improved without departing from the gist of the present invention, and equivalents thereof are also included in the present invention.

Note that, hereinafter, as an example of the conveyance seat, a vehicle seat is exemplified, and a configuration example thereof will be described. However, the present invention is not limited to vehicle seats mounted on ground traveling conveyances including wheels such as automobiles and trains, and may be applied to seats mounted on aircrafts, ships, and the like which move other than on the ground.

In addition, in the following description, “front to rear direction” is a front to rear direction of a vehicle seat, and is a direction that coincides with an advancing direction when a vehicle is traveling. In addition, “seat width direction” is a width direction of the vehicle seat and is a direction that coincides with a right to left direction when viewed from an occupant who is seated on the vehicle seat. In addition, “up to down direction” is an up to down direction of the vehicle seat, and is a direction that coincides with a vertical direction when the vehicle is traveling on a horizontal plane.

In addition, in the following description, in a case where description is made by attaching “seat” to various directions such as “seat width direction” and “seat height direction”, it is assumed that the description represents a direction with respect to the vehicle seat. In a case where description is made by attaching “vehicle” such as “vehicle inner side” and “vehicle outer side”, it is assumed that the description represents a direction with respect to the vehicle.

In addition, with respect to shapes, positions, postures, and the like of respective portions of the vehicle seat to be described below, description will be made on the assumption of a case in which an occupant can be seated on the vehicle seat unless otherwise stated.

### Basic Configuration of Vehicle Seat According to This Embodiment

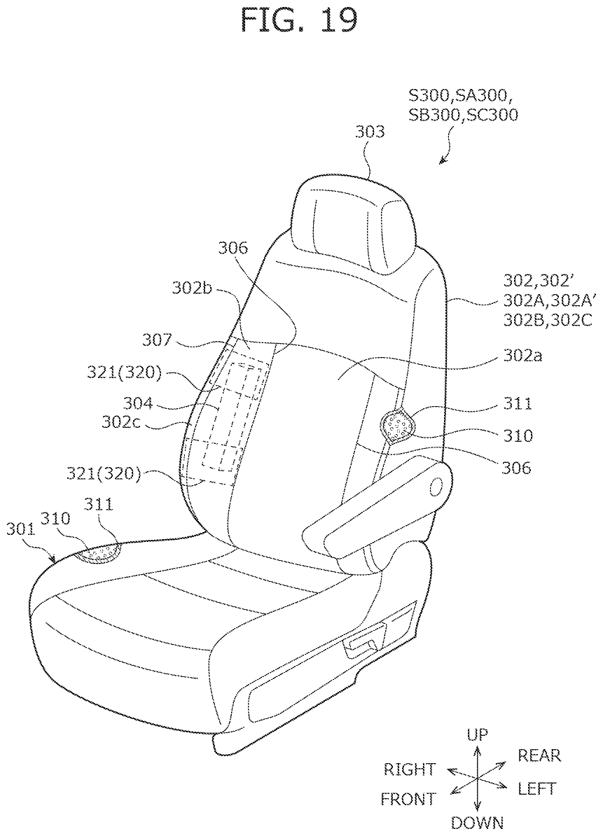

A basic configuration of a vehicle seat (hereinafter, a vehicle seat S300) according to a first example of this embodiment will be described with reference to FIG. 19. FIG. 19 is a perspective view when the vehicle seat S300 is viewed diagonally from a forward side. In FIG. 19, a part of the vehicle seat S300 is illustrated in the drawing with a configuration in which a skin 311 (also referred to as a trim cover) is removed for convenience of illustration.

The vehicle seat S300 is a seat which is placed on a vehicle body floor and on which an occupant of the vehicle is seated. In this embodiment, the vehicle seat S300 is used as a front seat corresponding to a vehicle front seat. However, there is no limitation thereto, and the vehicle seat S300 may be a rear seat of the vehicle, or can be used as a middle seat in a second row or a rear seat in a third row in a vehicle including three rows of seats in a front to rear direction.

As illustrated in FIG. 19, the vehicle seat S300 includes a seat cushion 301 that becomes a seating portion configured to support buttocks of a seated occupant, a seat back 302 that becomes a backrest configured to support the back of the seated occupant, and a headrest 303 that is disposed at an upper portion of the seat back 302 and supports the head of the seated occupant as main constituent elements.

In the seat cushion 301, a rear end portion thereof is connected to a lower end portion of the seat back 302. In addition, the seat cushion 301 has a configuration in which a cushion pad 310 is placed on a cushion frame and is covered with a skin 311. The seat back 302 has a configuration in which a cushion pad 310 is placed on a back frame, and the cushion pad 310 is covered with a skin 311.

In addition, the seat cushion 301 and the seat back 302 are connected to each other with a reclining mechanism (not illustrated) interposed therebetween. A slide rail (not illustrated) is installed at a lower portion of the seat cushion 301, and the vehicle seat S300 is placed on a vehicle body floor in a state capable of sliding in the front to rear direction due to the slide rail.

A seat frame F300 (frame) is provided inside the vehicle seat S300, and the seat frame F300 mainly includes a cushion frame that is a skeleton of the seat cushion 301 and a back frame that is a skeleton of the seat back 302.

In the cushion pad 310, a cushion portion is formed by a foam, and the cushion portion is covered with the skin 311. As the foamed body, a polypropylene bead foam, a polyethylene bead foam, a polypropylene foam, a polyethylene foam, an acrylonitrile/styrene foam, an ethylene vinyl acetate copolymer resin, a urethane foam material, or the like, or a combination thereof is used. In this embodiment, the cushion pad 310 is a urethane pad formed by foam molding by using a urethane foaming agent.

In addition, the skin 311 is constituted by fabric, a film, cloth, leather, a sheet, or the like, and is attached to cover the cushion pad 310 in a state of stretched so that a predetermined tension is applied.

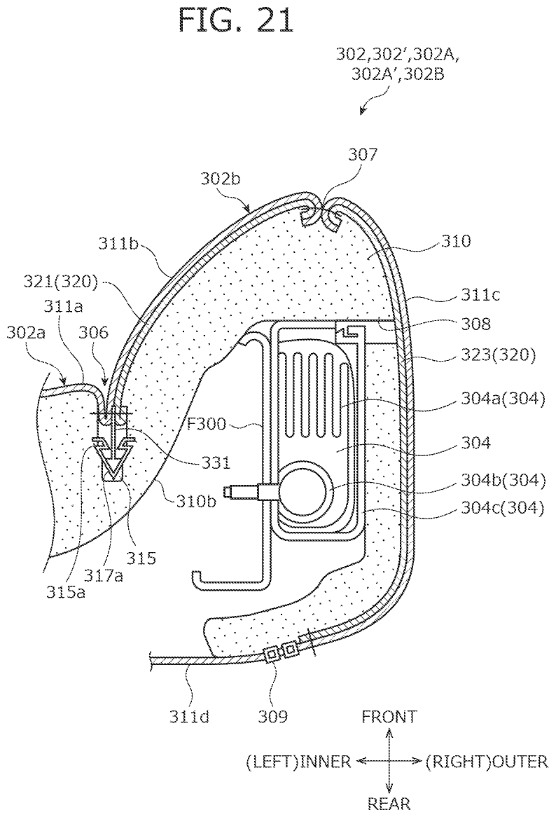

As illustrated in FIG. 21, the skin 311 that covers the seat back 302 includes a seat surface covering portion 311a, a bank portion covering portion 311b, a lateral portion covering portion 311c, and a rear surface covering portion 311d. The seat surface covering portion 311a and the bank portion covering portion 311b are connected by sewing at a sewn portion 306 that is pulled into a vertical pull-in groove 317a formed between a seat surface portion 302a and a bank portion 302b. Note that, the sewn portion 306 forms a pull-in line.

The bank portion covering portion 311b and the lateral portion covering portion 311c are connected by sewing at a sewn portion 307 at a front end of the bank portion 302b. The sewn portion 307 forms a tear line that is fractured when an airbag 304a is deployed.

The lateral portion covering portion 311c and the rear surface covering portion 311d are connected by a line fastener 309 at a rear surface portion 302d. The rear surface covering portion 311d of the seat back 302 connects a right lateral portion covering portion 311c and a left lateral portion covering portion (not illustrated) of the seat back 302.

### <Pull-In Groove 317>

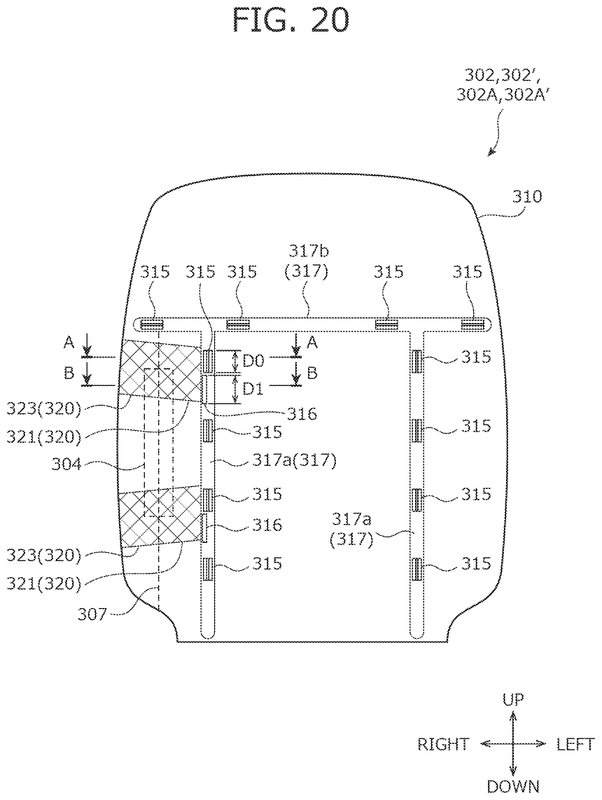

As illustrated in FIG. 20, a pull-in groove 317 is formed in the cushion pad 310 of the seat back 302. The pull-in groove 317 includes two vertical pull-in grooves 317a extending in a seat vertical direction and a transverse pull-in groove 317b extending in the seat width direction. The transverse pull-in groove 317b connects upper ends of the two vertical pull-in grooves 317a, and the entirety of the pull-in groove 317 is formed to have an inverted U-shape when viewed from a seat forward side. Note that, the arrangement of the pull-in groove 317 is merely one example, and the transverse pull-in groove 317b may be disposed between the two vertical pull-in grooves 317a, or the entirety of the pull-in groove 317 may be formed in an H-shape when viewed from the seat forward side.

### <Clip 315>

A plurality of clips 315 (attachment members) are provided with a predetermined interval at the inside of the vertical pull-in grooves 317a and the transverse pull-in groove 317b. As illustrated in FIG. 21, the clips 315 are fixed in a state of being partially embedded in a bottom portion of the vertical pull-in grooves 317a. In the clips 315, a cross-section thereof is formed in an approximately V-shape, and a top portion thereof is provided with a holding portion 315a that holds an arrowhead-shaped tip end portion 331a of a pull-in member 331 (first engagement member). Note that, the clips 315 may be formed to have a U-shaped cross-section or a C-shaped cross-section.

The clips 315 are made of a resin, and is made of, for example, a polyacetal (POM) resin, a polypropylene (PP) resin, a polyamide (PA) resin, a polycarbonate (PC) resin, or the like. The clips 315 may be formed by the polyacetal (POM) resin having relatively high strength.

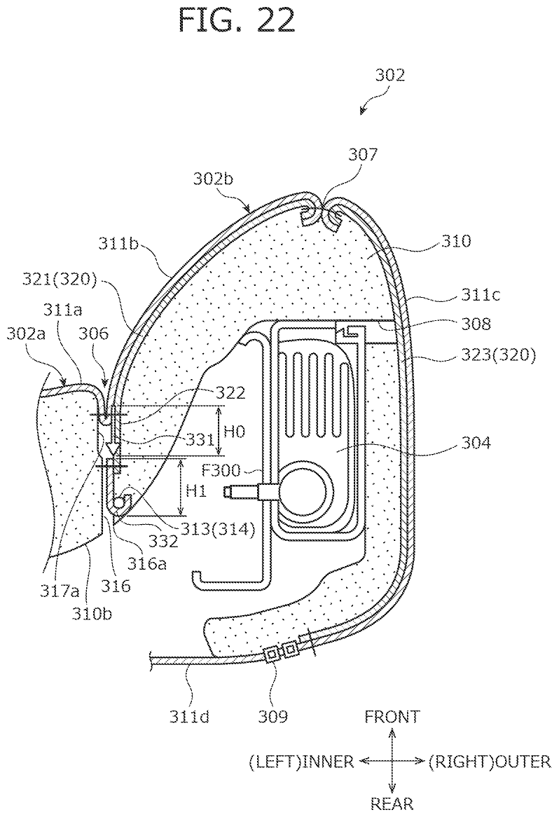

Note that, as illustrated in FIG. 22, in each of the vertical pull-in grooves 317a, a through-hole 316 that extends from a bottom portion of the vertical pull-in groove 317a to a rear surface 310b of the cushion pad 310 is formed between the clips 315 adjacent to each other. Due to the through-hole 316, a trim J-hook (second engagement member) provided in a stay cloth 320 to be described later, and the like can pass therethrough up to the rear surface 310b of the cushion pad 310.

### <Pull-in Member 331 (First Engagement Member)>

As illustrated in FIG. 21 to FIG. 23, at the sewn portion 306 (pull-in line) between the seat surface covering portion 311a and the bank portion covering portion 311b, the pull-in member 331 (first engagement member) is attached to the skin 311 by sewing.

The pull-in member 331 can be fixed to the clip 315 by inserting a tip end portion 331a of the pull-in member 331 into the holding portion 315a of the clip 315. The pull-in member 331 is made of a resin, and is formed by, for example, a polypropylene (PP) resin.

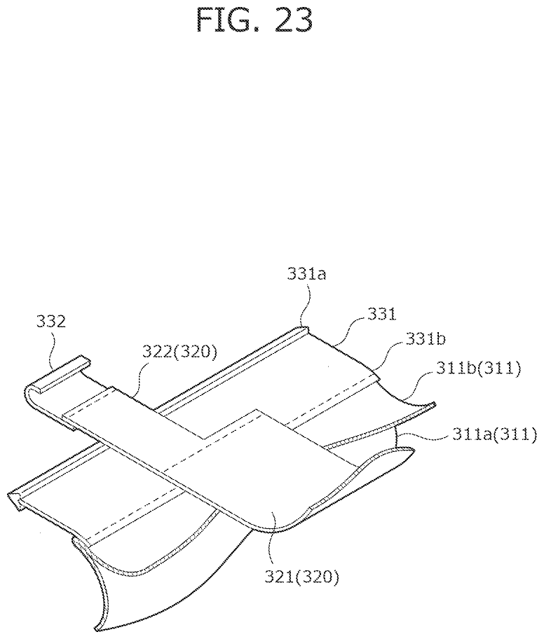

As illustrated in FIG. 21 and FIG. 23, a rear end portion 331b of the pull-in member 331 is directly connected to the skin 311 at the sewn portion 306.

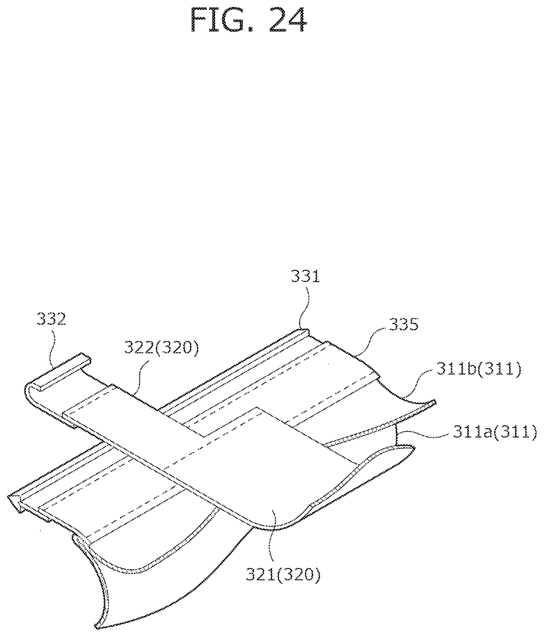

However, as illustrated in FIG. 24, the rear end portion 331b of the pull-in member 331 may be indirectly connected to the skin 311 through non-woven fabric 335. In other words, one end of the non-woven fabric 335 may be fixed to the skin 311 by sewing at the sewn portion 306, and the other end of the non-woven fabric 335 may be connected to the rear end portion 331b of the pull-in member 331 by sewing.

### <Airbag Device 304>

An airbag device 304 has a known configuration, and is schematically illustrated in FIG. 21 and FIG. 22. As illustrated in FIG. 21 and FIG. 22, the airbag device 304 is provided inside the bank portion 302b of the seat back 302, and is attached to the seat frame F300 and thus a position thereof is fixed. The airbag device 304 is configured to be accommodated in a space formed by the cushion pad 310.

The airbag device 304 includes an airbag 304a, an inflator 304b that supplies a gas to the airbag 304a, and a case 304c that covers the airbag 304a and the inflator 304b.

As illustrated in FIG. 19 and FIG. 21, the airbag device 304 is fixed to a right side of the seat frame F300 (an outer side of the vehicle seat S300), and a slit 308 is formed in the cushion pad 310 on a right side of the airbag device 304. When the airbag 304a bulges from the airbag device 304, the cushion pad 310 is fractured at the slit 308, and the skin 311 is incised at the sewn portion 307 (tear line), and the airbag 304a is deployed outward.

### <Stay Cloth 320>

As illustrated in FIG. 20, the stay cloth 320 is disposed along a surface of the bank portion 302b at a portion corresponding to the airbag device 304, in other words, at a position overlapping the airbag device 304 when the seat back 302 is viewed from a forward side. The stay cloth 320 is also referred to as an inner side stay cloth and may be made of a material of which the amount of tensile elongation is smaller as compared with the skin 311. In other words, the stay cloth 320 is made of a sheet-shaped member having stretchability smaller than that of the skin 311. Therefore, at the time of airbag deployment, the stay cloth 320 transfers an applied force to the tear line that is a fracture portion, and the deployment of the airbag can be promoted. In a case of this embodiment, as illustrated in FIG. 20, the stay cloth 320 is constituted by two sheets of stay cloth disposed on upper and lower sides. This is merely one example, the stay cloth 320 may be constituted by one sheet, or may be constituted by two or more sheets of stay cloths 320.

Since the stay cloths 320 disposed on upper and lower sides have the same configuration, hereinafter, description will be given of the stay cloth 320 disposed on an upper side.

As illustrated in FIG. 21, the stay cloth 320 includes a bank portion-side stay cloth 321 (first stay cloth), and a lateral-side stay cloth 323 that is disposed at a side portion 302c of the seat back 302. The bank portion-side stay cloth 321 is provided along a bank portion surface of the cushion pad 310 from the sewn portion 307 that is a tear line to the sewn portion 306 that is a pull-in line.

The lateral-side stay cloth 323 is disposed along a lateral portion surface of the cushion pad 310 from the sewn portion 307 to a rear surface portion 302d at the side portion 302c of the seat back 302.

As illustrated in FIG. 21 to FIG. 23, one end of the bank portion-side stay cloth 321 is sewn together with the skin 311 and the pull-in member 331 at the sewn portion 306. In addition, the other end of the bank portion-side stay cloth 321 is sewn together with the skin 311 and the one end of the lateral-side stay cloth 323 at the sewn portion 307. The other end of the lateral-side stay cloth 323 is sewn to the skin 311 in the vicinity of a connecting portion with the rear surface portion 302d and is fixed thereto.

Note that, as illustrated in FIG. 23, the bank portion-side stay cloth 321 and the pull-in member 331 are sewn together and are directly connected to each other. This is merely one example, and the bank portion-side stay cloth 321 and the pull-in member 331 may be configured not to be sewn together. That is, the bank portion-side stay cloth 321 (first stay cloth) may not be hanged directly to the clip 315, and may be configured so that the bank portion-side stay cloth 321 and the pull-in member 331 may be indirectly connected. The bank portion-side stay cloth 321 is fixed by a trim J-hook 332 to be described later.

When the airbag 304a is inflated by the airbag device 304, inflation energy of the airbag 304a is transferred to the bank portion-side stay cloth 321 and the lateral-side stay cloth 323 through the cushion pad 310. When the bank portion-side stay cloth 321 and the lateral-side stay cloth 323 receive the inflation energy of the airbag 304a, the inflation energy of the airbag 304a is focused to a sewing yarn of the sewn portion 307 (tear line), and the sewing yarn is cut. According to this, the bank portion-side stay cloth 321 and the lateral-side stay cloth 323 are detached from the sewn portion 307, the cushion pad 310 is fractured at the slit 308, and the airbag 304a is deployed outward.

### <Auxiliary Stay Cloth 322 (Second Stay Cloth) and Trim J-Hook 332 (Second Engagement Member)>

Hereinafter, description will be given of an auxiliary stay cloth 322 as a second stay cloth, and the trim J-hook 332 provided as a second engagement member which are characteristic configurations of this embodiment.

As described above, the through-hole 316 extending from the bottom portion of the vertical pull-in groove 317a to the rear surface 310b of the cushion pad 310 is formed between the adjacent clips 315 disposed in the vertical pull-in groove 317a. An insert wire 313 is provided in the vicinity of an opening portion 316a of the through-hole 316 on the rear surface 310b of the cushion pad 310 as illustrated in FIG. 22, and forms an engaged portion 314.

As illustrated in FIG. 22 and FIG. 23, the auxiliary stay cloth 322 (second stay cloth) that extends from the bank portion-side stay cloth 321 is provided. Specifically, the auxiliary stay cloth 322 is provided to extend from an end portion of the bank portion-side stay cloth 321 sewn together with the skin 311 at the sewn portion 306 toward the rear surface 310b of the cushion pad 310, in other words, in a rear surface direction of the seat back 302. In addition, the trim J-hook 332 (second engagement member) is connected to a tip end of the auxiliary stay cloth 322 by sewing.

The trim J-hook 332 is hooked to the insert wire 313 of the engaged portion 314 after passing through the through-hole 316, and according to this, the stay cloth 320 and the skin 311 can be fixed to the cushion pad 310.

Note that, in FIG. 23, the bank portion-side stay cloth 321 and a suspender cord of the pull-in member 331 are directly sewn together. However, the bank portion-side stay cloth 321 and the pull-in member 331 may not be sewn together and the bank portion-side stay cloth 321 may not be hanged to the clip 315 by the pull-in member 331 as described above. That is, the trim J-hook 332 may be fixed to the insert wire 313 of the engaged portion 314, and the bank portion-side stay cloth 321 may be configured to be pulled in by only the engaged portion 314 through the auxiliary stay cloth 322.

Note that, as illustrated in FIG. 20, the size D1 of the through-hole 316 is set to be larger than a longitudinal length DO of the clip 315. When the size D1 of the through-hole 316 is enlarged, it is easy for the trim J-hook 332 and the auxiliary stay cloth 322 to pass therethrough up to the rear surface 310b of the cushion pad 310.

Note that, the trim J-hook 332 is made of a polypropylene (PP) resin in a similar manner as in the pull-in member 331. The trim J-hook 332 may be formed to have higher hardness or heat resistance as compared with the pull-in member 331. The hardness or the heat resistance can be changed even in the propylene resin by changing detailed blending of a resin material and by changing the hardness or the heat resistance.

When the trim J-hook 332 is made to have higher hardness or heat resistance as compared with the pull-in member 331, since the auxiliary stay cloth 322 (second stay cloth) can be more strongly supported, when the airbag 304a is deployed, elongation of the skin 311 can be firmly restricted. That is, at the time of airbag deployment, the skin 311 and the stay cloth 320 are less likely to be detached from the clip 315, and thus the airbag 304a can be deployed in a more stable manner.

In addition, as illustrated in FIG. 22, a longitudinal length H1 of the trim J-hook 332 may be set to be larger than the length H0 of the pull-in member 331, and a material of the trim J-hook 332 may be set to be harder. For example, when the trim J-hook 332 is made of a metallic material such as iron or aluminum, the stay cloth 320 can be more firmly fixed.

Note that, in this embodiment, the insert wire 313 of the engaged portion 314 is provided to be located at the tear line (sewn portion 307) as compared with the clip 315. In other words, the insert wire 313 is provided at a side portion of the opening portion 316a located on an outer side as compared with the clip 315 in the seat width direction. When the insert wire 313 is disposed in this manner, a structure of attaching the auxiliary stay cloth 322 can become compact.

Note that, the insert wire 313 may be disposed at an inner side portion of the through-hole 316 in the seat width direction.

In addition, the trim J-hook 332 (second engagement member) may be disposed between the clips 315 (attachment member) disposed adjacent to each other on upper and lower sides at the inside of the vertical pull-in groove 317a. The bank portion-side stay cloth 321 can be firmly supported at the time of airbag deployment.

In addition, as illustrated in FIG. 22, the trim J-hook 332 is disposed in a region other than a region where the bank portion-side stay cloth 321 (first stay cloth) is disposed, and according to this, the trim J-hook 332 can be made small.

Note that, for example, as disclosed in JP 2015-003578 A, when a slit is formed in the pull-in groove 317 formed in the cushion pad 310, the amount of sinking of an occupant at the time of vehicle rear collision can be improved.

The through-hole 316 through which the trim J-hook 332 of this embodiment passes may be configured to also serve as a slit for allowing the occupant to further sink to the cushion pad 310 in a case where a large load is applied to the occupant at the time of vehicle rear collision. That is, the slit of the vertical pull-in groove 317a formed for improving the amount of sinking may also be used as the through-hole 316 through which the trim J-hook 332 passes. Since the through-hole 316 may not be formed separately for passing-through of the trim J-hook 332, a decrease in the rigidity of the cushion pad 310 can be suppressed.

In addition, for example, as disclosed in U.S. Pat. No. 8,245,377, a device that automatically assembles the skin 311 to the cushion pad 310 is known. In a vehicle seat capable of being assembled by the device, the clip 315 is provided at a predetermined position of the pull-in groove, and an assembly through-hole is formed at the periphery of the clip 315. The device is provided with an arm that inserts the skin into the pull-in groove, and the arm grips a skin disposed on a surface after passing through the assembly through-hole from a rear surface of the cushion pad, and inserts the skin to the rear surface side of the cushion pad, thereby fixing the skin to the clip.

When the assembly through-hole through which the arm passes is used as the through-hole 316 through which the trim J-hook 332 of this embodiment passes, it is not necessary to form the through-hole separately. In addition, when the through-hole is formed to be larger than the clip, the stay cloth easily passes through the through-hole. Note that, when the through-hole 316 is enlarged, a problem is to improve support rigidity of the clip 315 by the cushion pad 310. With regard to the problem, when the through-hole 316 and the insert wire 313 are set to the same height in a height direction of the cushion pad 310, the cushion pad 310 can be reinforced by the insert wire 313, and the support rigidity of the clip 315 can be improved.

### Modification Example of First Example

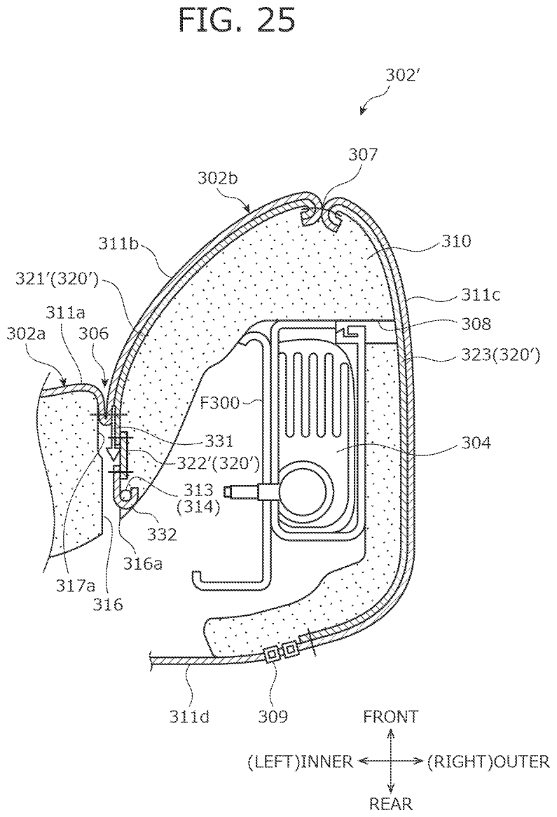

A seat back 302′ that is a modification example of the first example will be described with reference to FIG. 25. In the seat back 302 of the first example, the bank portion-side stay cloth 321 and the auxiliary stay cloth 322 are constituted by one sheet of stay cloth. However, in the modification example, a bank portion-side stay cloth 321′ and auxiliary stay cloth 322′ are constituted by separate members, and a rear end portion of the auxiliary stay cloth 322′ and an end portion of the bank portion-side stay cloth 321′ are attached by sewing at the sewn portion 306.

The trim J-hook 332 is attached to a tip end of the auxiliary stay cloth 322′ that is a separate member by sewing. In a similar manner as in the seat back 302 of the first example, the trim J-hook 332 is allowed to pass through the through-hole 316, and the trim J-hook 332 is hooked and fixed to the insert wire 313 of an engaged portion 314A provided at the periphery of the opening portion 316a.

When the bank portion-side stay cloth 321′ and the auxiliary stay cloth 322′ are set as separate members, the auxiliary stay cloth 322′ can be formed by post-installation. In addition, the auxiliary stay cloth 322′ may be formed by a material different from that of the bank portion-side stay cloth 321′, and according to this, the material and the strength of the auxiliary stay cloth 322′ may be set to be different from those of the bank portion-side stay cloth 321′.

Note that, the auxiliary stay cloth 322′ illustrated in FIG. 25 is connected to an end portion of the bank portion-side stay cloth 321′, but the auxiliary stay cloth 322′ may be connected to a part of the skin 311, for example, a sewn portion by sewing.

In the first example and the first modification example, the engaged portion 314 is formed at a location (the rear surface 310b of the cushion pad 310) where the clip 315 does not exist, that is, a location different from that of the clip 315, and the trim J-hook 332 sewn to the stay cloth 320′ is fixed to the insert wire 313 by engagement.

Since the bank portion-side stay cloth 321 or 321′ extending from the tear line and the auxiliary stay cloth 322 or 322′ are fixed by the clip 315 and the engaged portion 314, a load applied to the clip 315 at the time of airbag deployment is reduced, and according to this, for example, damage of the clip 315 and the like is suppressed.

### Second Example

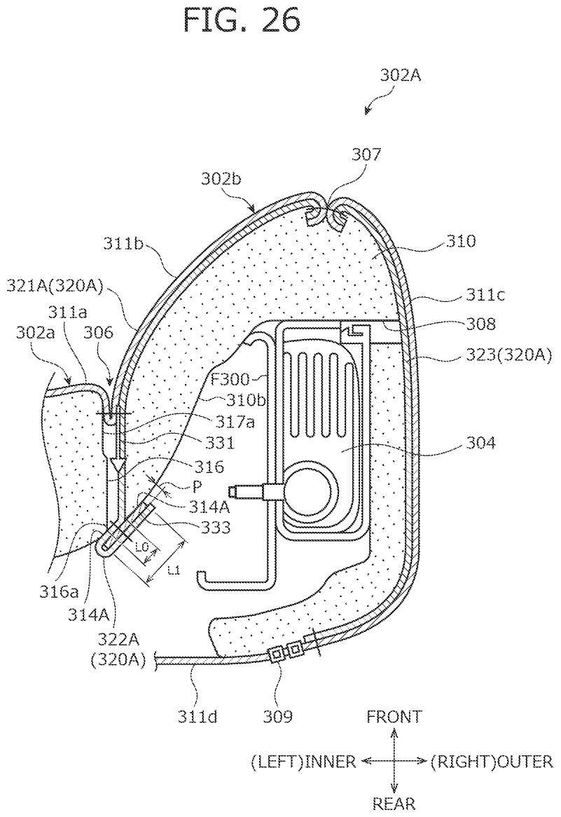

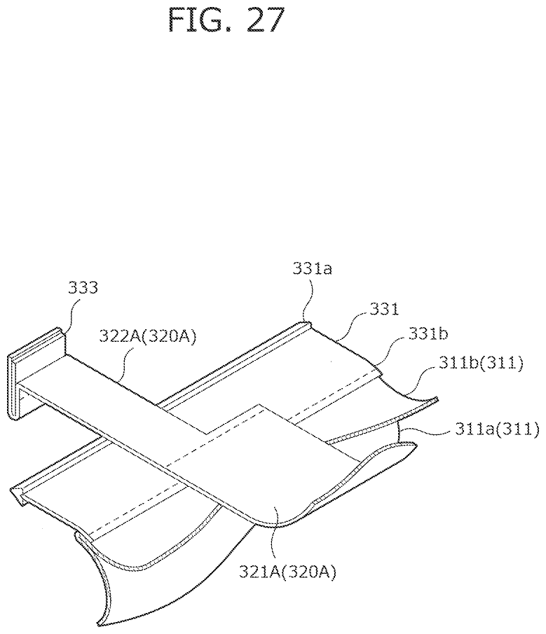

A vehicle seat SA300 that is a second example will be described with reference to FIG. 26 and FIG. 27. Even in the second example, an auxiliary stay cloth 322A extending from an end portion of a bank portion-side stay cloth 321A of the vehicle seat SA300 is provided, but the second example is different in that a trim plate 333 formed in a plate shape is used instead of the trim J-hook 332 that is a second engagement member. The vehicle seat SA300 has the same configuration as the vehicle seat S300 of the first example except for the configuration of the trim plate 333. Accordingly, detailed description thereof will be omitted, and description will be given of the configuration of the trim plate 333 that is a second engagement member.

The trim plate 333 is configured to be fixed to an engaged portion 314A in the vicinity of the opening portion 316a of the through-hole 316. Specifically, as illustrated in FIG. 26, the trim plate 333 is attached to have an approximately T-shape in combination with the auxiliary stay cloth 322A at an end portion of the auxiliary stay cloth 322A. The auxiliary stay cloth 322A covers a front surface of the trim plate 333 and is folded to a rear surface side and is attached to a central portion of the rear surface.

In addition, the trim plate 333 is fixed to the auxiliary stay cloth 322A by sewing. The trim plate 333 may be fixed to the auxiliary stay cloth 322A by adhesive, a double-faced tape, or the like. In addition, the trim plate 333 can rotate with a central portion thereof set as an axis.

As illustrated in FIG. 26, the thickness P of the trim plate 333 is smaller than the width L0 of the opening portion 316a of the through-hole 316, and the width L1 of the trim plate 333 is larger than the width L0 of the through-hole 316. Therefore, at the time of assembly, after the trim plate 333 is inserted into the through-hole 316 and is taken out from the rear surface side in a state in which the trim plate 333 is folded state, the trim plate 333 is rotated to be widened and the trim plate 333 is locked to the engaged portion 314A in the vicinity of the opening portion 316a so as not to come out. According to this, the stay cloth 320A can be fixed to the cushion pad 310.

The engaged portion 314 is provided at a location where the clip 315 is not present, that is, at a position (the rear surface 310b of the cushion pad 310) different from that of the clip 315, and the trim plate 333 is brought into contact with the engaged portion 314 to be fixed.

The trim plate 333 is a rectangular plate body made of a hard resin, and is made of a polypropylene (PP) resin as in the trim J-hook 332 in this embodiment. In addition, the trim plate 333 may be formed to have higher hardness or higher heat resistance as compared with the pull-in member 331. The hardness or the heat resistance can be changed even in the propylene resin by changing detailed blending of a resin material and by changing the hardness or the heat resistance.

Since the bank portion-side stay cloth 321A extending from the tear line (sewn portion 307) and the auxiliary stay cloth 322A are fixed by the clip 315 and the engaged portion 314A, at the time of airbag deployment, a load applied to the clip 315 is reduced, and thus, for example, damage of the clip 315 is suppressed.

In addition, in the vehicle seat S300 of the first example, the insert wire 313 is formed separately for fixing, but in a configuration of the vehicle seat SA300 of the second example, the stay cloth 320A can be fixed to the vicinity of the opening portion without providing the insert wire 313.

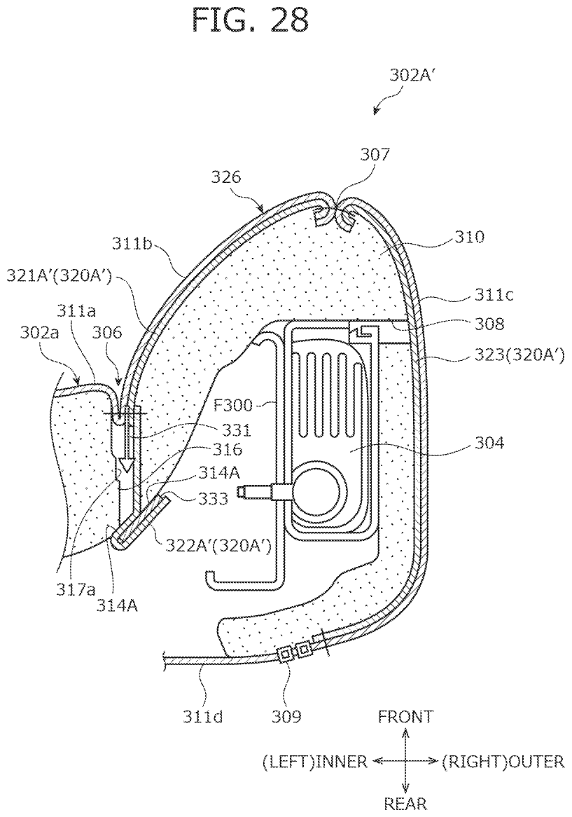

A vehicle seat SA300′ that is a modification example of the second example will be described with reference to FIG. 28. In the modification example of the second example, a bank portion-side stay cloth 321A′ and an auxiliary stay cloth 322A′ are constituted by separate members as in the modification example of the first example as illustrated in FIG. 25. The trim plate 333 is attached to the auxiliary stay cloth 322A′ that is a separate member by sewing, and rotation and folding are possible at the central portion of the trim plate 333.

Therefore, when attaching the bank portion-side stay cloth 321A′, after the trim plate 333 of the auxiliary stay cloth 322A′ is inserted into the through-hole 316 and is taken out from the opening portion 316a of the through-hole 316 in a state of being folded, the trim plate 333 is rotated to be widened and is hooked to the engaged portion 314A in the vicinity of the opening portion 316a so as not to come out. According to this, the stay cloth 320A′ and the skin 311 can be fixed.

The engaged portion 314A is provided at a location where the clip 315 is not present, that is, at a location (the rear surface 310b of the cushion pad 310) different from that of the clip 315, and the trim plate 333 engages with the engaged portion 314A. Since the bank portion-side stay cloth 321A′ extending from the tear line and the auxiliary stay cloth 322A′ are fixed by the clip 315 and the engaged portion 314A, at the time of airbag deployment, a load applied to the clip 315 is reduced and damage of the clip 315 is suppressed.

### <Manufacturing Method>

Here, a method of manufacturing the seat back 302 or 302A will be described. First, the seat frame F300 to which the airbag device 304 is attached is covered with the cushion pad 310 formed from urethane. Next, the surface of the cushion pad 310 is covered with the skin 311, and the pull-in member 331 attached to the sewn portion 306 of the skin 311 and the stay cloth 320 or 320A is fixed to the clip 315. At this time, the trim J-hook 332 attached to the auxiliary stay cloth 322 of the stay cloth 320 or the trim plate 333 of the auxiliary stay cloth 322A is inserted into the through-hole 316. Note that, at this time, the trim J-hook 332 or the trim plate 333 may be left as is without passing through the through-hole 316.

Next, the cushion pad 310 is turned upside down, the trim J-hook 332 or the trim plate 333 that is inserted into the through-hole 316 or is located on a front surface side of the cushion pad 310 is pulled to the rear surface of the cushion pad 310, and the trim J-hook 332 is hooked to the insert wire 313 (engaged portion 314) or the trim plate 333 is hooked to the engaged portion 314A to fix the skin 311 and the bank portion-side stay cloth 321 or 321A.

Next, the cushion pad 310 is covered with the lateral portion covering portion 311c of the skin 311 and the lateral-side stay cloth 323 up to the rear surface side of the cushion pad 310, and the lateral portion covering portion 311c and the rear surface covering portion 311d are connected by the line fastener 309. According to this, the seat back 302 or 302A is completed.

### Third Example

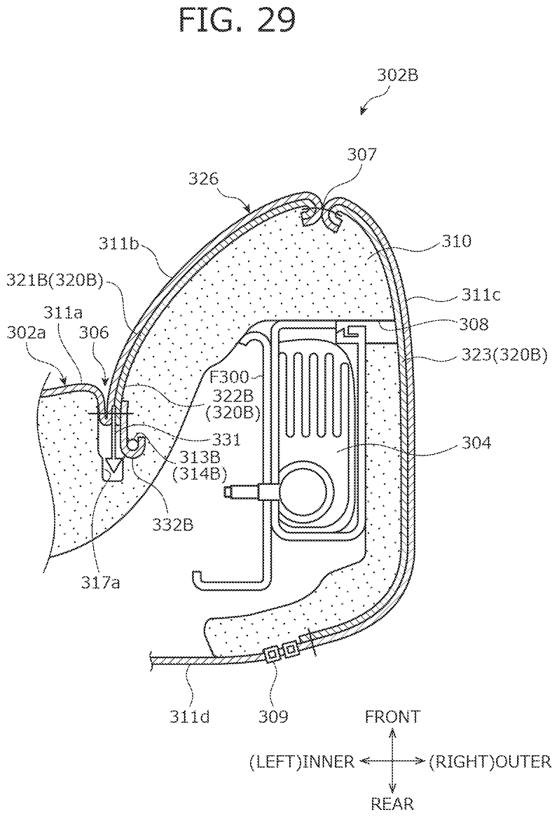

Next, a vehicle seat SB300 of a third example of this embodiment will be described. FIG. 29 is a cross-sectional view illustrating a configuration of a seat back 302B of the vehicle seat SB300 of the third example.

In the seat back 302 or 302A of the vehicle seat S300 or SA300 of the first or second example, the through-hole 316 is formed in the vertical pull-in groove 317a, and the trim J-hook 332 or the trim plate 333 passes through the through-hole 316, and is hooked to the engaged portion 314 or 314A.

This example is different from the examples in that the through-hole 316 is not formed in the vertical pull-in groove 317a and an engaged portion 314B is formed at a lateral portion of the vertical pull-in groove 317a as illustrated in FIG. 29. The other configurations are the same as each other, and thus detailed description thereof will be omitted.

In the stay cloth 320B of the third example, a trim J-hook 332B is provided at a tip end of an auxiliary stay cloth 322B (second stay cloth) in a similar manner as in the stay cloth 320 of the first example. The trim J-hook 332B is attached to the auxiliary stay cloth 322B by sewing. The trim J-hook 332B may be attached directly to a bank portion-side stay cloth 321B.

As described above, at a lateral portion of the vertical pull-in groove 317a, an insert wire 313B is embedded as the engaged portion 314B. The bank portion-side stay cloth 321B can be fixed by hooking the trim J-hook 332B attached to the tip end of the auxiliary stay cloth 322B to the insert wire 313B.

In addition, the trim J-hook 332B is made of a polypropylene resin, but it is preferable that the trim J-hook 332B is formed to have higher hardness or heat resistance as compared with the polypropylene pull-in member 331.

The engaged portion 314B is provided at a location (a lateral portion of the vertical pull-in groove 317a) different from that of the clip 315, and the trim J-hook 332B engages with the engaged portion 314B to be fixed. Therefore, at the time of airbag deployment, a load applied to the clip 315 is reduced, and damage of the clip 315 is suppressed.

In addition, in the seat backs 302 and 302A of the first and second example, the through-hole 316 is formed in the vertical pull-in groove 317a, but in the seat back 302B of the third example, even when the through-hole 316 is not formed, the stay cloth 320B can be fixed.

### Modification Example of Third Example

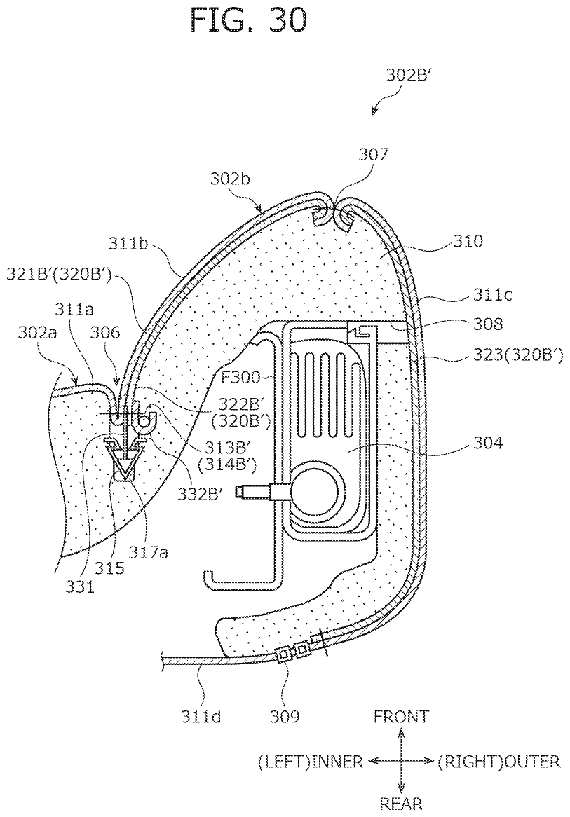

A modification example of the third example will be described. FIG. 30 is a cross-sectional view illustrating a configuration of a seat back 302B′ of a vehicle seat SB300′ that is a modification example of the third example.

The through-hole 316 as in the third example illustrated in FIG. 29 is not formed in the vertical pull-in groove 317a, and an insert wire 313B′ is embedded at a lateral portion of the vertical pull-in groove 317a to form an engaged portion 314B′.

In the seat back 302B of the third example, a trim J-hook 332B is attached to an auxiliary stay cloth 322B at a position where the clip 315 is not provided in the seat width direction, and is hooked to an insert wire 313B that is an engaged portion 314B. In the modification example of the third example, as illustrated in FIG. 30, an insert wire 313B′ is embedded in the cushion pad 310 at the same height where the clip 315 is provided in the seat width direction to form an engaged portion 314B′.

In addition, a trim J-hook 332B′ is attached to an auxiliary stay cloth 322B′ by sewing at the same height as that of the clip 315 in the seat up to down direction. Then, the trim J-hook 332 is hooked to the engaged portion 314B′ to be fixed.

Since a stay cloth 320B is fixed by hooking the trim J-hook 332B′ to the engaged portion 314B′ at the same height as that of the clip 315 to which the pull-in member 331 is attached, holding of the clip 315 can be assisted when the airbag 334a is deployed. In other words, when the airbag 304a is deployed, since the trim J-hook 332B′ is locked to the engaged portion 314B′, a load applied to the clip 315 is reduced, and damage of the clip 315 or the like, for example, coming-out of the clip 315 from the cushion pad 310, or detachment of the clip 315 from the pull-in member 331 can be suppressed.

In addition, as in the seat back 302B of the third example, since the engaged portion 314B′ that engages with the trim J-hook is provided at a lateral portion of the vertical pull-in groove 317a, as in the seat backs 302 and 302A of the first and second examples, even when the through-hole 316 is not formed, the stay cloth 320B can be fixed.

### <Manufacturing Method>

Here, a method of manufacturing the seat back 302B or 302B′ will be described. First, the seat frame F300 to which the airbag device 304 is attached is covered with the cushion pad 310 formed from urethane. Next, the surface of the cushion pad 310 is covered with the skin 311, and the pull-in member 331 attached to the sewn portion 306 of the skin 311 and the stay cloth 320B is fixed to the clip 315. At this time, the trim J-hook 332B or 332B′ attached to the auxiliary stay cloth 322B of the stay cloth 320 is hooked to the insert wire 313B of the engaged portion 314B or 314B′ provided at a lateral side of the vertical pull-in groove 317a to fix the bank portion-side stay cloth 321B or 321B′.

Next, the cushion pad 310 is turned upside down, a lateral portion of the cushion pad 310 is covered with the lateral portion covering portion 311c of the skin 311 and the lateral-side stay cloth 323 coupled thereto, and at the rear surface of the cushion pad 310, the lateral-side stay cloth 323 and the rear surface covering portion 311d are coupled by the line fastener 309. According to this, the seat back 302B or 302B′ is completed.

### Fourth Example

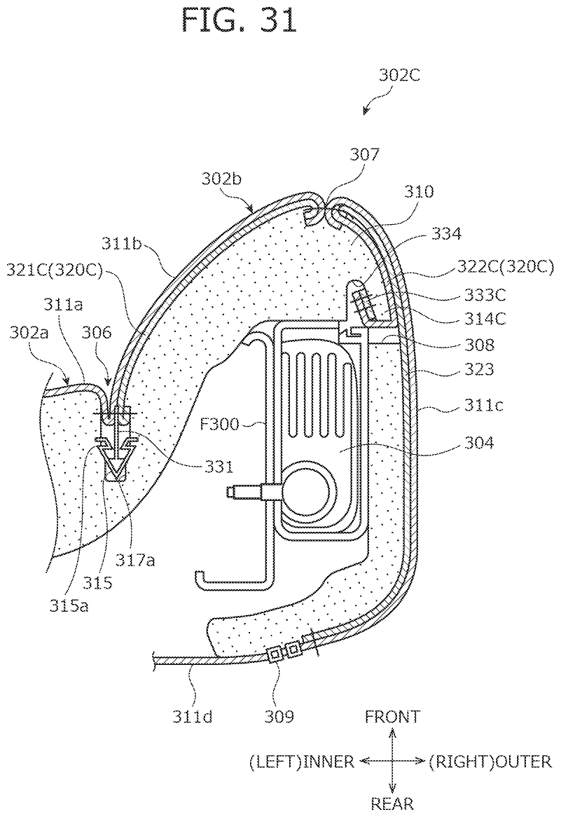

A vehicle seat SC300 that is a fourth example will be described with reference to FIG. 31. In the vehicle seats S300 to SB300 of the first to third examples, the trim J-hook 332 or the trim plate 333 engages with the engaged portion 314 to 314B provided in the vertical pull-in groove 317a or in the through-hole 316 formed in the vertical pull-in groove 317a.

In the fourth example, an engaged portion 314C is formed in the slit 308 formed in a lateral portion of a seat back 302C instead of the pull-in groove 317. In addition, an auxiliary stay cloth 322C (second stay cloth) extending from the sewn portion 307 along a lateral portion of the cushion pad 310 is formed, and a trim plate 333C is attached to a tip end of the auxiliary stay cloth 322C.

The trim plate 333C is a plate-shaped member made of a hard resin, and the trim plate 333C is attached to the tip end of the auxiliary stay cloth 322C by sewing.

As illustrated in FIG. 31, a concave portion 334 that becomes the engaged portion 314C is formed in a front lateral portion of the slit 308. The trim plate 333C is inserted from an opening portion of the slit 308, and the trim plate 333C is inserted into the concave portion 334 to fix an end portion of the auxiliary stay cloth 322C with engagement.

As illustrated in FIG. 31, the concave portion 334 that is the engaged portion 314C may be formed at a position located at approximately the same height as that of the clip 315 in the seat height direction. In addition, the concave portion 334 may be formed at a position located at a height different from that of the clip 315.

In addition, the trim plate 333C is made of a polypropylene resin, but it is preferable that the trim plate 333C is formed to have higher hardness or heat resistance as compared pull-in member 331 made of the polypropylene resin.

Since the stay cloth 320C is fixed by using the trim plate 333C at a position (lateral portion of the seat back 302C) different from that of the clip 315, at the time of airbag deployment, a load applied to the clip 315 can be reduced, and damage of the clip 315 can be prevented or detachment of the pull-in member 331 from the clip 315 can be suppressed.

In addition, since the trim plate 333C is made so as to have higher hardness or heat resistance as compared with the pull-in member 331, when the airbag 304a is deployed, elongation of the skin 311 can be firmly restricted.

Note that, the bank portion-side stay cloth 321C (first stay cloth) and the auxiliary stay cloth 322C may be constituted by one sheet of stay cloth. In addition, the lateral-side stay cloth 323 and the auxiliary stay cloth 322C may be constituted by one sheet of stay cloth. According to this, an increase in the number of components can be suppressed.

### Fifth Example

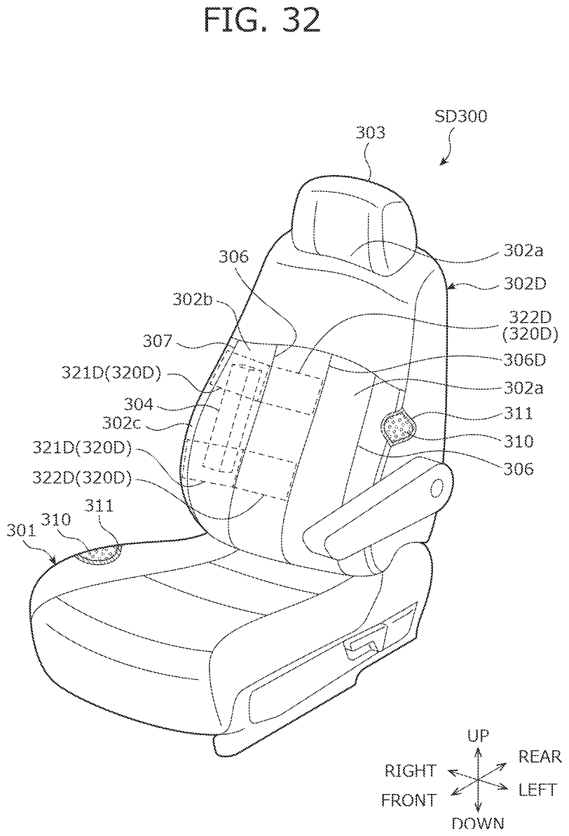

A vehicle seat SD300 that is a fifth example of this embodiment will be described with reference to FIG. 32 to FIG. 34. In the vehicle seats S300 to SC300 of the first to fourth examples, the trim J-hook 332 or the trim plate 333 engages with the engaged portion 314 formed in the bank portion 302b of the seat back 302. However, in a seat back 302D of the vehicle seat SD300 of the fifth example, an engaged portion 314D formed in the seat surface portion 302a is used. Hereinafter, description will be given of the engaged portion 314D formed in the seat surface portion 302a. A configuration other than a configuration of the seat surface portion 302a and a configuration of the engaged portion 314D is the same as the configuration of the seat back 302 of the first example, and thus detailed description thereof will be omitted.

As illustrated in FIG. 32, in the seat back 302D of the vehicle seat SD300, two vertical pull-in grooves 317a extending in a height direction (up to down direction) of a cushion pad 310D, and a vertical pull-in groove 317c that is disposed at the center of the seat back 302 between the vertical pull-in grooves 317a are formed. In addition, a transverse pull-in groove 317b extending in a transverse direction (seat width direction) is formed.

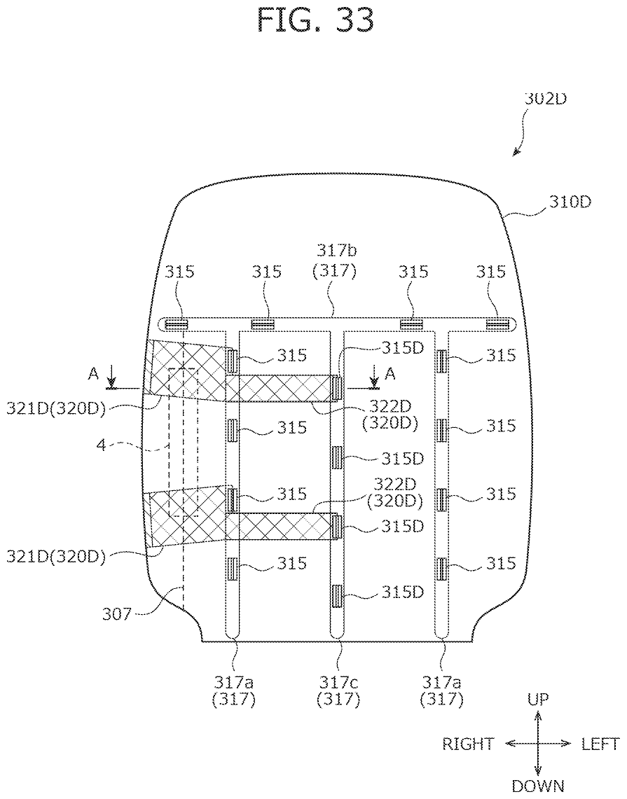

As illustrated in FIG. 33, in the vertical pull-in grooves 317a and the transverse pull-in groove 317b, a plurality of clips 315 are disposed to pull in the skin 311. In addition, the clip 315D is also disposed in the vertical pull-in groove 317c disposed at the center. However, the clip 315D in the vertical pull-in groove 317c is disposed at a different height as compared with a position of the clip 315 disposed in the right and left vertical pull-in grooves 317a.

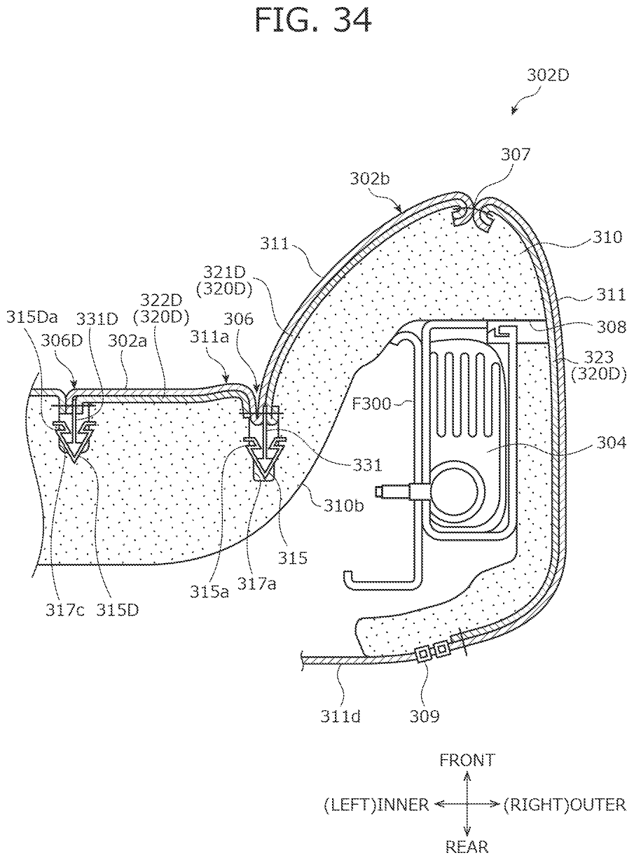

As illustrated in FIG. 34, a pull-in member 331D is attached to the skin 311 by sewing in order to pull in the skin 311 between the seat surface portion 302a and the bank portion 302b of the seat back 302D, and the pull-in member 331D is held by the clip 315D fixed to the bottom portion of the vertical pull-in groove 317c. A bank portion-side stay cloth 321D extends from a pull-in line to a tear line along the surface of the bank portion 302b, and both end portions are fixed by sewing.

In addition, an auxiliary stay cloth 322D (second stay cloth) extends from the bank portion-side stay cloth 321D, and is disposed along the surface of the seat surface portion 302a from the sewn portion 306 between the seat surface portion 302a and the bank portion 302b up to a sewn portion 306D that is a pull-in line at the center of the seat surface portion 302a. An outer end portion of the auxiliary stay cloth 322D is fixed to a part of the skin 311, the pull-in member 331, and the bank portion-side stay cloth 321D by sewing at the sewn portion 306. An inner end portion of the auxiliary stay cloth 322D is fixed to a part of the skin 311 and the pull-in member 331D by sewing at the sewn portion 306D.

The clip 315D is attached to the bottom portion of the vertical pull-in groove 317c provided at the center of the seat surface portion 302a as described above, and the tip end of the pull-in member 331D can be held by a holding portion 315 Da of the clip 315D. The clip 315D functions as an engaged portion 314D, and the pull-in member 331D functions as a second engagement member.

When the tip end portion 331a of the pull-in member 331D is inserted into the holding portion 315 Da of the clip 315D, the stay cloth 320D is fixed to the cushion pad 310.

As illustrated in FIG. 33, in the seat back 302D of the fifth example, the clip 315D as the engaged portion 314D is provided at a position (at the center of the seat surface portion 302a) different from that of the clip 315 (attachment member) in the seat width direction. In addition, the pull-in member 331D (second engagement member) that engages with the clip 315D is provided, and the auxiliary stay cloth 322D (second stay cloth) extending from the bank portion-side stay cloth 321D is fixed by the pull-in member 331D. According to this, at the time of airbag deployment, a load applied to the clip 315 is reduced, and damage of the clip 315 is suppressed.

Note that, the material of the clips 315 and 315D is polyacetal (POM) resin, but the hardness or heat resistance may be changed by changing detailed blending of the polyacetal resin. For example, the clip 315D may be set to have higher hardness or heat resistance as compared with the clip 315.

In addition, the material of the pull-in member 331 and 331D is a polypropylene (PP) resin, but the hardness or heat resistance may be changed by changing detailed blending of the polypropylene resin. For example, the pull-in member 331D disposed at the center of the seat surface portion 302a may be set to have higher hardness or heat resistance as compared with the pull-in member 331 disposed between the seat surface portion 302a and the bank portion 302b. In addition, the pull-in member 331D may be made of a metal such as aluminum and iron.

In addition, in the fifth example, the bank portion-side stay cloth 321 and the auxiliary stay cloth 322D are constituted by different members and are connected by sewing, but the bank portion-side stay cloth 321 and the auxiliary stay cloth 322D may be constituted by one sheet of stay cloth. When the clothes are constituted by one sheet of stay cloth, the number of components can be reduced.

In addition, the pull-in member 331 and the bank portion-side stay cloth 321D are directly connected by sewing at the sewn portion 306 of the pull-in line, but may be indirectly connected through another member such as non-woven fabric.

In addition, the pull-in member 331D and the auxiliary stay cloth 322D are directly connected by sewing at the sewn portion 306D of the pull-in line at the center, but may be indirectly connected through another member such as a non-woven fabric and a suspender cord.

In addition, in the fifth example, the auxiliary stay cloth 322D is fixed to the seat surface portion 302a by using the pull-in member 331D connected to the auxiliary stay cloth 322D, but as in the first example or the second example, a trim J-hook or a trim plate may be attached to the auxiliary stay cloth 322D, and an engaged portion 314 corresponding to the trim J-hook or the trim plate may be formed in the seat surface portion 302a to fix the stay cloth 320D.

In addition, the clip 315 disposed in the vertical pull-in groove 317a and the clip 315D disposed in the vertical pull-in groove 317c disposed at the center may be disposed at the same height in the up to down direction.

### <Manufacturing Method>

A method of manufacturing the seat back 302D of the vehicle seat SD300 illustrated in the fifth example will be described. The seat frame F300 to which the airbag device 304 is attached is covered with the cushion pad 310 formed from urethane.

Next, the surface of the cushion pad 310 is covered with the skin 311, and the pull-in member 331 attached to the sewn portion 306 of the skin 311 and the stay cloth 320 is fixed to the clip 315.

At this time, the pull-in member 331D that is provided on a side opposite to the pull-in member 331 and is attached to the auxiliary stay cloth 322 is attached to the clip 315D in the pull-in groove located at the center.

Next, the cushion pad 310 is turned upside down, the cushion pad is covered with the lateral portion covering portion 311c of the skin 311 and the lateral-side stay cloth 323 up to the rear surface side of the cushion pad 310, and the lateral portion covering portion 311c and the rear surface covering portion 311d are coupled by the line fastener 309.

### Fourth Embodiment

Hereinafter, a fourth embodiment of the present invention will be described. The fourth embodiment of the present invention relates to a conveyance seat, and more particularly, to a conveyance seat including an airbag device.

In recent, a side airbag is provided in a vehicle seat to protect an occupant against impact from a lateral side. The side airbag protects the occupant by cushioning and distributing impact loads.

A side airbag provided in a seat back efficiently transfers inflation energy of the airbag to a sewn portion (a tear line, a fracture portion) that is a seam of a skin (seat cover) to fracture the sewn portion in a short time. In order to deploy the airbag without delay, the skin and the stay cloth are sewn together at the sewn portion, and a base end portion opposite to the sewn portion is fixed to a back frame.

However, since a bracket or the like is used to fix the stay cloth to the back frame, there is a problem that a structure of the seat back becomes complicated. Therefore, for example, in a conveyance seat relating to JP 2017-094982 A, the side airbag is wrapped and fixed with the stay cloth. Therefore, it is required to more easily fix the stay cloth and to improve workability.

In order to easily fix the stay cloth, for example, in a vehicle seat related to JP 2015-003578 A, a pull-in member is provided at a base end portion of the stay cloth, and the stay cloth is fixed by using a clip (attachment member) provided in a pull-in groove of a cushion pad.

### Technical Problem

As disclosed in JP 2017-094982 A, in a case where the pull-in groove is present at a position where the airbag is attached, fixing can be performed by using the clip or the like. However, the pull-in groove may not be provided at the position where the airbag is attached depending on the design of the seat, and the stay cloth may not be fixed by using the clip. Therefore, there is a demand for means for simply fixing the stay cloth without using the clip.

The present invention has been made in consideration of the above-described problem, and an object thereof is to provide a conveyance seat capable of simply attaching the stay cloth.

The problem is solved by the following conveyance seat including an airbag and an inflator according to the present invention. Specifically, the conveyance seat includes: a frame; a pad disposed on the frame; a skin which covers the pad and in which a fracture portion to be fractured when the airbag is deployed is formed at a part; and a stay cloth which extends from the fracture portion along a surface of the pad, and of which the amount of tensile elongation is smaller as compared the skin. The stay cloth is attached to the surface of the pad with adhesive.

Since the stay cloth can be simply fixed by attaching the stay cloth to the pad with adhesive, workability can be further improved as compared with a case of attaching the stay cloth to the frame.

In addition, since the stay cloth can be attached even in a case where a pull-in groove into which the stay cloth is pulled does not exist, it is possible to cope with the design of various conveyance seats.

In addition, according to the above-described conveyance seat, an adhesion region where the stay cloth and the surface of the pad are bonded with the adhesive may be provided in a region other than a portion where the fracture portion is provided.

When the adhesion region is provided in a region other than a portion where the fracture portion (fixing point) is formed, for example, at a position separated from the fracture portion, supportability by the stay cloth is improved.

In addition, according to the conveyance seat, an end portion opposite to an end portion that is connected to the fracture portion, and the surface of the pad may be bonded by the adhesive, and a non-adhesion region where the stay cloth and the surface of the pad are not bonded with the adhesive may be provided between the adhesion region where bonding with the adhesive is performed and the fracture portion.

When the non-adhesion region is provided between the adhesion region and the fracture portion, for example, the amount of the adhesive used can be reduced.

In addition, according to the conveyance seat, the stay cloth may be attached to a surface on a rear surface side of the pad with the adhesive.

When the stay cloth is disposed on the rear surface side of the pad and is bonded, since the stay cloth is not disposed on a front surface side of the conveyance seat, concave and convex impression can be suppressed from occurring on the front surface side.

In addition, according to the above-described conveyance seat, the stay cloth may be sandwiched between the airbag and the pad.

When the stay cloth is disposed between the airbag and the pad, the stay cloth can be more firmly fixed.

In addition, according to the above-described conveyance seat, the frame may include an arc-shaped portion of which a cross-section is formed in an arc shape on a front surface side of the conveyance seat, and the stay cloth may be in contact with the arc-shaped portion of the frame and may be disposed along the surface of the pad.

When the stay cloth is in contact with the arc-shaped portion of the frame and is disposed along the surface of the pad, for example, contact with an edge portion of the frame can be avoided, and thus damage of the stay cloth can be suppressed.

### Advantageous Effects of Invention

According to the present invention, since the stay cloth can be simply fixed by attaching the stay cloth to the pad with adhesive, workability can be further improved as compared with a case of attaching the stay cloth to the frame. In addition, since the stay cloth can be attached to a location where the pull-in groove into which the stay cloth is pulled is not present, it is possible to cope with the design of various conveyance seats.

In addition, since the adhesion region is provided in a region other than a portion where the fracture portion (fixing point) is formed, for example, at a position separated from the fracture portion, supportability by the stay cloth is improved.

In addition, since the non-adhesion region is provided between the adhesion region and the fracture portion, for example, the amount of the adhesive used can be reduced.

In addition, when the stay cloth is disposed on the rear surface side of the pad and is bonded, since the stay cloth is not disposed on a front surface side of the conveyance seat, concave and convex impression can be suppressed from occurring on the front surface side.

In addition, when the stay cloth is disposed between the airbag and the pad, the stay cloth can be more firmly fixed.

In addition, when the stay cloth is in contact with the arc-shaped portion of the frame and is disposed along the surface of the pad, for example, contact with an edge portion of the frame can be avoided, and thus damage of the stay cloth can be suppressed.

### DESCRIPTION OF EMBODIMENTS

Hereinafter, a configuration of a conveyance seat according to a fourth embodiment will be described with reference to the accompanying drawings. However, the following embodiment is merely one example for facilitating understanding of the present invention, and is not intended to limit the present invention. That is, the present invention can be modified and improved without departing from the gist of the present invention, and equivalents thereof are also included in the present invention.

Note that, hereinafter, as an example of the conveyance seat, a vehicle seat is exemplified, and a configuration thereof will be described. However, the present invention is not limited to vehicle seats mounted on ground traveling conveyances including wheels such as automobiles and trains, and may be applied to seats mounted on aircrafts, ships, and the like which move other than on the ground.

In addition, in the following description, “front to rear direction” is a front to rear direction of a vehicle seat, and is a direction that coincides with an advancing direction when a vehicle is traveling. In addition, “seat width direction” is a width direction of the vehicle seat and is a direction that coincides with a right to left direction when viewed from an occupant who is seated on the vehicle seat. In addition, “up to down direction” is an up to down direction of the vehicle seat, and is a direction that coincides with a vertical direction when the vehicle is traveling on a horizontal plane.

In addition, in the following description, in a case where description is made by attaching “seat” to various directions such as “seat width direction” and “seat height direction”, it is assumed that the description represents a direction with respect to the vehicle seat. In a case where description is made by attaching “vehicle” such as “vehicle inner side” and “vehicle outer side”, it is assumed that the description represents a direction with respect to the vehicle.

In addition, with respect to shapes, positions, postures, and the like of respective portions of the vehicle seat to be described below, description will be made on the assumption of a case in which an occupant can be seated on the vehicle unless otherwise stated.

### <Basic Configuration of Vehicle Seat>

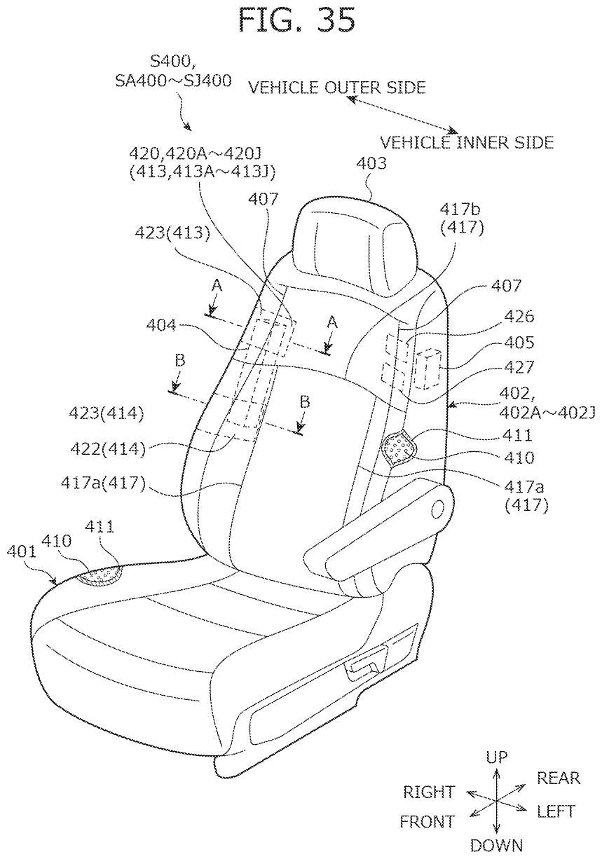

A basic configuration of a vehicle seat (hereinafter, a vehicle seat S400) that is a first example of the fourth embodiment will be described with reference to FIG. 35. FIG. 35 is a perspective view when the vehicle seat S400 is viewed from a front diagonal side. In FIG. 35, a part of the vehicle seat S400 is illustrated in the drawing with a configuration in which a skin 411 (also referred to as a trim cover) is removed for convenience of illustration.

The vehicle seat S400 is a seat which is placed on a vehicle body floor and on which an occupant of the vehicle is seated. In this embodiment, the vehicle seat S400 is used as a front seat corresponding to a vehicle front seat. However, there is no limitation thereto, and the vehicle seat S400 may be a rear seat of the vehicle, or can be used as a middle seat in a second row or a rear seat in a third row in a vehicle including three rows of seats in a front to rear direction.

As illustrated in FIG. 35, the vehicle seat S400 includes a seat cushion 401 that becomes a seating portion configured to support buttocks of a seated occupant, a seat back 402 that becomes a backrest configured to support the back of the seated occupant, and a headrest 403 that is disposed at an upper portion of the seat back 402 and supports the head of the seated occupant as main constituent elements.

In the seat cushion 401, a rear end portion thereof is connected to a lower end portion of the seat back 402. In addition, the seat cushion 401 has a configuration in which a cushion pad 410 is placed on a cushion frame and is covered with a skin 411. The seat back 402 has a configuration in which a cushion pad 410 is placed on a back frame, and the cushion pad 410 is covered with a skin 411.

In addition, the seat cushion 401 and the seat back 402 are connected to each other with a reclining mechanism (not illustrated) interposed therebetween. A slide rail (not illustrated) is installed at a lower portion of the seat cushion 401, and the vehicle seat S400 is placed on a vehicle body floor in a state capable of sliding in the front to rear direction due to the slide rail.

A seat frame F400 (frame) is provided inside the vehicle seat S400, and the seat frame F400 mainly includes a cushion frame that is a skeleton of the seat cushion 401 and a back frame that is a skeleton of the seat back 402.

In the cushion pad 410, a cushion portion is formed by a foam, and the cushion portion is covered with the skin 411. As the foamed body, a polypropylene bead foam, a polyethylene bead foam, a polypropylene foam, a polyethylene foam, an acrylonitrile/styrene foam, an ethylene vinyl acetate copolymer resin, a urethane foam material, or the like, or a combination thereof is used. In this embodiment, the cushion pad 410 is a urethane pad formed by foam molding by using a urethane foaming agent.

In addition, the skin 411 is constituted by fabric, a film, cloth, leather, a sheet, or the like, and is attached to cover the cushion pad 410 in a state of stretched so that a predetermined tension is applied.

### <Airbag Device 404>

As indicated by a dotted line in FIG. 35, an airbag device 404 is provided at a right lateral portion of the seat back 402. The airbag device 404 is a near-side airbag device that is disposed on a side closer to a vehicle door.

Note that, in the vehicle seat S400, an airbag device 405 is also provided at a left lateral portion of the seat back 402. The airbag device 405 is a far-side airbag device that is disposed on a side far from the door.

The airbag devices 404 and 405 have a known configuration, and are attached to the seat frame F400 at the inside of the bank portion 402b of the seat back 402, and a position thereof is fixed. The airbag devices 404 and 405 are configured to be accommodated in a space formed by the cushion pad 410. The airbag devices 404 and 405 have approximately the same configuration, and thus hereinafter, description will be mainly given of the airbag device 404.

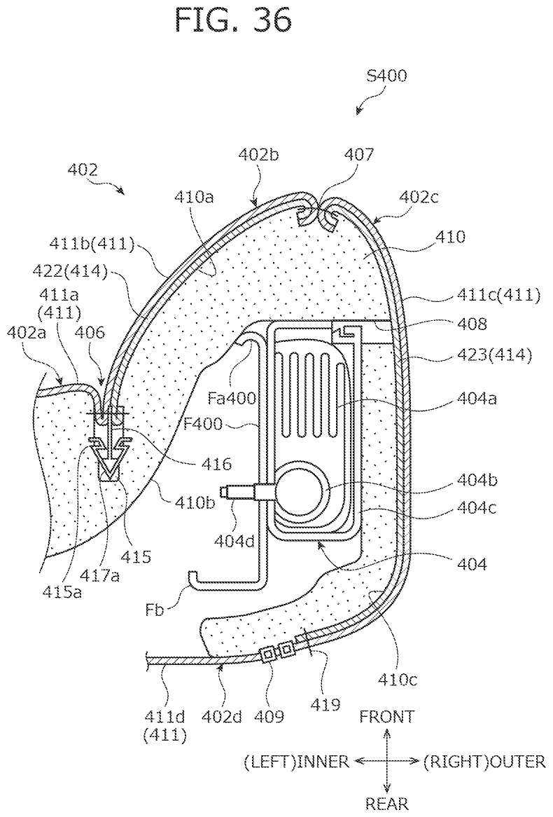

The airbag device 404 will be described below in more detail. For example, as illustrated in FIG. 36, the airbag device 404 includes an airbag 404a, an inflator 404b that supplies a gas to the airbag 404a, a case 404c that covers the airbag 404a and the inflator 404b, and a bolt 404d that fastens the inflator 404b to the case 404c with a nut.

The airbag device 404 is fixed to a right side of the seat frame F400 (an outer side of the vehicle seat S400), and a slit 408 is formed in the cushion pad 410 on a right side of the airbag device 404. When the airbag 404a bulges from the airbag device 404, the cushion pad 410 is fractured at the slit 408, and the skin 411 is incised at a fracture portion 407 (called a tear line) that is also a sewn portion, and the airbag 404a is deployed outward.

As indicated by a dotted line in FIG. 35, at the periphery of the airbag device 404, a guide member (stay cloth) that guides airbag deployment is provided inside the seat back 402. The guide member is provided at two sites on an upper side and on a lower side at the periphery of the airbag device 404. Hereinafter, the guide member provided on the upper side is referred to as an upper side guide member 413 and the guide member provided on the lower side is referred to as a lower side guide member 414.

When the airbag 404a is inflated by the airbag device 404, inflation energy of the airbag 404a is transferred to the upper side guide member 413 and the lower side guide member 414 which are stay cloths through the cushion pad 410. When the upper side guide member 413 and the lower side guide member 414 receive the inflation energy of the airbag 404a, the inflation energy of the airbag 404a is focused to a sewing yarn of the fracture portion 407 (tear line), and the sewing yarn is cut. According to this, the upper side guide member 413 and the lower side guide member 414 are detached from the fracture portion 407, the cushion pad 410 is fractured at the slit 408, and the airbag 404a is deployed outward.

### <Stay Cloth Fixing Structure>

Hereinafter, a structure of fixing the lower side guide member 414 will be described with reference to FIG. 36, and then a structure of fixing the upper side guide member 413 that is a main configuration of the present invention will be described.

FIG. 36 is a cross-sectional view of the seat back 402 along line B-B in FIG. 35, and illustrates the structure of fixing the lower side guide member 414 by using a clip 415.

As illustrated in FIG. 36, the skin 411 that covers the seat back 402 includes a seat surface covering portion 411a, a bank portion covering portion 411b, a lateral portion covering portion 411c, and a rear surface covering portion 411d. The seat surface covering portion 411a and the bank portion covering portion 411b are connected by sewing at a sewn portion 406 that is pulled into a vertical pull-in groove 417a formed between a seat surface portion 402a and a bank portion 402b. Note that, the sewn portion 406 forms a pull-in line.

The bank portion covering portion 411b and the lateral portion covering portion 411c are connected by sewing at the fracture portion 407 in a front end of the bank portion 402b. The fracture portion 407 forms a tear line that is fracture when the airbag 404a is deployed.

The lateral portion covering portion 411c and the rear surface covering portion 411d are connected by a line fastener 409 at the rear surface portion 402d. The rear surface covering portion 411d of the seat back 402 connects the lateral portion covering portion 411c on a right side of the seat back 402 and a lateral portion covering portion (not illustrated) on a left side thereof.

### <Lower Side Guide Member 414>

As illustrated in FIG. 35 and FIG. 36, the lower side guide member 414 is provided at a portion corresponding to the airbag device 404, in other words, a position overlapping the airbag device 404 when the seat back 402 is viewed from a forward side.

The lower side guide member 414 includes an inner side stay cloth 422 and an outer side stay cloth 423, and the inner side stay cloth 422 and the outer side stay cloth 423 are sewn with the skin 411 at the fracture portion 407. Specifically, the inner side stay cloth 422 is provided along a bank portion surface 410a of the cushion pad 410 from the fracture portion 407 that is a tear line to the sewn portion 406 of the pull-in line. The outer side stay cloth 423 is disposed along a lateral portion surface 410c of the cushion pad 410 from the fracture portion 407 to the rear surface portion 402d at the side portion 402c of the seat back 402. A rear surface-side end portion of the outer side stay cloth 423, that is, an end portion opposite to an end that is connected to the fracture portion 407 is attached by sewing at a rear surface side sewn portion 419, and the outer side stay cloth 423 is in a state of backing the lateral portion covering portion 411c in the skin 411.

The inner side stay cloth 422 and the outer side stay cloth 423 is formed from a material of which the amount of tensile elongation is smaller as compared with the skin 411. In other words, the inner side stay cloth 422 and the outer side stay cloth 423 is formed from a sheet-shaped member having less stretchability as compared with the skin 411. Therefore, the inner side stay cloth 422 and the outer side stay cloth 423 can transfer a force applied at the time of airbag deployment to the fracture portion 407, and can promote deployment of the airbag 404a.

### <Pull-In Groove 417>

A pull-in groove 417 is formed in the cushion pad 410 (refer to FIG. 35). The pull-in groove 417 includes two vertical pull-in grooves 417a extending in a seat vertical direction, and a transverse pull-in groove 417b extending in a seat width direction. In the two vertical pull-in grooves 417a, upper ends thereof are connected by the transverse pull-in groove 417b, and the entirety of the pull-in groove 417 is formed to have an inverted U-shape when viewed from the seat forward side.

### <Clip 415>

A plurality of clips 415 (also referred to as fogless clip) are provided inside the vertical pull-in grooves 417a and the transverse pull-in groove 417b with a predetermined interval. As illustrated in FIG. 36, the clips 415 are fixed in a state of being partially embedded in a bottom portion of the vertical pull-in grooves 417a, and are provided integrally with the cushion pad 410. In the clips 415, a cross-section thereof is formed in an approximately V-shape, and a top portion of the clip 415 is provided with a holding portion 415a that holds an arrowhead-shaped tip end portion of a pull-in member 416. Note that, the clips 415 may be formed to have a U-shaped cross-section or a C-shaped cross-section.

The clips 415 are made of a resin, and is made of, for example, a polyacetal (POM) resin, a polypropylene (PP) resin, a polyamide (PA) resin, a polycarbonate (PC) resin, or the like. The clips 415 may be formed by the polyacetal (POM) resin having relatively high strength.

As illustrated in FIG. 36, at the sewn portion 406 of the seat surface covering portion 411a and the bank portion covering portion 411b, the pull-in member 416 is attached to the skin 411 and the inner side stay cloth 422 by sewing.

In addition, the pull-in member 416 can be fixed to the clips 415 by inserting the tip end portion of the pull-in member 416 into the holding portion 415a of each of the clips 415. When the pull-in member 416 is fixed to the clip 415, the inner side stay cloth 422 is fixed to the cushion pad 410.

Note that, the pull-in member 416 is made of a resin, and is formed by, for example, a polypropylene (PP) resin.

### <Upper Side Guide Member 413>

Hereinafter, the upper side guide member 413 disposed on an upper side of the periphery of the airbag device 404 will be described. The inner side stay cloth 422 of the lower side guide member 414 illustrated in FIG. 36 is fixed to the vertical pull-in grooves 417a of the cushion pad 410 by using the clip 415.

However, the pull-in groove 417 may not extend up to the upper side of the airbag device 404 depending on a seat design.

In the vehicle seat S400 of this embodiment, as illustrated in FIG. 35, the pull-in groove 417 extends up to the vicinity of the center of the airbag device 404, but the pull-in groove 417 is not formed on the upward side of the airbag device 404. Therefore, the upper side guide member 413 cannot be fixed to the cushion pad 410 by using the clip 415, and separate means is necessary for attachment.

### First Example

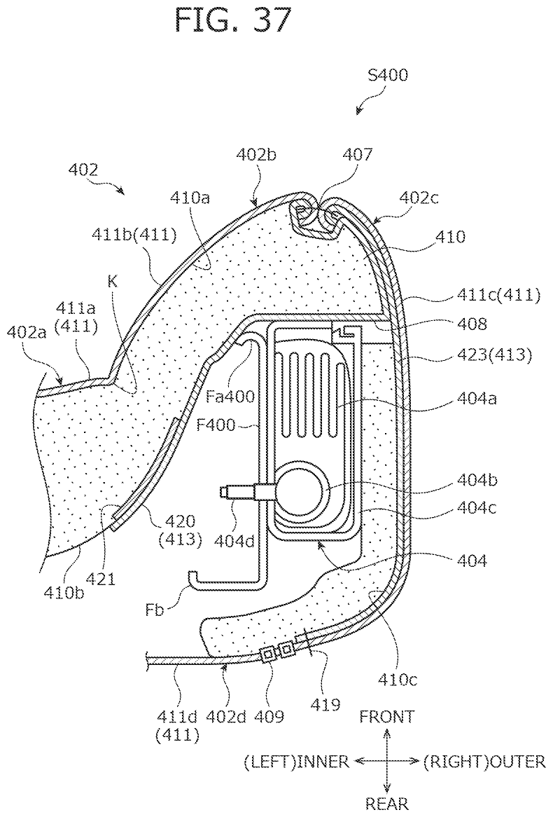

A vehicle seat S400 that is a first example of this embodiment will be described with reference to FIG. 37 to FIG. 39. FIG. 37 is a cross-sectional view of the seat back 402 along line A-A in FIG. 35, and illustrates an attachment structure of attaching the upper side guide member 413 to the cushion pad 410.

As illustrated in FIG. 37, the seat surface covering portion 411a and the bank portion covering portion 411b of the skin 411 are formed continuously from a boundary portion K between the seat surface portion 402a and the bank portion 402b.

The upper side guide member 413 includes an inner side stay cloth 420 and an outer side stay cloth 423. As in the outer side stay cloth 423 of the lower side guide member 414, the outer side stay cloth 423 is disposed along the lateral portion surface 410c of the cushion pad 410 from the fracture portion 407 to the rear surface portion 402d at the side portion 402c of the seat back 402.

In addition, a rear surface-side end portion of the outer side stay cloth 423, that is, an end portion opposite to an end that is connected to the fracture portion 407 is attached by sewing at the rear surface side sewn portion 419, and the outer side stay cloth 423 is in a state of backing the lateral portion covering portion 411c in the skin 411.

On the other hand, the inner side stay cloth 420 extends along the lateral portion surface 410c (front surface) of the cushion pad 410 from the fracture portion 407 differently from the inner side stay cloth 422 of the lower side guide member 414, and enters into the cushion pad 410 from the slit 408. The inner side stay cloth 420 entered from the slit 408 passes through the front surface of the case 404c of the airbag device 404, passes beyond an arc-shaped portion Fa400 of the seat frame F400, and is disposed along the rear side surface 410b of the cushion pad 410. In addition, the inner side stay cloth 420 is attached to the rear side surface 410b of the cushion pad 410 with adhesive at a portion inclined with respect to the front to rear direction. The adhesive is provided in the adhesion region 421 having a predetermined area at an end portion of the inner side stay cloth 420. In addition, the adhesion region 421 is provided on an inner side in the seat width direction as compared with an inner end portion of a flange Fb400 on a rear end side of the seat frame F400. As the adhesive, for example, a sheet-shaped hot melt, an adhesive tape, or the like can be used. In addition, a non-adhesion region that is not bonded is provided between the adhesion region 421 and the fracture portion 407.

When the inner side stay cloth 420 is attached to the cushion pad 410 with adhesive, it is possible to fix the upper side guide member 413 by a simpler method as compared with the related art, and workability of attaching the inner side stay cloth 420 can be improved.

In addition, when the inner side stay cloth 420 is fixed with adhesive, since the inner side stay cloth 420 can be attached even in a location where the pull-in groove is not present, it is possible to cope with the design of various vehicle seats.

In addition, when the adhesion region 421 is provided at a region other than the fracture portion 407 that is a tear line, and the inner side stay cloth 420 is bonded, supportability is improved. For example, the adhesion region 421 is provided at a position separated from the fracture p predetermined distance, the supportability is improved.

In addition, when the non-adhesion region where adhesive is not provided between the fracture portion 407 and the adhesion region 421, the amount of adhesive used can be reduced.

In addition, when the inner side stay cloth 420 is not disposed the front surface side of the vehicle seat S400, that is, on a seating surface side of the seat back 402, concave and convex impression can be suppressed from occurring on the front surface side of the vehicle seat S400.

Since the skin 411 is not fixed with adhesive or the like, wrinkle is less likely to occur in the skin 411. In addition, since the skin 411 can follow movement of the occupant's neck, interference with the movement of the neck is suppressed.

### <Method of Assembling Vehicle Seat S400>

Description will be given of a method of assembling the vehicle seat S400 including the airbag 404a and the inflator 404b (airbag device 404).

The skin 411 in which the fracture portion 407 to be fractured when the airbag 404a is deployed is formed, and the inner side stay cloth 420 (stay cloth) which is sewn to the fracture portion 407 and of which the amount of tensile elongation is smaller than that of the skin 411 are prepared (preparation process). The outer side stay cloth 423 may be sewn to the rear surface of the skin 411.

In a case where the upper side guide member 413 and the lower side guide member 414 which are disposed on upper and lower sides exist as the guide member, and the inner side stay cloth 422 of the lower side guide member 414 is fixed by the clip 415 provided in the cushion pad 410, the pull-in member 416 that engages with the clip 415 is attached to the inner side stay cloth 422 in advance.

The seat frame F400 to which the airbag device 404 is attached is covered with the urethane cushion pad 410. Next, the inner side stay cloth 420 of the upper side guide member 413 is disposed to extend from the fracture portion 407 along the surface of the cushion pad 410. The inner side stay cloth 422 of the lower side guide member 414 is also disposed to extend from the fracture portion 407 along the surface of the cushion pad 410 (stay cloth arrangement process).

Next, the inner side stay cloth 420 is attached to the surface of the cushion pad 410 by using adhesive. In a case where the adhesive is a hot melt, the adhesive is applied to the inner side stay cloth 420 in advance, and the inner side stay cloth 420 is disposed on the surface of the cushion pad 410 and is bonded by applying heat (stay cloth bonding process).

In addition, the pull-in member 416 engages with the clip 415 to fix the inner side stay cloth 422 of the lower side guide member 414 (stay cloth engagement process).

Next, the cushion pad 410 is covered with the entirety of the skin 411. The lateral portion covering portion 411c of the skin 411 and the outer side stay cloth 423 are disposed on a rear surface side of the cushion pad 410, and the lateral portion covering portion 411c and the rear surface covering portion 411d are coupled by the line fastener 409, thereby completing assembly (skin attachment process).

It takes approximately half a day for the adhesive that bonds the inner side stay cloth 420 to be completely dried, but the adhesive becomes stable enough not to shift a position within 30 minutes. Therefore, when after performing the stay cloth bonding process, the subsequent skin attachment process is performed after approximately 30 minutes, or after simultaneously performing the stay cloth bonding process and the skin attachment process, the skin attachment process is performed after approximately 30 minutes, positional shift of the inner side stay cloth 422 of the lower side guide member 414 can be suppressed.

The clip 415 provided in the pull-in groove 417 is normally open along an extension direction of the pull-in groove 417. Therefore, the pull-in member 416 engaged with the clip 415 is likely to move in the extension direction of the pull-in groove 417. When the stay cloth engagement process is performed after passage of approximately 30 minutes after performing the stay cloth bonding process, assembling work can be performed while suppressing the positional shift of the pull-in member 416.

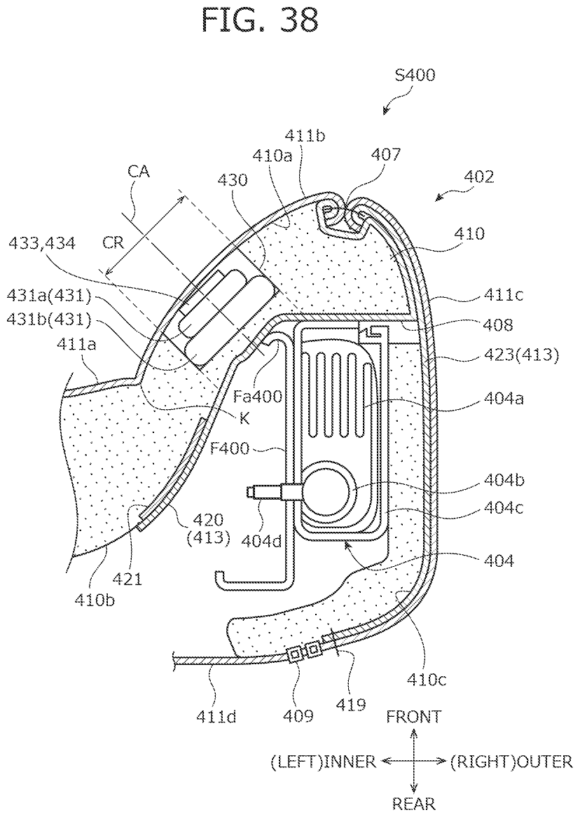

Next, another example of the first example will be described. As illustrated in FIG. 38, an air cell (air bag) may be embedded in the bank portion 402b of the seat back 402. An air cell 431 is constituted by two large and small air bags 431a and 431b, and are configured to be inflated and contracted. When the air cell 431 is inflated and presses a part of the body of an occupant, the lumbar, the back, and the like of the occupant are massaged, and the occupant is relaxed or refreshed.

In the cushion pad 410 of the seat back 402, as illustrated in FIG. 38, the air cell 431 is disposed inside an air cell accommodation portion 430 formed from a front surface side (seating surface side) toward a rear surface side.

In addition, as illustrated in FIG. 38, a heater device 433 may be provided on the front surface side of the air In addition, a vibration device 434 may be cell 431.

provided instead of the heater device 433. A surface of the heater device 433 or the vibration device 434 which faces the occupant is in directly contact with the rear surface of the bank portion covering portion 411b (skin 411). According to this, heat or vibration is likely to be transferred to the occupant.

Note that, the heater device 433 and the vibration device 434 may not be formed on the front surface (surface facing the occupant) of the air cell 431. In this case, the front surface of the air cell 431 is in direct contact with the bank portion covering portion 411b. A cushion member may be provided between the skin 411 and the air cell 431.

In the example illustrated in FIG. 38, the adhesion region 421 is provided at a position other than a region where the air cell 431 comes into contact with the skin 411 when the air cell 431 is inflated. Specifically, the adhesion region 421 is disposed not to be located within a range where a region of a maximum width CR of the air cell 431 is inflated along a central axis CA of the air cell 431.

When the adhesion region 421 is provided in this manner, an influence of the air cell 431 on the adhesion region 421 of the inner side stay cloth 420 is suppressed, that is, a load or a pressure applied to the adhesion region 421 can be reduced. In a case where the heater device 433 or the vibration device 434 exists on the front surface of the air cell 431, it is possible to suppress an influence of heat from the heater device 433 or vibration by the vibration device 434.

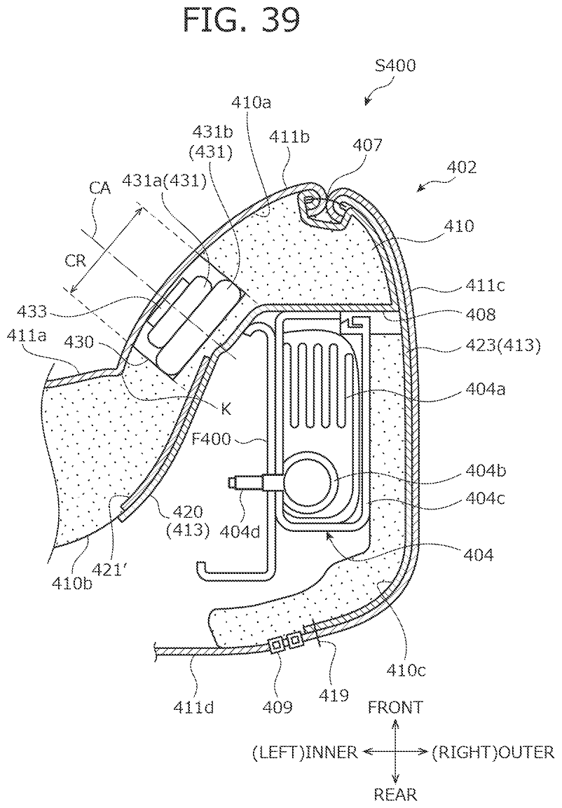

A still another example of the first example will be described with reference to FIG. 39. In the example illustrated in FIG. 39, in a case where the inner side stay cloth 420 is bonded to the rear side surface 410b of the cushion pad 410, an adhesion region 421′ is disposed to overlap a region where the air cell 431 comes into contact with the skin 411 when the air cell 431 is inflated. Specifically, at least a part of the adhesion region 421′ is disposed to be within a range where the region of the maximum width CR of the air cell 431 is inflated along the central axis CA of the air cell 431.

At this time, it is preferable that direct contact between the air cell 431 and the adhesion region 421′ is avoided, and a pad layer is provided between the air cell 431 and the adhesion region 421′ to avoid.

According to this, when the air cell 431 is inflated, the cushion pad 410 presses a part of the adhesion region 421′, and thus adhesivity of the adhesive that bonds the inner side stay cloth 420 and the cushion pad 410 is improved.

### Second Example

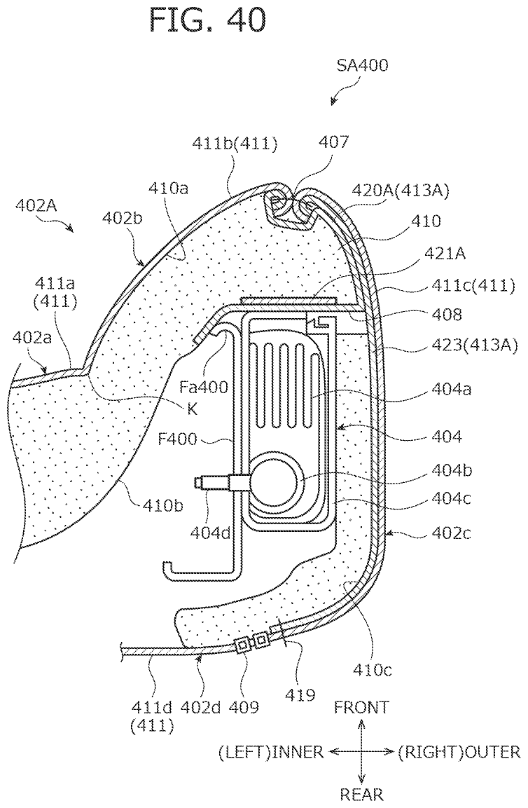

A vehicle seat SA400 that is a second example of this embodiment will be described with reference to FIG. 40 to FIG. 42. FIG. 40 is a cross-sectional view of a seat back 402A along line A-A in FIG. 35, and illustrates an attachment structure of attaching an upper side guide member 413A to the cushion pad 410.

As illustrated in FIG. 40, the seat surface covering portion 411a and the bank portion covering portion 411b in the skin 411 are formed continuously at a boundary portion K between the seat surface portion 402a and the bank portion 402b of the seat back 402A.

The upper side guide member 413A includes the outer side stay cloth 423 and an inner side stay cloth 420A, and the inner side stay cloth 422 and the outer side stay cloth 423 are sewn with the skin 411 at the fracture portion 407. As in the outer side stay cloth 423 of the first example, at the side portion 402c of the seat back 402, the outer side stay cloth 423 is disposed from the fracture portion 407 to the rear surface portion 402d along the lateral portion surface 410c (lateral portion surface) of the cushion pad 410, and is sewn at the rear surface side sewn portion 419.

On the other hand, with regard to the inner side stay cloth 420A, the position of the adhesion region 421A that is attached to the cushion pad 410 with adhesive is different as compared with the inner side stay cloth 420 in the first example.

As illustrated in FIG. 40, the inner side stay cloth 420A extends from the fracture portion 407 along the lateral portion surface 410c (surface) of the cushion pad 410, and enters into the cushion pad 410 from the slit 408. The inner side stay cloth 420A entered into the cushion pad 410 from the slit 408 passes through the front surface of the case 404c of the airbag device 404, and extends beyond the arc-shaped portion Fa400 of the seat frame F400. In addition, the inner side stay cloth 420A and the cushion pad 410 are attached in the adhesion region 421A provided on the front surface side of the airbag device 404 with adhesive. The case 404c of the airbag device 404 and the inner side stay cloth 420A come into contact with each other but are not attached with the adhesive.

When the inner side stay cloth 420A is attached to the cushion pad 410 with the adhesive, the upper side guide member 413A can be fixed by a simpler method as compared with the related art, and workability of attaching the inner side stay cloth 420A can be improved.

In addition, when the adhesion region 421A is sandwiched between the case 404c of the airbag device 404 and the rear surface side skin of the cushion pad 410, the inner side stay cloth 420A and the cushion pad 410 can be more firmly bonded.

In addition, when the inner side stay cloth 420A is bonded at a position separated from the fracture portion 407 that is a tear line, supportability is improved. In addition, when a region where the adhesive is not provided exists between the fracture portion 407 and the adhesion region 421, the amount of the adhesive used can be reduced.

Since the inner side stay cloth 420 is not disposed on the front surface side of the conveyance seat, that is, on the seating surface side of the seat back 402, concave and convex impression can be suppressed from occurring on the front surface side.

Since the skin 411 is not fixed with adhesive or the like, wrinkle is less likely to occur in the skin 411. In addition, since the skin 411 can follow movement of the occupant's neck, interference with the movement of the neck is suppressed.

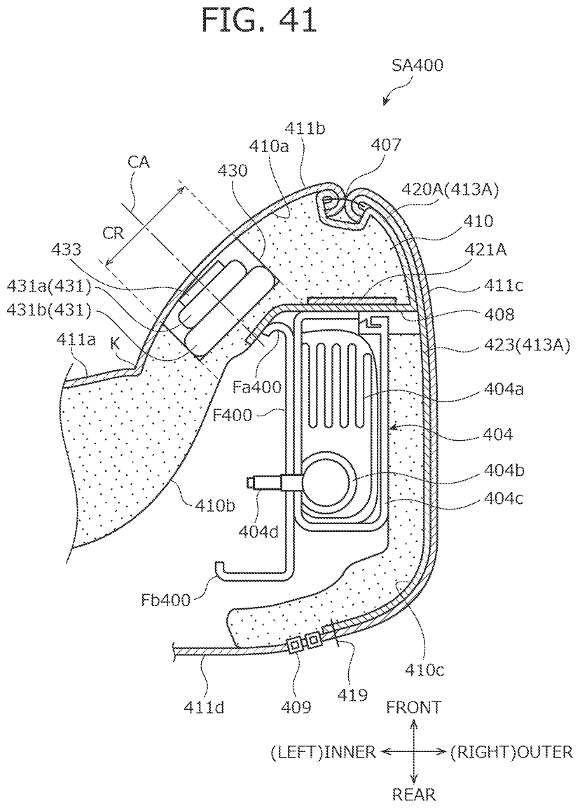

A still another example of the second example will be described with reference to FIG. 41. FIG. 41 is a cross-sectional view of the seat back 402A in which the air cell 431 (air bag) and the heater device 433 or the vibration device 434 are embedded in the bank portion 402b. The configuration of the air cell 431, the heater device 433, or the like is the same as illustrated in FIG. 38, and thus detailed description thereof will be omitted.

As illustrated in FIG. 41, the adhesion region 421A is provided at a position other than a region where the air cell 431 comes into contact with the skin 411 when the air cell 431 is inflated. Specifically, the adhesion region 421A is disposed not to be located within a range where a region of a maximum width CR of the air cell 431 is inflated along a central axis CA of the air cell 431.

When the adhesion region 421A is provided at the position, an influence of the air cell 431 on the adhesion region 421A of the inner side stay cloth 420A is suppressed, that is, a load or a pressure applied to the adhesion region 421A can be reduced. In a case where the heater device 433 or the vibration device 434 exists on the front surface of the air cell 431, it is possible to suppress an influence of heat from the heater device 433 or vibration by the vibration device 434.

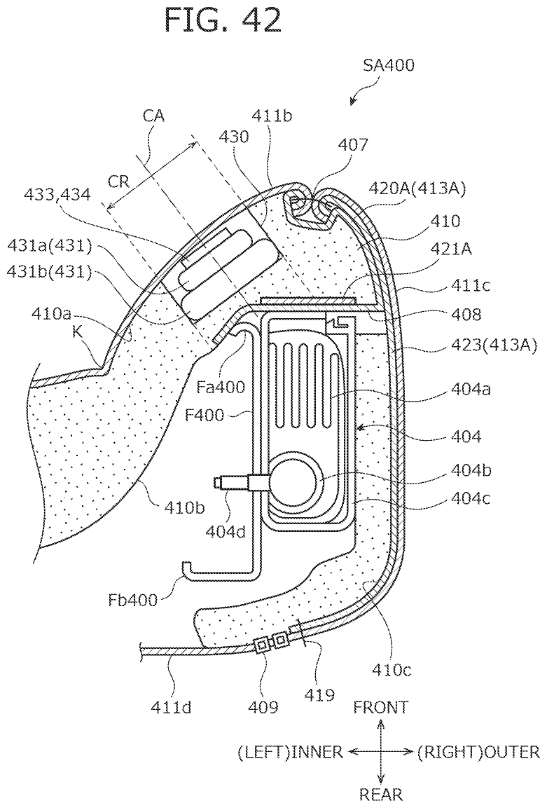

A still another example of the second example will be described with reference to FIG. 42. In the example illustrated in FIG. 42, in a case where the inner side stay cloth 420A is bonded between the cushion pad 410 and the airbag device 404, the adhesion region 421A is disposed to overlap a region where the air cell 431 comes into contact with the skin 411 when the air cell 431 is inflated.

Specifically, at least a part of the adhesion region 421A is disposed to be within a range where the region of the maximum width CR of the air cell 431 is inflated along the central axis CA of the air cell 431.

At this time, it is preferable that direct contact between the air cell 431 and the adhesion region 421A is avoided, and a pad layer is provided between the air cell 431 and the adhesion region 421.

According to this, when the air cell 431 is inflated, the cushion pad 410 presses the adhesion region 421, and thus adhesivity of the adhesive that bonds the inner side stay cloth 420 and the cushion pad 410 is improved.

### Third Example

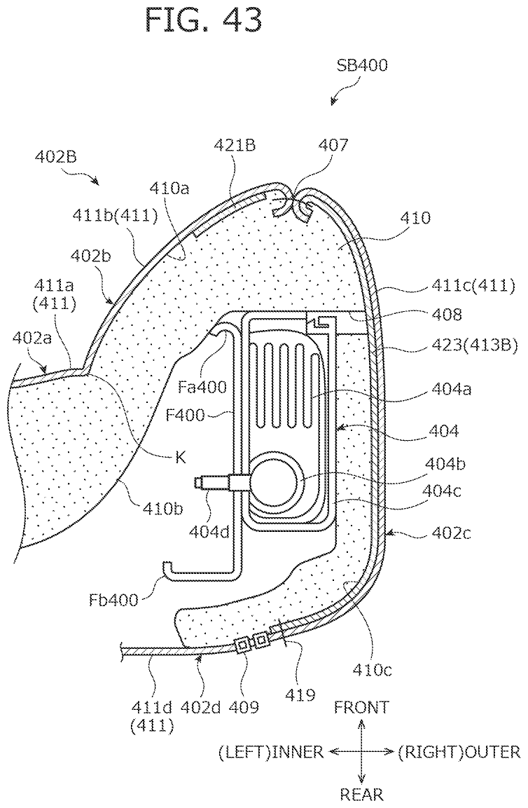

A vehicle seat SB400 that is a third example of this embodiment will be described with reference to FIG. 43 to FIG. 45. FIG. 43 is a cross-sectional view of a seat back 402B along line A-A in FIG. 35 and illustrates an attachment structure of attaching an upper side guide member 413B to the cushion pad 410.

As illustrated in FIG. 43, the seat surface covering portion 411a and the bank portion covering portion 411b in the skin 411 are formed continuously at the boundary portion K between the seat surface portion 402a and the bank portion 402b.

The upper side guide member 413B is constituted by only the outer side stay cloth 423, and the outer side stay cloth 423 is sewn with the skin 411 at the fracture portion 407.

As in the outer side stay cloth 423 of the first example, at the side portion 402c of the seat back 402, the outer side stay cloth 423 is disposed from the fracture portion 407 to the rear surface portion 402d along the lateral portion surface 410c of the cushion pad 410.

When being compared with the first example, the inner side stay cloth 420 is not provided, and a position of the adhesion region 421B is different. In the third example, the bank portion covering portion 411b of the skin 411 and the bank portion surface 410a of the cushion pad 410 are directly bonded with adhesive at the adhesion region 421B, and a part of the skin 411 is fixed to the cushion pad 410. As illustrated in FIG. 43, the adhesion region 421B is provided on the front surface side (seating surface side) of the cushion pad 410 in the vicinity of the fracture portion 407 that is a tear line.

When the skin 411 is fixed at a position closer to the fracture portion 407, an influence of elongation of the skin 411 can be reduced.

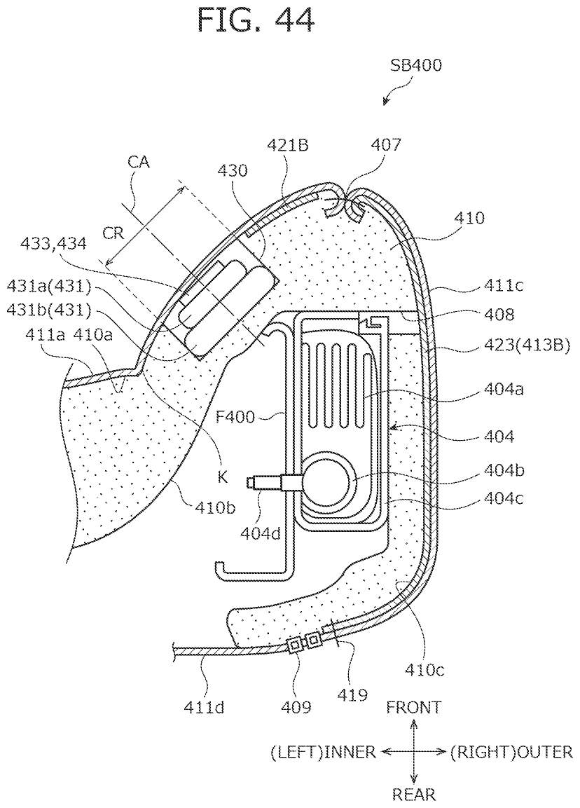

Another example of the third example will be described with reference to FIG. 44. FIG. 44 is a cross-sectional view of a seat back 402B in which the air cell 431 (air bag) and the heater device 433 or the vibration device 434 are embedded in the bank portion 402b. The configuration of the air cell 431, the heater device 433, or the like is the same as illustrated in FIG. 38, and thus detailed description thereof will be omitted.

As illustrated in FIG. 44, the adhesion region 421B is provided at a position other than a region where the air cell 431 comes into contact with the skin 411 when the air cell 431 is inflated. Specifically, the adhesion region 421B is disposed not to be located within a range where a region of a maximum width CR of the air cell 431 is inflated along a central axis CA of the air cell 431.

When the adhesion region 421B is provided in this manner, an influence of the air cell 431 on the adhesion region 421B is suppressed, that is, a load or a pressure applied to the adhesion region 421B can be reduced. In a case where the heater device 433 or the vibration device 434 exists on the front surface of the air cell 431, it is possible to suppress an influence of heat from the heater device 433 or vibration by the vibration device 434.

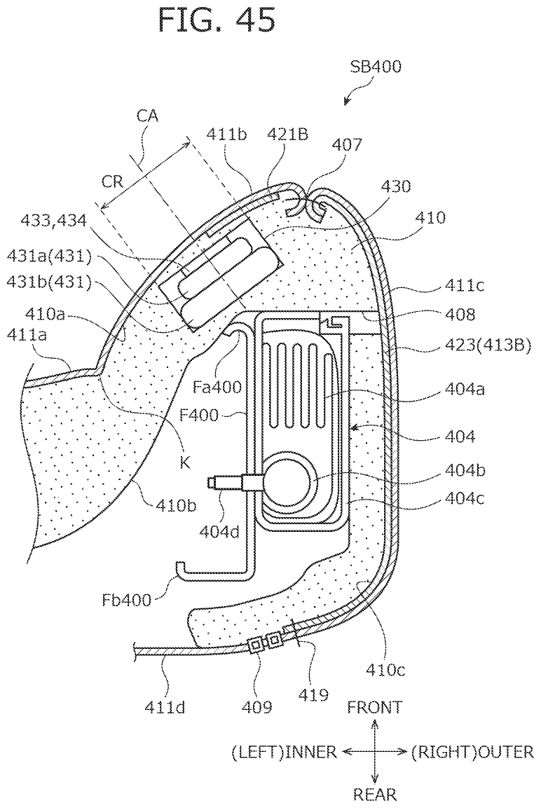

A still another example of the third example will be described with reference to FIG. 45. In the example illustrated in FIG. 45, the adhesion region 421B is disposed to overlap a region where the air cell 431 comes into contact with the skin 411 when the air cell 431 is inflated.

Specifically, at least a part of the adhesion region 421B is disposed to be within a range where the region of the maximum width CR of the air cell 431 is inflated along the central axis CA of the air cell 431.

At this time, it is preferable that direct contact between the air cell 431 and the adhesion region 421B is avoided, and a pad layer is provided between the air cell 431 and the adhesion region 421B.

According to this, when the air cell 431 is inflated, the cushion pad 410 presses the adhesion region 421B, and adhesivity of the adhesive that bonds the skin 411 and the cushion pad 410 is improved.

### Fourth Example

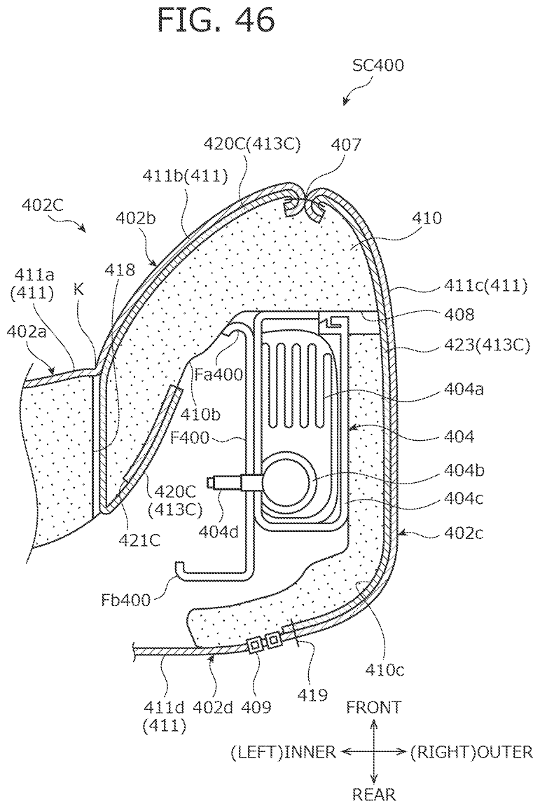

A vehicle seat SC400 that is a fourth example of this embodiment will be described with reference to FIG. 46. FIG. 46 is a cross-sectional view of a seat back 402C along line A-A in FIG. 35, and illustrates an attachment structure of attaching an upper side guide member 413C to the cushion pad 410.

As illustrated in FIG. 46, the seat surface covering portion 411a and the bank portion covering portion 411b in the skin 411 are formed continuously at the boundary portion K between the seat surface portion 402a and the bank portion 402b. In addition, at the boundary portion K, the slit 418 extending from the bank portion surface 410a to the rear side surface 410b is formed in the cushion pad 410.

The upper side guide member 413C includes an inner side stay cloth 420C and the outer side stay cloth 423, and the inner side stay cloth 422 and the outer side stay cloth 423 are sewn with the skin 411 at the fracture portion 407.

As in the outer side stay cloth of the first example, at the side portion 402c of the seat back 402, the outer side stay cloth 423 is disposed from the fracture portion 407 to the rear surface portion 402d along the lateral portion surface 410c of the cushion pad 410, and is sewn at the rear surface side sewn portion 419.

When being compared with the first example, a direction in which the inner side stay cloth 420C extends is different. The inner side stay cloth 420C extends from the fracture portion 407 along the bank portion surface 410a (surface) of the cushion pad 410, and enters into the cushion pad 410 from the slit 418 formed at the boundary portion K.

The inner side stay cloth 420C entered from the slit 418 is bent outward in the seat width direction at a rear surface side opening of the slit 418, and extends along the rear side surface 410b. In addition, the inner side stay cloth 420C is attached to the rear side surface 410b (inclined portion) of the cushion pad 410 with adhesive at the adhesion region 421C. The adhesion region 421C is provided on an inner side in the seat width direction as compared with an inner end portion of the flange Fb400 on a rear end side of the seat frame F400.

It is necessary to form the slit 418, but since the inner side stay cloth 420C can be extended in the same direction as in the lower side guide member 414, and a force applied at the time of airbag deployment becomes the same as a stress applied to the inner side stay cloth 420C, the inner side stay cloth 420C can stably support the fracture portion 407.

### Fifth Example

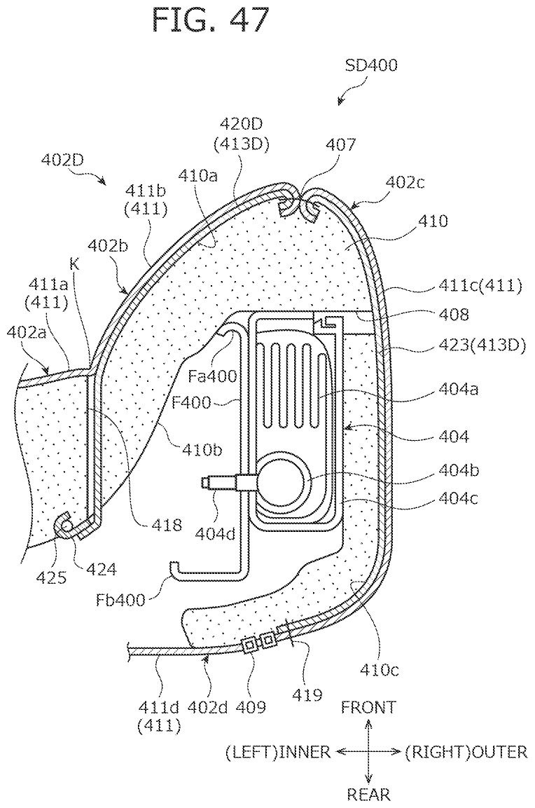

A vehicle seat SD400 that is a fifth example of this embodiment will be described with reference to FIG. 47. With regard to fixing means in the fourth example, the inner side stay cloth 420C is attached to the rear side surface 410b of the cushion pad 410 by using adhesive. However, in the fifth example, a J-hook 424 is formed at a tip end of an inner side stay cloth 420D instead of the adhesive, and the inner side stay cloth 420D is fixed to the rear side surface 410b.

Specifically, the inner side stay cloth 420D extending from the fracture portion 407 passes through the slit 418, and the J-hook 424 is hooked to an insert wire 425 attached to the periphery of a rear surface side opening of the slit 418, thereby fixing the inner side stay cloth 420C. It takes approximately half a day for adhesive to be completely dried, but since the adhesive is not used in this example, attachment of the inner side stay cloth 420D can be completed without waiting for drying.

### Sixth Example

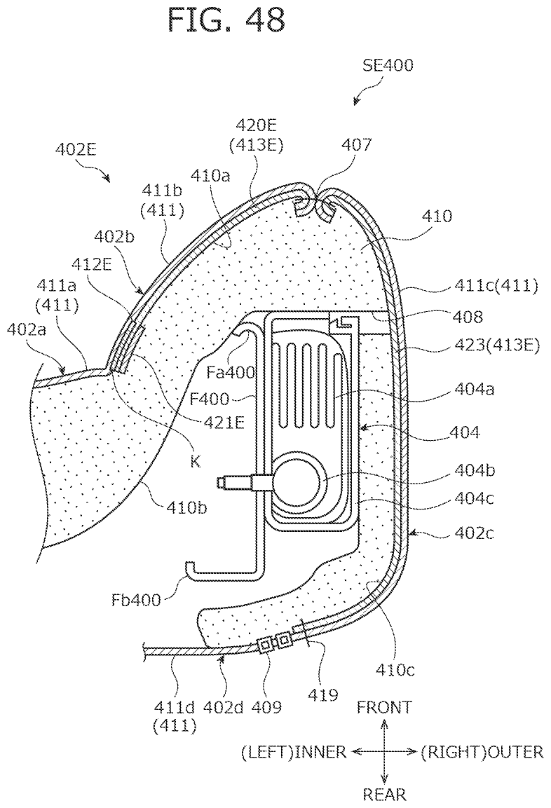

A vehicle seat SE400 that is a sixth example of this embodiment will be described with reference to FIG. 48. FIG. 48 is a cross-sectional view of a seat back 402E along line A-A in FIG. 35, and illustrates an attachment structure of attaching an upper side guide member 413E to the cushion pad 410.

As illustrated in FIG. 48, the seat surface covering portion 411a and the bank portion covering portion 411b in the skin 411 are formed continuously at the boundary portion K between the seat surface portion 402a and the bank portion 492b.

The upper side guide member 413E includes an inner side stay cloth 420E and the outer side stay cloth 423, and the inner side stay cloth 420E and the outer side stay cloth 423 are sewn with the skin 411 at the fracture portion 407.

As in the outer side stay cloth 423 of the first example, at the side portion 402c of the seat back 402E, the outer side stay cloth 423 is disposed from the fracture portion 407 to the rear surface portion 402d along the lateral portion surface 410c of the cushion pad 410. In addition, an end portion of the outer side stay cloth 423, which is opposite to an end portion that is sewn with the fracture portion 407, is sewn at the rear surface side sewn portion 419.

On the other hand, when being compared with the first example, in the inner side stay cloth 420E, an extension direction from the fracture portion 407 and a position of an adhesion region 421E where bonding to the cushion pad 410 is performed with adhesive are different.

Specifically, as illustrated in FIG. 48, the inner side stay cloth 420E extends from the fracture portion 407 that is a tear line to the boundary portion K between the seat surface portion 402a and the bank portion 402b along the bank portion surface 410a (surface) of the cushion pad 410. In addition, a tip end portion of the inner side stay cloth 420E, that is, an end portion opposite to an end portion that is connected to the fracture portion 407 is attached to the cushion pad 410 with adhesive at the adhesion region 421E in the vicinity of the boundary portion K.

The inner side stay cloth 420E is bonded to the rear surface of the bank portion covering portion 411b of the skin 411 with adhesive at the adhesion region 412E.

Since the inner side stay cloth 420E is attached to the cushion pad 410 with adhesive, it is applicable to a seat in a type of covering the skin 411 in which the pull-in groove is not formed.

In addition, partial bonding is performed, the cost can be reduced as compared with a case where the adhesive is applied to an entire region. In addition, even in a case where a deployment direction of the airbag 404a varies, it is possible to stably exhibit a function as a guide member due to the degree of freedom of the inner side stay cloth 420E at a non-adhesion region.

In addition, since the bank portion covering portion 411b of the skin 411 and the inner side stay cloth 420E are bonded, the inner side stay cloth 420E can be more firmly supported.

In addition, the adhesion region 412E where the skin 411 and the inner side stay cloth 420E are bonded, and the adhesion region 421E where the inner side stay cloth and the cushion pad 410 are bonded may be set to have approximately the same size.

The inner side stay cloth 420E can be firmly attached to both the skin 411 and the cushion pad 410.

In addition, the adhesion region 421E may be larger than the adhesion region 412E. The inner side stay cloth 420E can be firmly attached to the cushion pad 410.

### Seventh Example

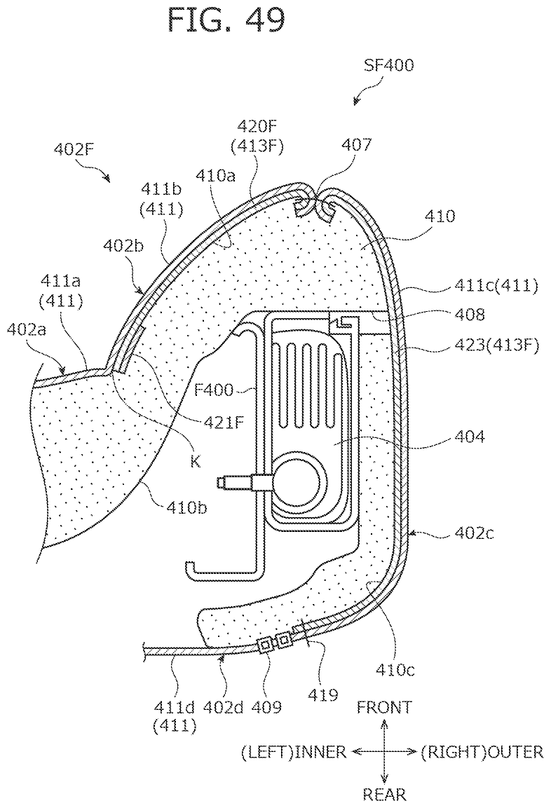

A vehicle seat SF400 that is a seventh example of this embodiment will be described with reference to FIG. 49. FIG. 49 is a cross-sectional view of a seat back 402F along line A-A in FIG. 35, and illustrates an attachment structure of attaching an upper side guide member 413F to the cushion pad 410.

The upper side guide member 413F includes an inner side stay cloth 420F and the outer side stay cloth 423, and the inner side stay cloth 422F and the outer side stay cloth 423 are sewn with the skin 411 at the fracture portion 407. The outer side stay cloth 423 has the same configuration as in the first example. As in the inner side stay cloth 420E of the sixth example, the inner side stay cloth 420F extends from the fracture portion 407 that is a tear line to the boundary portion K between the seat surface portion 402a and the bank portion 402b along the bank portion surface (surface) of the cushion pad 410.

In addition, a tip end portion of the inner side stay cloth 420F, that is, an end portion opposite to an end portion that is connected to the fracture portion 407 is attached to the cushion pad 410 with adhesive at the adhesion region 421F in the vicinity of the boundary portion K. In the sixth example, the skin 411 is attached to the inner side stay cloth 420F with adhesive, but in this example, the skin 411 is not fixed to the inner side stay cloth 420F with adhesive.

Since the skin 411 is not fixed to the inner side stay cloth 420F with adhesive, the amount of the adhesive is decreased and the cost can be reduced. In addition, the skin 411 is not fixed, wrinkle is less likely to occur in the skin 411.

In addition, since the skin 411 can follow movement of the occupant's neck, interference with the movement of the neck is suppressed. Even in a case where a deployment direction of the airbag 404a varies, it is possible to stably exhibit a function as a guide member due to the degree of freedom of the inner side stay cloth 420F.

### Eighth Example

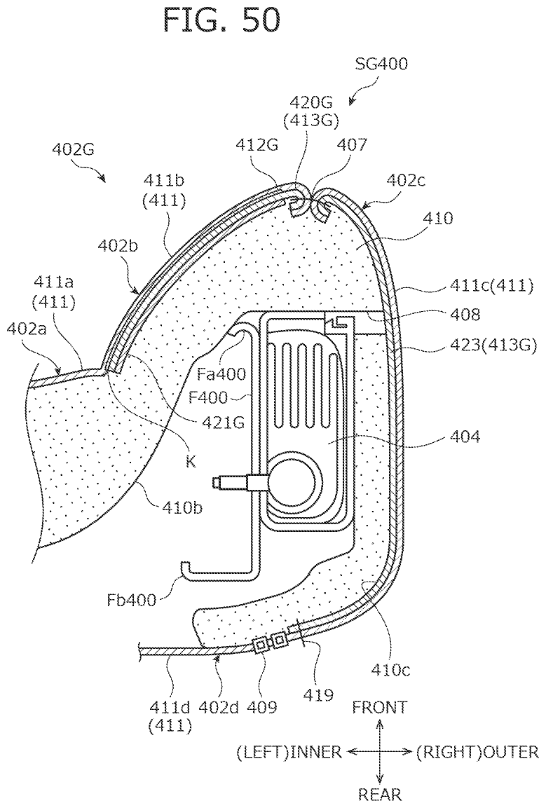

A vehicle seat SG400 that is an eighth example of this embodiment will be described with reference to FIG. 50. FIG. 50 is a cross-sectional view of a seat back 402G along line A-A in FIG. 35, and illustrates an attachment structure of attaching an upper side guide member 413G to the cushion pad 410.

As in the upper side guide member 413 of the sixth example, the upper side guide member 413G of the eighth example includes the outer side stay cloth 423 and an inner side stay cloth 420G. The outer side stay cloth 423 is disposed from the fracture portion 407 to the rear surface portion 402d along the lateral portion surface 410c of the cushion pad 410 at the side portion 402c of the seat back 402. In addition, in the outer side stay cloth 423, an end portion opposite to an end portion that is connected to the fracture portion 407 is attached to the skin 411 by sewing at the rear surface side sewn portion 419, and is in a state of being backed to a lining side of the skin 411.

As in the inner side stay cloth 420E of the t sixth example, the inner side stay cloth 420G extends from the fracture portion 407 that is a tear line to the boundary portion K between the seat surface portion 402a and the bank portion 402b along the bank portion surface 410a (surface) of the cushion pad 410.

In the inner side stay cloth 420E of the above-described sixth example, bonding is performed only at the adhesion region 421E in the vicinity of the boundary portion K. As illustrated in FIG. 50, the inner side stay cloth 420G of the eighth example is bonded to the cushion pad 410 at the bank portion surface 410a (adhesion region 421G) other than the fracture portion 407 that is a tear line.

In addition, the inner side stay cloth 420G is bonded to a portion (adhesion region 412G) other than the fracture portion 407 in the skin 411.

When the inner side stay cloth 420G is attached as described above, holding strength of the inner side stay cloth 420G is raised, and the configuration is applicable to an airbag device with high deployment output. In addition, this configuration is also applicable to a full-surface adhesion method in which the skin is attached entirely with adhesive.

### Ninth Example

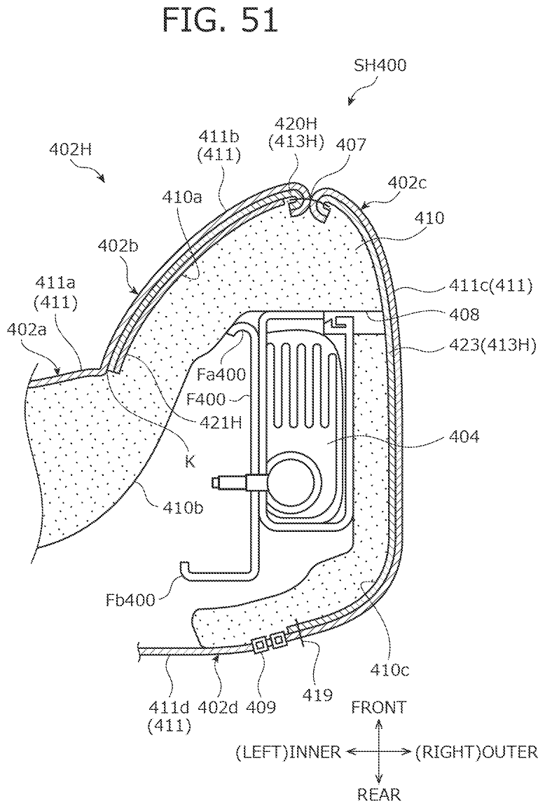

A vehicle seat SH400 that is a ninth example of this embodiment will be described with reference to FIG. 51. FIG. 51 is a cross-sectional view of a seat back 402H along line A-A in FIG. 35, and illustrates an attachment structure of attaching an upper side guide member 413H to the cushion pad 410.

An inner side stay cloth 420H of the ninth example is attached to the cushion pad 410 with adhesive at the bank portion surface (adhesion region 421H) other than the fracture portion 407 that is a tear line. On the other hand, the inner side stay cloth 420H is not bonded to the skin 411 (bank portion covering portion 411b).

When the inner side stay cloth 420H and the cushion pad 410 are bonded at a portion other than the fracture portion 407, holding strength is raised, and this configuration is applicable to an airbag device with high deployment output. On the other hand, the skin 411 is not fixed to the inner side stay cloth 420H, and thus wrinkle is less likely to occur in the skin 411.

### Tenth Example

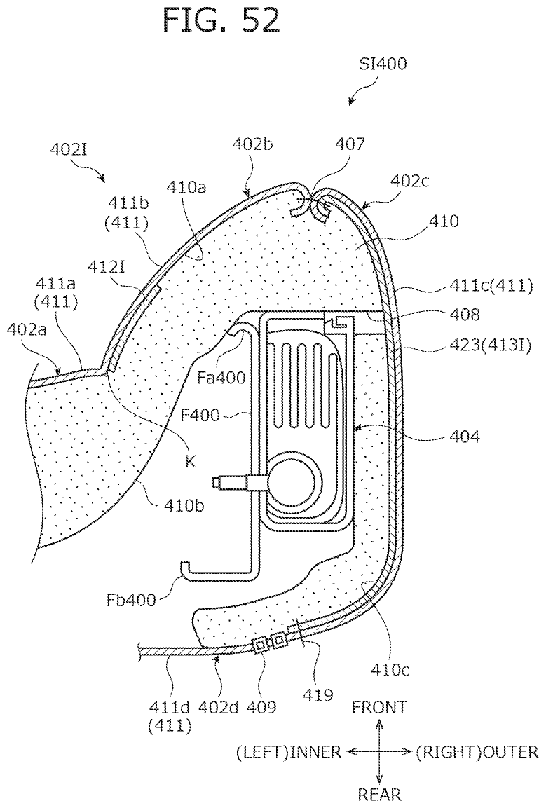

A vehicle seat SI400 that is a tenth example of this embodiment will be described with reference to FIG. 52. FIG. 52 is a cross-sectional view of a seat back 4021 along line A-A in FIG. 35, and illustrates an attachment structure of attaching an upper side guide member 413I to the cushion pad 410.

The upper side guide member 413I of the tenth example is constituted by only an outer side stay cloth 423, and an inner side stay cloth is not provided. As in the outer side stay cloth 423 of the first example, the outer side stay cloth 423 is attached to the skin 411 by sewing at the fracture portion 407 and the rear surface side sewn portion 419, and is in a state of being backed to a rear surface side of the skin 411.

In addition, in the bank portion surface 410a of the cushion pad 410, the bank portion covering portion 411b of the skin 411 is directly attached with adhesive at the adhesion region 412I instead of the inner side stay cloth.

In the tenth example, since the inner side stay cloth is not provided on the rear surface side of the skin 411, concave and convex impression in the appearance can be reduced.

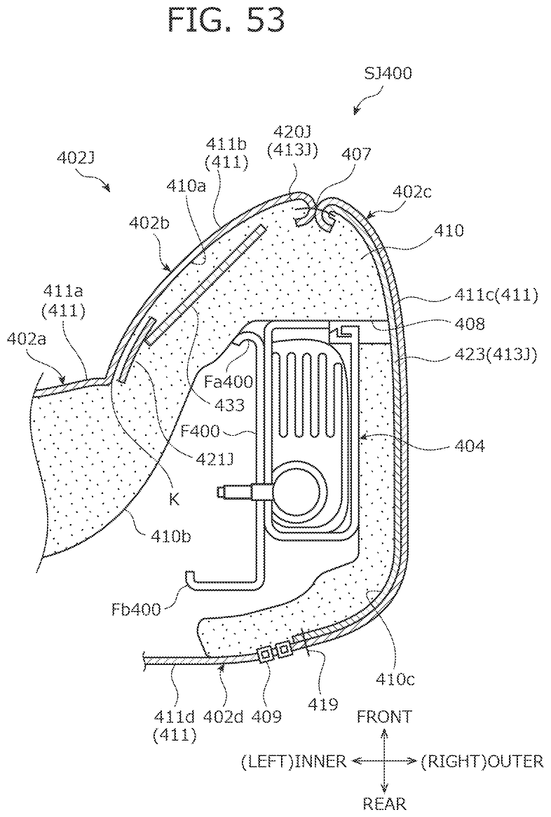

Note that, in the example illustrated in FIG. 53, the adhesion region 412I is partially provided, and a non-adhesion region exists between the adhesion region 412I and the fracture portion 407, but as in the eighth example, the skin 411 may be bonded to the bank portion surface 410a of the cushion pad 410 by widening the adhesion region 412J to a portion other than the fracture portion 407. That is, the entirety of the rear surface of the bank portion covering portion 411b of the skin 411 may be bonded to the cushion pad 410.

### Eleventh Example

A vehicle seat SJ400 that is an eleventh example of this embodiment will be described with reference to FIG. 53. FIG. 53 is a cross-sectional view of a seat back 402J along line A-A in FIG. 35, and illustrates an attachment structure of attaching an upper side guide member 413J to the cushion pad 410.

As illustrated in FIG. 53, in the vehicle seat SJ400, the heater device 433 is provided inside the bank portion of the seat back 402J. When the heater device 433 is provided, the shoulder and the like of a seated occupant can be warmed.

The upper side guide member 413J includes an outer side stay cloth 423 and an inner side stay cloth 420J. As illustrated in FIG. 53, the inner side stay cloth 420J is disposed to overlap the heater device 433 in a thickness direction of the cushion pad 410. For example, as in the inner side stay cloth 420F illustrated in the seventh example, the inner side stay cloth 423J is attached to the bank portion surface 410a of the cushion pad 410 with adhesive at the adhesion region 421J.

When the inner side stay cloth 423J is disposed to overlap the heater device 433 in the thickness direction, high space saving can be secured.

In addition, in a case where the heater device 433 exists inside the bank portion, the inner side stay cloth 423J may be disposed not to overlap the heater device 433 in the thickness direction. For example, the inner side stay cloth 423J is disposed at a position where the heater device 433 is not provided by shifting the inner side stay cloth 423J in the seat height direction. When the inner side stay cloth 423J and the heater device 433 are disposed not to overlap each other in the thickness direction, an increase in the thickness of the seat back 402 can be suppressed.

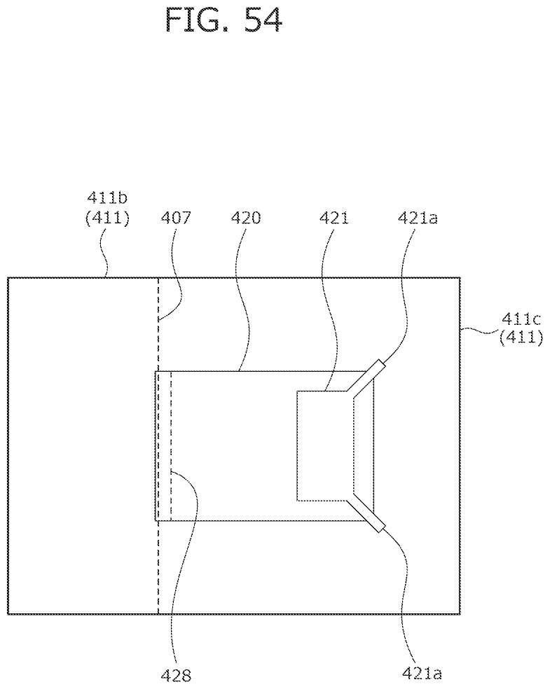

An example of arrangement of adhesive will be described with reference to FIG. 54. FIG. 54 is an explanatory view illustrating the inner side stay cloth 420 attached to the skin 411 before being attached to the cushion pad 410. The inner side stay cloth 420 is sewn by the sewn portion 428 in the vicinity of the fracture portion 407 that becomes a tear line.

Adhesive by a hot melt or the like is applied to the adhesion region 421 of the inner side stay cloth 420 in advance, and after attachment, the adhesive is heated to bond the inner side stay cloth 420 to the rear side surface 410b of the cushion pad 410. At this time, a portion of the adhesive is stretched and attached so as to protrude from the inner side stay cloth 420 as an extension portion 421a.

Specifically, as illustrated in FIG. 54, the adhesive is stretched from corners of the adhesion region 421 toward corners of the inner side stay cloth 420, and is disposed to slightly protrude so as to be bonded to the skin 411.

When a portion of the adhesive is made to protrude as described above, it enters a state in which the inner side stay cloth 420 is temporarily fixed to the skin 411, and for example, the cushion pad 410 is covered with the skin 411, the inner side stay cloth 420 is suppressed from being caught and bent or displaced. In addition, after the inner side stay cloth 420 is disposed at a predetermined position, the inner side stay cloth 420 and the surface of the cushion pad 410 can be bonded by applying heat to the adhesive.

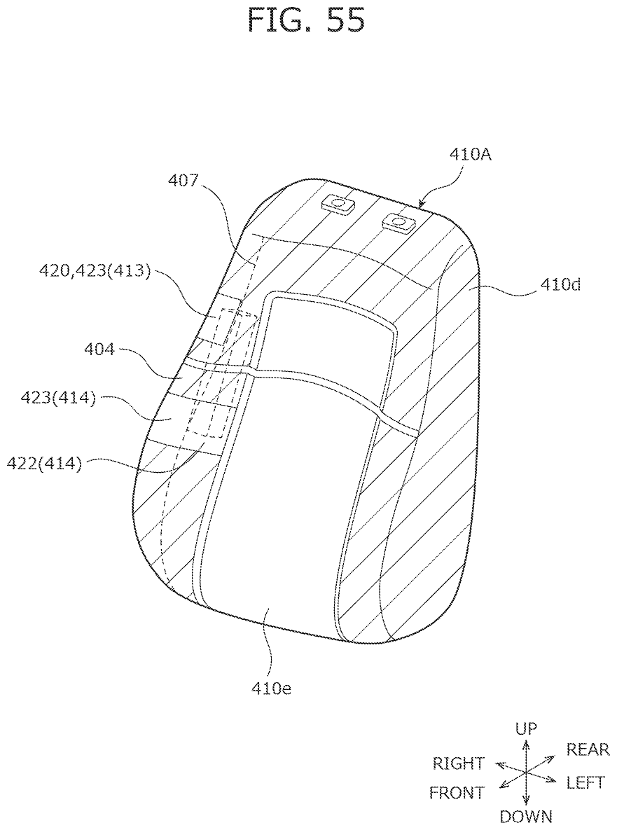

Another example (cushion pad 410A) of the cushion pad 410 will be described with reference to FIG. 55. A cushion pad 410A includes a cushion center portion 410e located on an inner side as compared with a groove in the seat width direction, and a cushion side portion 410d located on an outer side as compared with the groove.

In addition, the cushion side portion 410d is configured to have hardness higher than that of the cushion center portion 410e. According to this configuration, the cushion center portion 410e smoothly catches a seated occupant, and the cushion side portion 410d can reliably hold and catch the occupant. The cushion pad 410A in which hardness is partially different can be formed by using a known technology such as two-color molding using, for example, urethane materials different from each other.

The above-described upper side guide members 413, and 413A to 413J may be attached to the cushion side portion 410d having high hardness. Particularly, in a case where the inner side stay cloth 420 is attached with adhesive, a pad material is less likely to be bent, and an adhesion state is likely to be maintained.

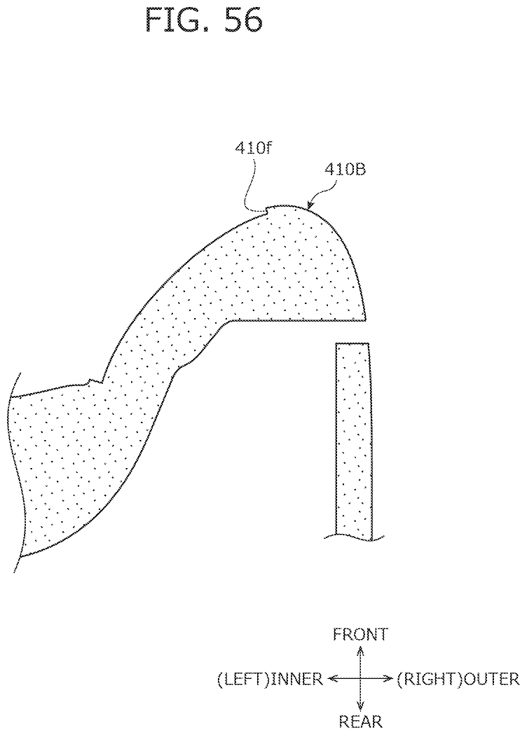

Still another example (cushion pad 410B) of the cushion pad 410 mounted on the seat back 402 will be described with reference to FIG. 56. FIG. 56 is a cross-sectional view of the cushion pad 410B, and a concave portion 410f is formed at a part of the bank portion surface 410a in correspondence with a position where the inner side stay cloth 420E to 420G, or 420J illustrated in the sixth example to the ninth example, or the eleventh example is disposed. In addition, the inner side stay cloths 420E to 420G, or 420J may be disposed inside the concave portion 410f. When the inner side stay cloths 420E to 420G, or 420J is disposed inside the concave portion 410f, a positional deviation of the inner side stay cloths 420E to 420G, or 420J, or a positional deviation of the adhesive can be suppressed. In addition, an increase in thickness can be suppressed, and according to this, for example, concave and convex impression in a case where the skin 411 is viewed from the front surface can be reduced.

The attachment structure of the upper side guide members 413, and 413A to 413J used in the vehicle seats S400, and SA400 to SJ400 from the first example to the eleventh example of the above-described embodiment is applied to the near-side airbag disposed on a vehicle outer side of the vehicle seats, but the attachment structure of attaching the upper side guide members 413, and 413A to 413J to the cushion pad 410 is not limited to the case of the near-side airbag. For example, the attachment structure is also applicable to the airbag device 405 that is a far-side airbag provided on a vehicle inner side as illustrated in FIG. 35. That is, the above-described attachment structure may be applicable to fixing of the upper side guide member 426 and the lower side guide member 427 which guide deployment of the far-side airbag. However, in a case of applying the attachment structure illustrated in the fourth example or the fifth example, it is necessary to form a slit 418 extending from the bank portion surface 410a to the rear side surface 410b in the cushion pad 410.

In addition, in a case where the pull-in groove is not present at a location where the lower side guide member is disposed, the lower side guide member may be attached by using the same attachment structure as in the upper side guide member. In addition, attachment to the cushion pad 410 may be performed in combination of the attachment structures of the upper side guide member as illustrated in the first example to the eleventh example.

### Fifth Embodiment

Hereinafter, a fifth embodiment of the present invention will be described. The fifth embodiment of the present invention relates to a condition correction unit that corrects a physical condition of a seated occupant, and particularly, to a condition correction unit capable of correction processing suitable for the individuality of the seated occupant in consideration of a state of a mounted conveyance.

### BACKGROUND ART

There is known a technology of correcting a posture and the like of a seated occupant by detecting the posture and the like of the seated occupant and by moving respective portions of a seat in correspondence with a detection result (for example, refer to JP 2017-081194 A). Specifically, in the technology described in JP 2017-081194 A, the individuality (age, gender, or the like) of the seated occupant on a vehicle seat is grasped in advance, contents corresponding to the grasped individuality or the posture of the seated occupant is measured, and a bulging pressure of an air bag disposed on a seat backrest portion of a seat back is adjusted in correspondence with the measurement result to correct the posture of the seated occupant to an appropriate posture.

### Technical Problem

In a vehicle seat configured to correct a posture in the related art, correction is made to a posture suitable for physical individuality of the seated occupant, but when correcting the posture, a state of the vehicle in which the seat is mounted, for example, a traveling state of the vehicle, a state of the vehicle seat, and the like are not considered. The vehicle state may have an influence on the posture correction, and thus it is demanded to perform the correction to a posture suitable for the physical individuality, and to perform the correction in correspondence with the vehicle state.

Here, the present invention has been made in consideration of the above-described problem, and an object thereof is to provide a condition correction unit capable of performing correction processing in correspondence with a conveyance state.

### Solution to Problem

The problem is solved by the following condition correction unit of the present invention. Specifically, the condition correction unit includes an operation unit that operates to correct a physical condition of a seated occupant who is seated on a conveyance seat, a body measurement unit that measures a current value of an index for specifying the physical condition, a plan storage unit that stores a correction plan showing correction contents of the physical condition, a presentation unit that reads out the correction plan corresponding to the current value from the plan storage unit and presents the correction plan to the seated occupant who is seated on the conveyance seat, a processing execution unit that controls the operation unit and executes correction processing of correcting in the condition correspondence with the correction contents shown by the read-out correction plan, a state acquisition unit that acquires state information indicating a state of a conveyance in which the conveyance seat is disposed or the conveyance seat, and an execution setting unit that sets whether or not the correction processing is executable on the basis of the state information. The processing execution unit executes the correction processing in a case where execution of the correction processing is possible.

In the condition correction unit of the present invention configured as described above, the execution setting unit sets whether or not the correction processing may be executed on the basis of the state information of the conveyance, and the processing execution unit initiates execution of the correction processing in a case where execution is possible. Therefore, a condition correction unit capable of performing correction processing in correspondence with the state of the conveyance can be provided.

In addition, in the condition correction unit, in a case where the execution setting unit sets execution of the correction processing as impossible on the basis of the state information during execution of the correction processing, the processing execution unit may stop execution of the correction processing.

Since execution of the correction processing can be stopped on the basis of the state information of the conveyance during execution of the correction processing, the correction processing can be executed in a more appropriate state.

In addition, in the condition correction unit, the state information may be information indicating that the conveyance is in an automatic drive mode or a manual drive mode, and the execution setting unit may set execution of the correction processing as possible in a case where the conveyance is in the automatic drive mode.

When the correction processing is executed in the case of the automatic drive mode, the correction processing can be executed in a more stable state.

In addition, in the condition correction unit, in a case where the automatic drive mode transitions to the manual drive mode during execution of the correction processing, the execution setting unit may set execution of the correction processing as impossible, and the processing execution unit may stop execution of the correction processing.

When being switched to the manual drive mode, execution of the correction processing can be stopped, and the correction processing can be performed in a more stable state.

In addition, in the condition correction unit, the state information may be a backrest angle of the conveyance seat, the execution setting unit may change contents of the correction processing to processing corresponding to the backrest angle in a case where the backrest angle is equal to or more than a predetermined value, and the processing execution unit may execute the correction processing changed by the execution setting unit.

When the correction processing is executed in correspondence with the backrest angle of the conveyance seat, the correction processing can be performed in a more appropriate state.

In addition, the condition correction unit may further include a vibration application unit that applies vibration to a predetermined part of the body of the seated occupant who is seated on the conveyance seat, the execution setting unit may set whether or not to execute vibrating by the vibration application unit on the basis of elapsed time from the correction processing executed last by the processing execution unit, and when executing the correction processing again, the processing execution unit may apply vibration before execution of the correction processing in a case where execution of vibrating by the vibration application unit is possible, and may not apply vibration in a case where the execution is not possible.

When executing the correction processing again, it is considered that processing of applying vibration is not necessary before a predetermined time has been elapsed, and thus total time taken in the correction processing can be shortened by skipping the processing in order to shorten time taken until initiating the correction processing.

In addition, the condition correction unit may further include a warming unit that warms a predetermined part of the body of the seated occupant who is seated on the conveyance seat, the execution setting unit may set whether or not to perform warming by the warming unit on the basis of elapsed time from the correction processing that is executed last by the processing execution unit, and when executing the correction processing again, the processing execution unit may perform warming before execution of the correction processing in a case where execution of warming by the warming unit is possible, and may not perform warming in a case where execution of warming is not possible.

When executing the correction processing again, it is considered that processing of warming a part of the body is not necessary before a predetermined time has elapsed, and thus total time taken in the correction processing can be shortened by skipping the processing in order to shorten time taken until initiating the correction processing.

In addition, in the condition correction unit, the state information may be information indicating a door opened/closed state of the conveyance, the state acquisition unit may acquire the state information indicating the door opened/closed state before execution of the correction processing or during execution of the correction processing, and the execution setting unit may set whether or not the correction processing is executable on the basis of the door opened/closed state.

The correction processing can be executed in correspondence with the door closed/opened state of the conveyance, and the correction processing can be more stably executed.

In addition, in the condition correction unit, in a case where the door enters an opened state before or during execution of the correction processing, the execution setting unit may set execution of the correction processing as impossible, and the processing execution unit may stop execution of the correction processing.

In a state in which the door of the conveyance is opened, there is a possibility that the occupant may enter or exit the vehicle, and thus when the correction processing is stopped when the door of the conveyance is in the opened state, obstruction on entrance or exiting of the occupant is suppressed.

In addition, in the condition correction unit, in a case where the door enters an opened state before or during execution of the correction processing, the execution setting unit may change the correction processing so that the correction processing is executed after a part of the conveyance seat is lowered or softened, and the processing execution unit may execute the correction processing after a part of the conveyance seat is lowered or softened.

In a state in which the door of the conveyance is opened, there is a possibility that the occupant may enter or exist the vehicle. Therefore, when the door of the conveyance is in an opened state, the position of the occupant during the correction processing is lowered by lowering or softening a part of the conveyance seat, and thus obstruction on entrance or exiting of the occupant is suppressed.

### Advantageous Effects of Invention

According to the condition correction unit of the present invention, the execution setting unit determines whether or not the correction processing may be executed on the basis of the state information of the conveyance, and the processing execution unit initiates execution of the correction processing in a case where execution is possible. Therefore, a condition correction unit capable of performing correction processing in correspondence with the state of the conveyance can be provided.

In addition, according to the condition correction unit of the present invention, since execution of the correction processing can be stopped on the basis of the state information of the conveyance during execution of the correction processing, the correction processing can be executed in a more appropriate state.

In addition, when the correction processing is executed in the case of the automatic drive mode, the correction processing can be executed in a more stable state.

In addition, when being switched to the manual drive mode, execution of the correction processing can be stopped, and the correction processing can be performed in a more stable state.

In addition, when the correction processing is executed in correspondence with the backrest angle of the conveyance seat, the correction processing can be performed in a more appropriate state.

In addition, when executing the correction processing again, it is considered that processing of applying vibration is not necessary before a predetermined time has been elapsed, and thus total time taken in the correction processing can be shortened by skipping the processing in order to shorten time taken until initiating the correction processing.

When executing the correction processing again, it is considered that processing of warming a part of the body is not necessary before a predetermined time has elapsed, and thus total time taken in the correction processing can be shortened by skipping the processing in order to shorten time taken until initiating the correction processing.

In addition, the correction processing can be executed in correspondence with the door opened/closed state of the conveyance, and the correction processing can be more stably executed.

In addition, in a state in which the door of the conveyance is opened, there is a possibility that the occupant may enter or exit the vehicle, and thus when the correction processing is stopped when the door of the conveyance is in the opened state, obstruction on entrance or exiting of the occupant is suppressed.

In addition, in a state in which the door of the conveyance is opened, there is a possibility that the occupant may enter or exist the vehicle. Therefore, when the door of the conveyance is in an opened state, the position of the occupant during the correction processing is lowered by lowering or softening a part of the conveyance seat, and thus obstruction on entrance or exiting of the occupant is suppressed.

### DESCRIPTION OF EMBODIMENTS

Hereinafter, a configuration example and an operation example of a fifth embodiment (this embodiment) of the present invention will be described. Note that, in the following description, it is assumed that a condition correction unit configured to correct a physical condition of a seated occupant who is seated on a vehicle seat (hereinafter, referred to as a seated occupant) with reference to, for example, a vehicle seat as an example of a conveyance seat. However, the condition correction unit of the present invention is also applicable to a conveyance seat other than the vehicle seat, and particular to, a seat mounted on a conveyance (for example, aircrafts or ships) other than the vehicle.

In addition, in the following description, the “physical condition” that is a correction target by the condition correction unit of the present invention represents an orthopedic condition among conditions related to the human body, and specifically, a condition related to skeletons, joints, muscles, and the like. Examples of the physical condition include a curved condition of a spine (in other words, a posture), a muscle tension condition, a skeletal deformation, and the like. Note that, hereinafter, description will be given of a configuration of correcting the curved condition (posture) of the spine as the “physical condition”. However, the correction target by the condition correction unit of the present invention is not limited to the curved condition (posture) of the spine, and may correct other “physical conditions”, for example, the muscle tension condition, the skeletal deformation, and the like.

### Overview of Condition Correction Unit According to This Embodiment

First, an overview of the condition correction unit according to this embodiment (hereinafter, simply referred to as “condition correction unit 501”) will be described. The condition correction unit 501 is mounted inside a vehicle, and is used to improve a health condition of a seated occupant on a vehicle seat S500 step by step. Specifically, the condition correction unit 501 is configured to correct the posture of the seated occupant, that is, the curved condition of the spine while the seated occupant is seated on the vehicle seat S500. In this embodiment, the posture correction by the condition correction unit 501 is performed continuously instead of being performed once, and proceeds in conformity to a plan (correction plan) set in advance.

Specifically, with regard to the correction plan, a plurality of candidates are prepared, and one correction plan is selected among the candidates. The condition correction unit 501 performs the posture correction in accordance with correction contents shown by the selected correction plan. Here, the “correction contents” represent specific contents related to the posture correction, and examples thereof include a part to which a load is applied during the posture correction in the body of the seated occupant, a load balance between parts when applying a load to a plurality of parts, a correction period, a final target posture (specifically, an ideal posture to be described later), a standard size of the load during correction, and the like.

In addition, in this embodiment, the individuality of the seated occupant is reflected in selection of the correction plan. According to this, in this embodiment, posture correction suitable for the individuality of the seated occupant is performed. This is characteristics of this embodiment, and the characteristics will be described later in detail.

Note that, in this embodiment, the condition correction unit 501 is mounted on a seat corresponding a driver's seat in a vehicle seat S500. That is, the condition correction unit 501 is used to correct a driver's posture. However, there is no limitation thereto, and the condition correction unit 501 may be mounted in a seat (for example, a front passenger's seat or a rear seat) other than the driver's seat.

### Configuration Example of Condition Correction Unit

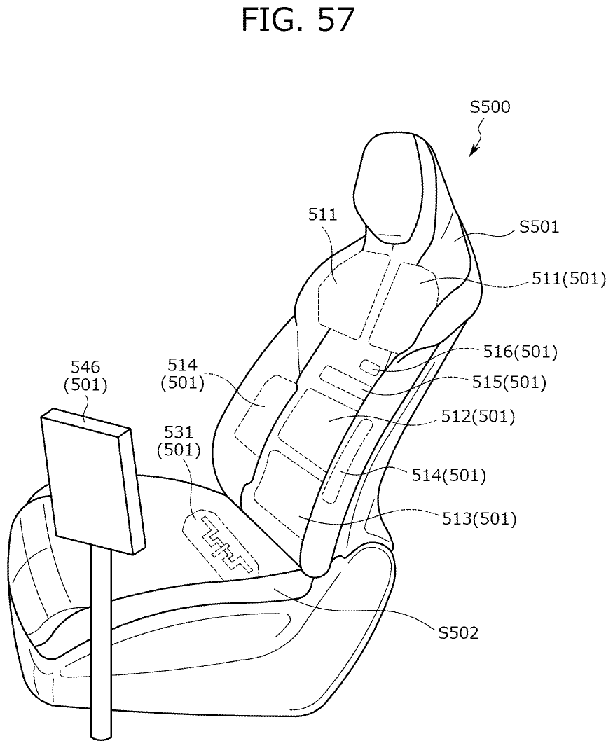

First, in description of a configuration example of the condition correction unit 501, a configuration of a vehicle seat S500 in which the condition correction unit 501 is mounted will be described. As illustrated in FIG. 57, the vehicle seat S500 includes a seat back S501 that supports the back of a seated occupant from a rearward side, a seat cushion S502 that supports buttocks of the seated occupant from a downward side, and a headrest S503 that supports the head of the seated occupant from a rearward side. Basic configurations of the respective portions of the seat are known configurations, and thus description thereof will be omitted.

Next, the configuration example of the condition correction unit 501 will be described. The condition correction unit 501 is constituted by devices disposed inside or in the vicinity of the vehicle seat S500. Specifically, the condition correction unit 501 includes a device (corresponding to an operation unit) that is installed inside the vehicle seat S500 and operates to correct the posture of the seated occupant.

In detailed description of the operation unit, a plurality of support portions including the operation unit exist in the seat back S501 of the vehicle seat S500. Specifically, as illustrated in FIG. 57, the seat back S501 is provided with a shoulder support portion 511, a lumbar support portion 512, a pelvis support portion 513, and a side support portion 514.

The shoulder support portion 511 is a portion that supports a shoulder of the seated occupant in a state of being seated on the vehicle seat S500 (strictly, a seated occupant having a standard body type, the same shall apply hereinafter) in the seat back S501, and a pair the shoulder support portions 511 are provided on right and left sides as illustrated in FIG. 57. The lumbar support portion 512 is a portion that supports a lumbar of the seated occupant in the seat back S501, and is provided at a lower portion of the seat back S501 as illustrated in FIG. 57. The pelvis support portion 513 is a portion, which supports a part where the pelvis is located in the seated occupant's body, and is provided on a downward side of the lumbar support portion 512 as illustrated in FIG. 57. The side support portion 514 is a portion that comes into i contact with the seated occupant's body from a lateral side, and is provided on an inner side of a portion (bank portion) of which both end portions in the width direction are formed to be swollen in the seat back S501 as illustrated in FIG. 57.

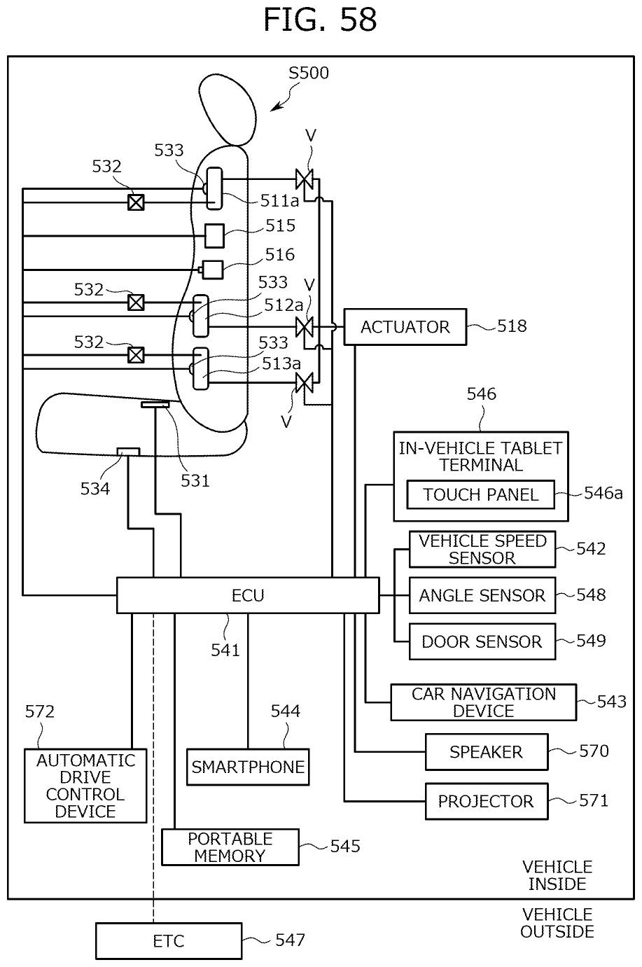

In addition, each of the above-described four support portions includes an air bag. Specifically, as illustrated in FIG. 58, a shoulder air bag 511a is provided in the shoulder support portion 511, a lumbar air bag 512a is provided in the lumbar support portion 512, and a pelvis air bag 513a is provided in the pelvis support portion 513. Note that, although not illustrated in FIG. 58, an air bag is also provided in the side support portion 514.

Each of the air bags is disposed inside of the seat back S501 or on a front surface of the seat back S501. In addition, when being filled with air, the air bag bulges. The posture of the seated occupant is corrected due to bulging of the air bag. More specifically, when each of the air bags bulges while the seated occupant is seated on the vehicle seat S500, the air bag presses the seated occupant from the back side. The posture of the seated occupant is corrected due to the applied pressure. In addition, the pressure that occurs due to the bulging of the air bag corresponds to a load (correction load) that operates on the seated occupant during posture correction.

In addition, supply of air to the air bag is performed by an actuator 518 illustrated in FIG. 58. Air supplied from the actuator 518 is filled into the air bag through a tube (not illustrated) that forms an air supply path. In addition, an electromagnetic valve V configured to adjust the filling amount of air into the air bag is provided for every air bag at a forward position of the air bag. The actuator 518 and the electromagnetic valve V constitute the “operation unit” of the present invention in combination with the air bag.

Note that, in this embodiment, as pressing means that bulges and presses the seated occupant, the air bag that bulges when being filled with air is used, but a bag body that bulges when a fluid other than air such as a liquid is filled in may be used. In addition, there is no limitation to members such as the air bag and the bag body which bulge when pressing the seated occupant, and the seated occupant may be pressed by bringing a member having a regular shape such as a roller-shaped body, a ball-shaped body, and a block-shaped body into contact with the seated occupant.

In addition, in this embodiment, as an auxiliary mechanism for effectively performing posture correction by the air bag as illustrated in FIG. 57, a heater 515 and a vibration application device 516 are provided. The heater 515 corresponds to the warming unit, and warms a predetermined part of the body of the seated occupant who is seated on the vehicle seat S500. When the heater 515 is provided, it is possible to warm the body of the seated occupant from the back side during the posture correction. When the body of the seated occupant is warmed from the back side, the responsiveness (easiness to be pressed) to a pressure (load) of the air bag with respect to the body of the seated occupant is improved, and as a result, the posture correction is more easily performed.

The vibration application device 516 corresponds to a vibration application unit, and applies vibration to a predetermined part of the body (strictly, the back) of the seated occupant who is seated on the vehicle seat S500. When the vibration application device 516 is provided, it is possible to relax tension (tension of muscles) of the back by applying vibration to the back of the seated occupant during the posture correction. According to this, the responsiveness (easiness to be pressed) to a pressure (load) of the air bag with respect to the body of the seated occupant is improved, and as a result, the posture correction is more easily performed.

Note that, in this embodiment, it is assumed that the vibration application device 516 is used to relieve the tension of the seated occupant, but the use of the vibration application device 516 is not limited to the above-described contents. For example, the vibration application device 516 may be used for the purpose of strengthening the muscles of the back of the seated occupant. In addition, the vibration application device 516 can also be used for the purpose of increasing a wakefulness level of the seated occupant when the wakefulness level of the seated occupant is lowered (for example, when the seated occupant is dozing off).

On the other hand, as illustrated in FIG. 58, the condition correction unit 501 includes a control device that controls the operation unit described above (strictly, the actuator 518 or the electromagnetic valve V). The control device consists of an electric control unit (ECU) 541 mounted in the vehicle. The ECU 541 includes a control circuit for posture correction. When the ECU 541 controls ON/OFF of the actuator 518 or the opening degree of the electromagnetic valve V through the control circuit for posture correction, the bulging pressure of each air bag is adjusted. As a result, a pressure (load) corresponding to the bulging pressure of each air pressure is applied to the back of the seated occupant, and the posture of the seated occupant is corrected.

In addition, the ECU 541 communicates with various sensors provided inside the vehicle through an in-vehicle network to acquire measurement values of the various sensors. In other words, the ECU 541 can measure current values of various management items by cooperation with various in-vehicle sensors. In addition, the management items (that is, measurement targets) measured by the ECU 541 include an item relating to a seating state of the seated occupant.

Specifically, a sensor configured to measure the seating state of the seated occupant includes a respiration sensor 531, a bulging pressure sensor 532, a pressure sensor 533, and a weight sensor 534. The sensors are used in a state of being attached to the vehicle seat S500.

With regard to the respective sensors, the bulging pressure sensor 532 and the pressure sensor 533 are sensors provided to specify a physical condition of the seated occupant, specifically, a seating posture. The bulging pressure sensor 532 is provided for every air bag in order to measure a current value of the bulging pressure of each air bag. The pressure sensor 533 is provided for every air bag as in the bulging pressure sensor 532, and is specifically attached to a front surface of each air bag as illustrated in FIG. 58. In addition, the ECU 541 measures current values of indexes for specifying the seating posture of the seated occupant through a plurality of the bulging pressure sensors 532 and a plurality of the pressure sensors 533 while the seated occupant is seated on the vehicle seat S500.

Specifically, in this embodiment, before the seated occupant is seated on the vehicle seat S500, the plurality of air bags (specifically, the shoulder air bag 511a, the lumbar air bag 512a, and the pelvis air bag 513a) bulges until reaching a bulging pressure set in advance. In this state, when the seated occupant is seated on the vehicle seat S500, the bulging pressure of each of the air bag varies. The ECU 541 measures the varied bulging pressure through the bulging pressure sensor 532 for every air bag. Here, the bulging pressure of each air bag (in other words, bulging pressure balance between the air bags) becomes a value corresponding to a seating posture of the seated occupant. That is, the ECU 541 measures a current value of the bulging pressure of each air bag which varies when the seated occupant is seated on the vehicle seat S500 as an index for specifying the seating posture of the seated occupant.

As described above, in this embodiment, the air bags are used not only for posture correction but also measurement of the seating state of the seated occupant, and thus the air bags are more effectively utilized.

In addition, when the seated occupant is seated on the vehicle seat S500, the ECU 541 measures a current value of a pressure applied to the seat back S501 through the pressure sensor 533 provided for every air bag. Specifically, when the seated occupant is seated on the vehicle seat S500 and leans against the seat back S501, when a pressure is applied to front surfaces of the air bags from the back of the seated occupant, the pressure sensor 533 detects the pressure, and the ECU 541 measures the magnitude of the detected pressure by the pressure sensor 533. Here, the pressure measured for every air bag varies depending on an installation site of the air bag. In addition, the pressure balance between the air bags becomes a value corresponding to the seating posture of the seated occupant. That is, the ECU 541 measures a current value of a pressure when the seated occupant is seated on the vehicle seat S500 as an index for specifying the seating posture of the seated occupant.

As described above, in this embodiment, the seating posture of the seated occupant is specified, and two indexes (specifically, the bulging pressure of the air bag, and the pressure applied to the seat back S501) are measured. According to this, the seating posture can be more appropriately specified as compared with a case of measuring only one between the two indexes. More specifically, in a case of specifying the seating posture by measuring only the bulging pressure of the air bag, a bulging pressure that varied when the seated occupant is seated on the vehicle seat S500 is measured. However, even when the bulging pressure varies, it may be difficult to determine whether the variation occurs due to seating or due to other reasons (for example, filling the air bag with air). On the other hand, in a case of specifying the seating posture by measuring only the pressure applied to the seat back S501 by the pressure sensor 533, when the back of the seated occupant does not come into contact with a portion where the air bag is present in the seat back S501 appropriately, measurement by the pressure sensor 533 may not be accurate.

In contrast, in this embodiment, since the seating posture of the seated occupant is specified, and the two indexes are measured, the seating posture of the seated occupant can be more appropriately specified as compared with a case of measuring only the one index. However, there is no limitation thereto, and any one of the two indexes may be measured.

In addition, the ECU 541 measures a seating state other than the seating posture by using the respiration sensor 531 or the weight sensor 534. Specifically, the ECU 541 specifies a wakefulness condition of the seated occupant by using the respiration sensor 531 consisting of a pressure-sensitive resistance type sensor installed at a rear end portion of the seat cushion S502. More specifically, the ECU 541 measures a periodic seating pressure fluctuation (respiratory waveform) that is in synchronous with respiration of the seated occupant by the respiration sensor 531, and the wakefulness condition of the seated occupant is specified from the measurement value. In addition, the ECU 541 measures a load that acts on the vehicle seat S500 by using the weight sensor 534, and presence or absence of the seated occupant is specified from the measurement value.

In addition, the ECU 541 communicates in-vehicle sensors other than the above-described sensors through the in-vehicle network and acquires measurement values of the in-vehicle sensors. That is, the ECU 541 can acquire state information indicating the state of the vehicle in which the vehicle seat S500 is disposed by acquiring not only the physical condition of the occupant but also the measurement values of the in-vehicle sensors.

For example, a vehicle speed sensor 542 that measures a vehicle speed may be provided inside the vehicle, and a current value of a traveling speed (vehicle speed) may be acquired through communication between the ECU 541 and the vehicle speed sensor 542.

In addition, the vehicle seat S500 may be provided with an angle sensor 548 that measures a rearward inclination angle of the seat back S501, that is, a backrest angle α, and the backrest angle α of the vehicle seat S500 may be acquired through communication between the ECU 541 and the angle sensor 548.

Measurement of the backrest angle α may be performed by an angle sensor that directly measures the rearward inclination angle, or in a case where the rearward inclination of the seat back S501 is made by a motor, the backrest angle α may be calculated by counting the number of revolutions of the motor.

In addition, the vehicle seat S500 may be provided with a door sensor 549 that detects opening/closing of a door. The ECU 541 can detect whether or not the door is opened through communication between the door sensor 549 and the ECU 541.

In addition, the ECU 541 can acquire information from a communication device through communication with the communication device other than the in-vehicle devices through the in-vehicle network. Specifically, the ECU 541 acquires information (strictly, identification information to be described later) relating to the seated occupant through communication with a smartphone 544 as a portable terminal carried by the seated occupant. In addition, the ECU 541 acquires information relating to a scheduled distance or a scheduled route of a vehicle that is traveling on the day through communication with a car navigation device 543.

In addition, the ECU 541 acquires information for specifying a traveling location of the vehicle (strictly, information indicating whether or not a vehicle is traveling on an expressway) through communication with an electronic toll collection (ETC) 547 when the vehicle passes through the front of the ETC 547.

In addition, the ECU 541 can be connected to a portable memory 545 that is portable recording medium such as a USB memory and an SD card (registered trademark), and can perform data exchange with the portable memory 545. That is, the ECU 541 can write information stored in the ECU 541 on the portable memory 545, and can read information stored in the portable memory 545.

In addition, the ECU 541 can communicate with a tablet terminal provided inside the vehicle (hereinafter, referred to as an in-vehicle tablet terminal 546), and can display information on a monitor screen (corresponding to a screen) of the in-vehicle tablet terminal 546. More specifically, the in-vehicle tablet terminal 546 is disposed at the periphery of the vehicle seat S500 (strictly, an easy operation position for the seated occupant), and is set on an upper portion of a stanchion that is erected from the vehicle body floor as illustrated in FIG. 57.

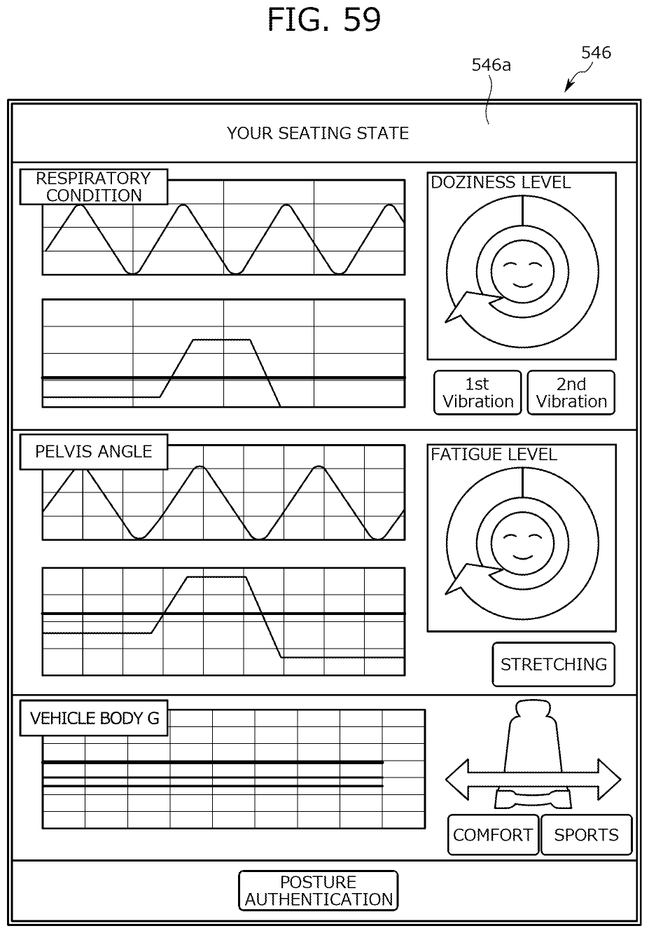

In addition, the ECU 541 generates data (information display data) for displaying image information or character line information, and transmits the information display data to the in-vehicle tablet terminal 546. When receiving the information display data through the in-vehicle network, the in-vehicle tablet terminal 546 develops the information display data and displays information indicated by the same data on a monitor screen. According to this, the seated occupant can confirm various pieces of information transmitted from the ECU 541 on the monitor screen, and can confirm, for example, the seating state measured by the ECU 541 as illustrated in FIG. 59.

In addition, a screen example shown in FIG. 59 is merely an example of a monitor screen, and the design and the screen arrangement are not limited to the example illustrated in FIG. 59 and can be arbitrarily set. In addition, in FIG. 59, information relating to a respiratory condition (strictly, a respiratory waveform or a wakefulness level determination graph), information relating to a pelvis angle (strictly, a variation curve of the pelvis angle and a fatigue level determination graph), and an inclination of a vehicle body (noted as a vehicle body G in the drawing) are displayed as the seating state, but the information displayed on the monitor screen is not limited to the above-described contents.

Note that, the monitor screen of the in-vehicle tablet terminal 546 consists of a touch panel 546a, displays information indicated by the information display data, and accepts a screen operation (touch operation) performed by the seated occupant as an input operation.

In addition, the ECU 541 (specifically, a notification unit 566) communicates with a speaker 570 provided inside the vehicle, and can output a voice as necessary. For example, in a case where appropriate correction processing cannot be performed due to a state of the vehicle, announcement is made to the occupant by using the speaker 570 to bring the state into a state in which the correction processing can be executed. According to this, the occupant changes the state of the vehicle and can bring the state into a state in which correction processing can be executed. More specifically, in a case where the backrest angle α of the vehicle seat S500 exceeds a predetermined angle range in a normal seating state, or in a case where the backrest angle α is not a satisfied angle, there is a possibility that appropriate correction processing cannot be executed. In this case, when an instruction for operation of the correction processing is given, the notification unit 566 can give a notification through the speaker 570 in order to set the backrest angle α within a predetermined angle range in a normal seating state.

In addition, the ECU 541 (more specifically, a projection unit 567) may communicate with a projector 571 provided inside the vehicle, and may project a stereoscopic image to the vicinity of the occupant by using the projector 571. The stereoscopic image according to the projection unit 567 may be configured to be displayed by an AR or VR goggles worn by the occupant.

As the projected stereoscopic image, for example, an AR (augmented reality) or VR character may be displayed as the projected stereoscopic. image, and the displayed character is used as conversation partner for the occupant in a correction state. At this time, when the AR or VR character is displayed in the same correction state as in the occupant, the occupant can sympathize with the state, and can enjoy the correction state.

### <<With Regard to Function of Control Device>>

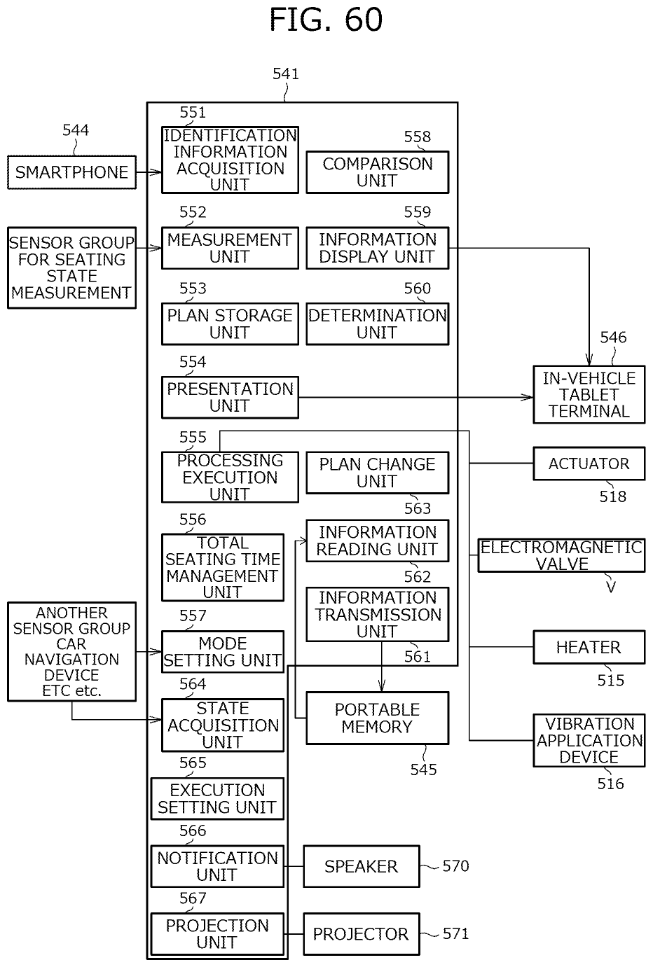

Next, a function of the ECU 541 as a control device will be described with reference to FIG. 60. The ECU 541 is equipped with various functions relating to the posture correction. Specifically, as illustrated in FIG. 60, the ECU 541 includes an identification information acquisition unit 551, a measurement unit 552, a plan storage unit 553, a presentation unit 554, a processing execution unit 555, a total seating time management unit 556, a mode setting unit 557, a comparison unit 558, an information display unit 559, a determination unit 560, an information transmission unit 561, an information reading unit 562, a plan change unit 563, a state acquisition unit 564, and an execution setting unit 565. These functional units are realized when hardware devices (specifically, an MPU and a memory) constituting the ECU 541 cooperate with software devices (control circuit for posture control).

Hereinafter, each of the functional units will be described. Note that, the order of description of the respective functional units is different from the above-described listing order of the functional units.

### (Identification Information Acquisition Unit 551)

The identification information acquisition unit 551 acquires identification information of the seated occupant. Here, the identification information is information for specifying the seated occupant (personal authentication), and for example, ID information of the seated occupant, image information indicating a face image or a fingerprint image of the seated occupant, voiceprint information of the seated occupant, and the like correspond to the identification information.

In addition, in this embodiment, the identification information acquisition unit 551 communicates with the smartphone 544 carried by the seated occupant and acquires identification information from the smartphone 544. According to the configuration, when a person who carries the smartphone 544 is seated on the vehicle seat S500, the ECU 541 communicates with the smartphone 544 and automatically acquires the identification information of the seated occupant. As a result, in this embodiment, the identification information of the seated occupant can be relatively easily acquired.

Note that, a method of acquiring the identification information is not limited to the above-described method. The seated occupant may input the identification information through the in-vehicle tablet terminal 546 or a predetermined input device, and the ECU 541 may receive data relating to the identification information (contents of an input operation) from a device that accepts the input operation to acquire the identification information. Alternatively, a face image of the seated occupant may be captured by a camera provided inside the vehicle, or a voice of the seated occupant may be recorded by a microphone provided inside the vehicle to acquire the identification information. In addition, a sensor for identifying the seated occupant may be provided inside the vehicle (for example, in the vicinity of a handle), and the ECU 541 may acquire the identification information (a detection result of the sensor) from the sensor.

### (Measurement Unit 552)

The measurement unit 552 measures a physical condition of the seated occupant who is seated on the vehicle seat S500, that is, a seating state by using a sensor group that is provided inside the vehicle for seating state measurement. Specifically, the measurement unit 552 measures a current value of the bulging pressure of each air bag which varies when the seated occupant is seated on the vehicle seat S500 by the bulging pressure sensor 532 that is provided for every air bag. In addition, the measurement unit 552 measures a current value of a pressure applied to each portion of the seat back S501 when the seated occupant is seated on the vehicle seat S500 by the pressure sensor 533 that is attached to the front surface of each air bag. In addition, the measurement unit 552 measures a respiratory waveform of the seated occupant by the respiration sensor 531. In addition, the measurement unit 552 measures a load that acts on the vehicle seat S500 by the weight sensor 534.

Note that, with regard to a measurement target or a measurement method by the measurement unit 552, an index for specifying a physical condition of the seated occupant may be measured by a suitable method, and there is no limitation to the above-described contents. For example, a skeletal shape of the seated occupant may be measured by a known shape sensor. Alternatively, the seated occupant may be imaged by an in-vehicle camera, and the captured image may be analyzed to measure a curved condition of a spine, a deformation of a skeleton of the seated occupant, and the like.

As described above, the measurement unit 552 measures a seating state of the seated occupant (specifically, current values of the bulging pressure of each air bag, and the pressure applied to the seat back S501), but in this embodiment, measurement is performed over a plurality of measurement days with respect to the same seated occupant (that is, the seated occupant having the same identification information). More specifically, in a case where a person uses a vehicle on different days, the measurement unit 552 measures a seating state of the person for every date.

Note that, a measurement value for every day which is obtained by the measurement unit 552 is stored as a measurement history. The measurement history is associated with the identification information of the seated occupant, and is managed for every seated occupant.

### (Determination Unit 560)

The determination unit 560 determines a seating posture (the curved condition of the spine) from current values of indexes for specifying the seating posture (specifically, the bulging pressure by the bulging pressure sensor 532 and the pressure measured by the pressure sensor 533) among current values related to the seating state which are measured by the measurement unit 552. More specifically, the determination unit 560 selects a posture among five postures including “stooped”, “slightly stooped”, “ideal posture”, “slightly warped back”, and “warped back”, and sets the selection result as a current seating posture of the seated occupant.

Note that, it is possible to arbitrarily set which range of the current value (that is, the measurement value) of the index which is measured by the measurement unit 552 corresponds to which posture among the five seating postures. In addition, with regard to candidates of the seating posture, there s no limitation to the five postures, and determination can be made in any manner.

### (Plan Storage Unit 553)

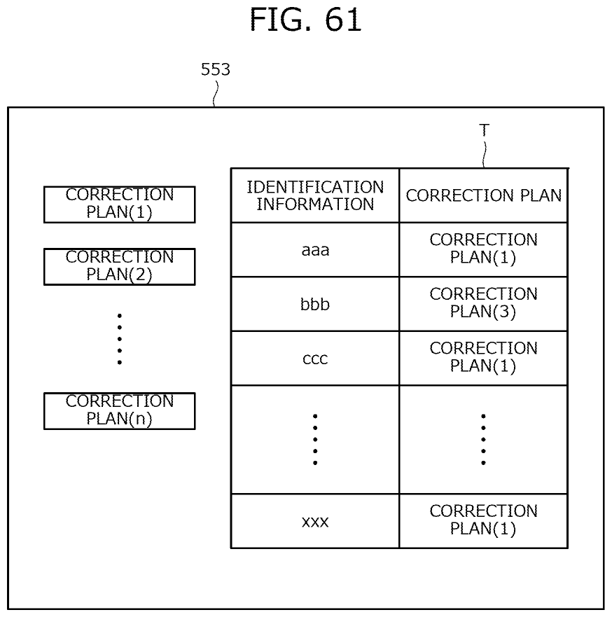

The plan storage unit 553 stores a correction plan that is applied at the time of posture correction. Note that, in this embodiment, a plurality of the correction plans are prepared in advance, and the plan storage unit 553 stores n (n is a natural number equal to or greater than two) pieces of correction plans as illustrated in FIG. 61.

In addition, the plan storage unit 553 stores a plan management table T illustrated in FIG. 61 in combination with the correction plans. The plan management table T is data for managing correction plans set with respect to the seated occupant. More specifically, the plan management table T defines a corresponding relation between identification information of the seated occupant which is acquired by the identification information acquisition unit 551, and a correction plan that is applied when performing posture correction with respect to the seated occupant specified by the identification information. For example, a correction plan (1) is applied when performing posture correction with respect to a seated occupant with identification information of “aaa”.

### (Presentation Unit 554)

The presentation unit 554 reads out a correction plan corresponding to a seating posture determined by the determination unit 560 from the plan storage unit 553, and presents the correction plan to the seated occupant. Here, when the determination unit 560 determines the seating posture, as described above, the determination is made on the basis of a current value relating to the seating state which is measured by the measurement unit 552. The presentation unit 554 may present a correction plan corresponding to the current value relating to the seating state which is measured by the measurement unit 552.

Presentation of the correction plan by the presentation unit 554 will be described in detail. The presentation unit 554 refers to a table (hereinafter, referred to as a correspondence table) that defines a corresponding relation between the seating posture and the correction plan, and selects and presents one correction plan corresponding to the seating posture of the seated occupant which is determined by the determination unit 560. Note that, in the correspondence table, a correction plan suitable for each seating posture is defined for every seating posture, and when the seating posture is determined, a corresponding correction plan is selected on the basis of the correspondence table.

In addition, the correction plan presented to the seated occupant is stored in the plan storage unit 553 in association with the identification information of the seated occupant. That is, the plan storage unit 553 stores the correction plan presented by the presentation unit 554 in association with the identification information of the seated occupant who is seated on the vehicle seat when the presentation unit 554 presents the correction plan. More specifically, when the presentation unit 554 presents the correction plan, a new record is added to the plan management table T that is stored in the plan storage unit 553. The record consists of data associating the correction plan currently presented by the presentation unit 554 and the identification information of the seated occupant at the time of presenting the plan.

### (Processing Execution Unit 555)

The processing execution unit 555 executes processing (hereinafter, referred to as correction processing) of correcting the seating posture. The processing execution unit 555 adjusts the bulging pressure of each air bag by controlling the actuator 518 and the electromagnetic valve V at the time of the correction processing. According to this, the back of the seated occupant is pressed by the air bag, and as a result, the seating posture of the seated occupant is corrected.

In addition, in this embodiment, the processing execution unit 555 specifies the identification information of the seated occupant who is seated on the vehicle seat S500 at the time of the posture correction, and reads out a correction plan associated with the specified identification information from the plan storage unit 553. In addition, the processing execution unit 555 executes the correction processing in correspondence with the correction contents exhibited by the read-out correction plan. As described above, in this embodiment, when correcting the seating posture of the seated occupant, correction is made with the contents exhibited by the correction plan presented to the seated occupant. As a result, the seating posture of the seated occupant is appropriately corrected with the correction contents suitable for the seating posture of the seated occupant.

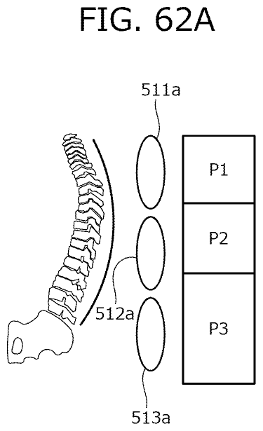

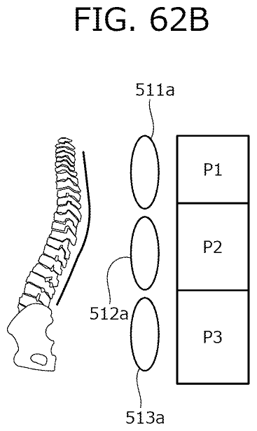

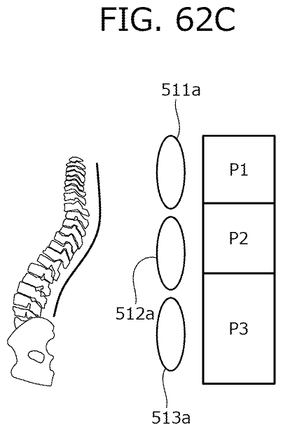

Specifically, in the correction processing, the processing execution unit 555 adjusts the bulging pressure of each of the shoulder air bag 511a, the lumbar air bag 512a, and the pelvis air bag 513a in correspondence with the seating posture determination (the result by the determination unit 560) of the seated occupant. As an example, in a case where the seating posture is stooped, as illustrated in FIG. 62A, the bulging pressure is set to be larger in the order of the shoulder air bag 511a, the lumbar air bag 512a, and the pelvis air bag 513a, and the bulging pressure (indicated by P3 in the drawing) of the pelvis air bag 513a is set to be largest. Note that, in FIG. 62A and FIGS. 62B and 62C to be described later, a view illustrating a positional relationship between the spin and a position of each air bag in each seating posture, and a schematic view illustrating a magnitude relationship of the bulging pressure between air bags are shown.

In contrast, in a case where the seating posture is a warped back, as illustrated in FIG. 62C, the bulging pressure (indicated by P1 in the drawing) of the shoulder air bag 511a is set to be largest, and the bulging pressure (indicated by P2 in the drawing) of the lumbar air bag 512a is set to be smallest. On the other hand, when the seating posture is an ideal posture, as illustrated in FIG. 62B, the bulging pressure of the lumbar air bag 512a is set to be larger than the bulging pressure of the shoulder air bag 511a, and the bulging pressure of the pelvis air bag 513a is set to be slightly larger than the bulging pressure of the lumbar air bag 512a. Note that, the correction contents (a balance of the bulging pressure between air bags) illustrated in FIGS. 62A to 62C are merely one example, and there is no limitation to the contents illustrated in the drawings.

By the way, in this embodiment, when executing the correction processing, the processing execution unit 555 corrects the seating posture of the seated occupant in a correction mode set by the mode setting unit 557 to be described later. Here, the “correction mode” is a specific format (correction procedure) of the posture correction or a correction mode. For example, the degree of a load applied to the body of the seated occupant at the time of the posture correction (strictly, a fluctuation rate of the load, a load application schedule, the magnitude of the load at each time zone, and the like) corresponds to the correction mode. Note that, in this embodiment, the correction mode is set whenever the correction processing is performed in correspondence with a condition of the seated occupant or a schedule on the day, situations of a vehicle and surroundings thereof, and situations to be considered when setting other correction mode.

In addition, when executing the correction processing, the processing execution unit 555 controls the heater 515 to warm the back of the seated occupant (specifically, a part located at a position immediately before the heater 515). In addition, when executing the correction processing, the processing execution unit 555 applies vibration to the back of the seated occupant by controlling the vibration application device 516. According to the configuration, muscles (particularly, muscles of the shoulder, the back, and the waist) of the seated occupant can be relaxed, and the subsequent posture correction is efficiently performed.

### (State Acquisition Unit 564)

The acquisition unit 564 acquires state information of a vehicle in which the vehicle seat S500 is disposed or the vehicle seat S500. Examples of the state information include a plurality of pieces of information indicating a vehicle speed, a traveling mode, a backrest angle of the vehicle seat S500, and an opened/closed state of the vehicle door, respectively.

The vehicle speed is acquired from the vehicle speed sensor 542 mounted in the vehicle.

The traveling mode is information indicating whether the vehicle is in an automatic drive mode or a manual drive mode, and the state acquisition unit 564 acquires information of the traveling mode, for example, from an automatic drive control device 572 that executes automatic drive.

The backrest angle α of the vehicle seat S500 is a rearward inclination angle of the back seat provided in the vehicle seat S500, and can be acquired from the angle sensor 548 provided in a reclining mechanism that causes the backseat to succeed.

The opened/closed state of the vehicle door is acquired from the door sensor 549 mounted in the vehicle.

The state acquisition unit 564 constantly acquires the state information of the vehicle described above. That is, the state information is also acquired before the processing execution unit 555 executes the correction processing, and is also acquired while the correction processing is executed. In addition, the execution setting unit 565 to be described later determines whether or not the processing execution unit 555 may execute the correction processing on the basis of the state information acquired by the state acquisition unit 564, and sets whether or not the correction processing is executable.

Note that, the above-described state information is merely one example, and there is no limitation thereto. For example, the state acquisition unit 564 may acquire the opened/closed state of the vehicle window from a window sensor, and may acquire a position of the vehicle seat S500 in the front to rear direction in a case where the vehicle seat S500 is slidable in the front to rear direction.

### (Execution Setting Unit 565)

The execution setting unit 565 sets whether or not the correction processing is executable on the basis of the state information of the vehicle or the vehicle seat S500 which is acquired by the state acquisition unit 564. The processing execution unit 555 to be described later executes the correction processing in a case where the execution setting unit 565 sets that the correction processing is executable on the basis of the state information. In a case where execution of the correction processing is set as impossible, the processing execution unit 555 does not execute the correction processing or stops the correction processing in a case of being executed.

### <Correction Processing Based on Traveling Mode>

More specifically, in a case where the vehicle speed acquired by the state acquisition unit 564 is 0 km/hour (in a case where the vehicle is stopped), the execution setting unit 565 sets execution of the correction processing as possible. In addition, when the vehicle starts to travel (the vehicle speed exceeds 0 km/hour), the execution setting unit 565 does not allow the processing execution unit 555 to execute the correction processing, or stops the correction processing when the correction processing is being executed.

The processing by the execution setting unit 565 based on the vehicle speed may be performed when the condition correction unit 501 is mounted on a driver's seat and, for example, the vehicle traveling mode is the manual drive mode.

In a case where the vehicle traveling mode is the automatic drive mode, the execution setting unit 565 sets execution of the correction processing as possible even when the vehicle is traveling (the vehicle speed is 0 km/hour or more). At this time, in a case where the vehicle speed reaches a predetermined speed, for example, 60 km/hour or more, the execution setting unit 565 does not allow the correction processing to be executed or stops the correction processing when the correction processing is being executed.

In addition, during execution of the correction processing, in a case where the state acquisition unit 564 shows that the vehicle traveling mode transitions from the automatic drive mode to the manual drive mode, the execution setting unit 565 may set execution of the correction processing as impossible, and the processing execution unit 555 may stop execution of the correction processing.

### <Correction Processing Based on Backrest Angle>

In addition, the execution setting unit 565 may set whether or not the correction processing is executable on the basis of the backrest angle α of the vehicle seat S500. More specifically, in a case where the backrest angle α exceeds an angle range in a normal seating state or is out of the range, the execution setting unit 565 may not allow the correction processing to be executed or may stop the correction processing when the correction processing is being executed.

For example, in a case where the range of the backrest angle in a normal seating state is from 0 degrees to 45 degrees, in a case where the backrest angle α of the vehicle seat S500 exceeds 45 degrees or equal to or less than 0 degrees due to forward inclination, the correction processing is set not to be executed.

In a case where the backrest angle α is out of an angle range in a normal seating state, the execution setting unit 565 sets execution of the correction processing as impossible, but at this time, in a case where an instruction for operation of the correction processing is given, the execution setting unit 565 may give an instruction for the notification unit 566 to make an announcement for returning the backrest angle α to an angle in a normal seating state. In a case where the instruction is given, the notification unit 566 makes an announcement for returning the backrest angle α to the angle in the normal seating state by using the speaker 570.

In addition, in a case where the backrest angle α of the vehicle seat S500 is within the angle range in the normal seating state, when the angle is inclined rearward within the range or the angle is changed to a rearward inclined angle, the execution setting unit 565 may change the contents of the correction processing. For example, the execution setting unit 565 changes an air pressure applied to an air bag in the correction processing to an air pressure higher than a set value (for example, an air pressure higher by 10%). When the setting is changed, it is possible to suppress a deterioration of a correction effect in a case where the seat back is greatly inclined rearward.

### <Correction Processing Based on Door Opened/Closed State>

The execution setting unit 565 may set whether or not the correction processing is executable based on vehicle door opened/closed state acquired by the state acquisition unit 564.

For example, in a case where door opening is detected by the state acquisition unit 564 before executing the correction processing, the execution setting unit 565 sets execution of the correction processing as impossible. In addition, even in a case where an instruction for execution of the correction processing is given from the occupant, the processing execution unit 555 may not execute the correction processing because the door is opened. In addition, even in a case where door opening is detected during execution of the correction processing, the execution setting unit 565 sets execution of the correction processing as impossible, and the processing execution unit 555 may stop the correction processing in execution.

The processing in a case where the door is opened is not limited to stoppage of execution of the correction processing. For example, in a case where the state acquisition unit 564 detects door opening at the time of initiating the correction processing or during execution, the execution setting unit 565 may lower or soften a part of the vehicle seat S500. For example, the height of the seat cushion of the vehicle seat S500 is lowered. Then, the execution setting unit 565 sets execution of the correction processing as possible and the processing execution unit 555 resumes execution of the correction processing.

When the vehicle door is opened, there is a possibility that an occupant may enter or exit the vehicle. Therefore, in a case where the door is in an opened state, when a part of the vehicle seat S500 is lowered or softened, a position of the occupant during correction processing is also lowered, and obstruction on entrance or exiting of the occupant is suppressed.

### <Warming and Vibration Application>

Note that, the body of the occupant may be warmed from the back side by using the heater 515 before executing the correction processing. When the body of the seated occupant is warmed from the back side, the responsiveness (easiness to be pressed) to a pressure (load) of the air bag with respect to the body of the seated occupant is improved, and as a result, the posture correction is more easily performed. In addition, in the posture correction, tension of the back (tension of muscles) may be relaxed by applying vibration to the back of the seated occupant. According to this, the responsiveness (easiness to be pressed) to a pressure (load) of the air bag with respect to the body of the seated occupant is improved, and as a result, the posture correction is more easily performed.

The warming and vibration application with respect to the body of the occupant may be performed after a certain amount of time has been elapsed after the previous correction processing is executed, for example, after 12 hours. Therefore, the execution setting unit 565 acquires an elapsed time T1 after the previous correction processing is performed, determines whether or not a predetermined time T2 or longer has been elapsed, and sets the warming and vibration application to be executed in a case where the predetermined time T2 or longer has been elapsed. In a case where the predetermined time T2 has not been elapsed, the execution setting unit 565 sets the warming and vibration application not to be executed.

In a case where a correction processing execution interval is short, the warming and vibration application processing is omitted to shorten a total time taken for the correction processing.

### (Total Seating Time Management Unit 556)

The total seating time management unit 556 manages a total seating time for every seated occupant. Here, the “total seating time” represents a cumulative value of a seating time for which a seated occupant having the same identification information is seated on the vehicle seat S500. Note that, in this embodiment, the total seating time is managed by using start time of posture correction when the seated occupant undergoes the posture correction for the first time as a reference (starting point). That is, in this embodiment, the total seating time is the same as the cumulative time for which the seated occupant undergoes the posture correction.

In addition, the total seating time management unit 556 stores the total seating time of the seated occupant in association with the identification information of the seated occupant, and specifically, stores a management table (hereinafter, referred to as a total seating time management table) that defines a correspondence relation between the total seating time and the identification information.

Management of the total seating time will be described in detail. When the seated occupant is seated on the vehicle seat S500, the total seating time management unit 556 specifies a total seating time of the seated occupant to the last time on the basis of the identification information acquired by the identification information acquisition unit 551 at that time, and the total seating time management table. On the other hand, the total seating time management unit 556 counts the seating time from a point of time at which the seated occupant is seated on the vehicle seat S500, and adds up the specified total seating time to the last time and a new seating time that is being counted to obtain a current total seating time. In addition, the total seating time management unit 556 updates the total seating time that is associated with the identification information of the seated occupant that is seated on the vehicle seat S500 in the total seating time management table to the currently obtained total seating time.

### (Mode Setting Unit 557)

The mode setting unit 557 sets a correction mode that is applied when the processing execution unit 555 executes the correction processing. In addition, in this embodiment, the mode setting unit 557 sets the correction mode whenever the correction processing is executed as described above. In addition, in this embodiment, the mode setting unit 557 sets the correction mode on the basis of various situations. Specifically, a correction mode corresponding to the following matters (r1), (r2), (r3), (r4), (r5), and (r6) is set.
(r1) Total seating time that is associated with identification information of a seated occupant who is seated on the vehicle seat S500 in the total seating time managed by the total seating time management unit 556
(r2) Age of the sated occupant who is seated on the vehicle seat S500
(r3) Scheduled traveling route along which a vehicle travel on the day
(r4) Day of the week and current time
(r5) Vehicle traveling location (whether or not a vehicle is traveling on an expressway)
(r6) Vehicle traveling speed

As described above, in this embodiment, since the correction mode is set in consideration of the six matters, posture correction is performed in an appropriate mode in consideration of the progress condition of the posture correction (that is, time for which a seated occupant undergoes the posture correction), a schedule of the seated occupant, and the like. Specifically, the seated occupant undergoes the posture correction in a correction mode corresponding to the total seating time up to that point. According to this, a load during correction is appropriately adjusted in correspondence with the total seating time, and for example, the load is suppressed to be low at the beginning of the correction (that is, when the total seating time is relatively short), and the load is gradually increased in combination with an increase in the total seating time.

In addition, in a case where the vehicle travels a relatively long distance, since the seated occupant is seated on the vehicle seat S500 for a long time, the correction mode can be set so that the duration of the posture correction is lengthened than normal time. In addition, in a case of driving a vehicle on a specific day of week (for example, a holiday) or at a specific time (for example, early in the morning), the posture correction can be performed in a correction mode corresponding to the day of the week or time of day. In addition, during a period in which the vehicle travels on the expressway, since the seating posture of the seated occupant is stable, the correction mode can be set so as to apply the load to the seated occupant more frequently.

Note that, among the six matters, (r1), (r4), (r5), and (r6) dynamically vary during a vehicle traveling period. The mode setting unit 557 periodically specifies the four matters during a vehicle traveling period, and appropriately updates the correction mode in correspondence with the specified result. Accordingly, in this embodiment since the correction mode is periodically updated during execution of the correction processing, in a case where the correction mode is changed, the processing execution unit 555 executes the correction processing in a changed correction mode.

In addition, in this embodiment, information relating to (r2) among the six matters is acquired when the seated occupant inputs the information through the in-vehicle tablet terminal 546 or a predetermined input device. However, there is no limitation thereto, and the age of the seated occupant may be acquired by analyzing a face image of the seated occupant captured by a camera installed inside a vehicle, or by measuring information (for example, the number of wrinkles, a bone density, a body fat percentage, or the like) that varies depending on the age in biometric information of the seated occupant by a predetermined sensor. Note that, the age may be a real age, or an age (so-called physical age) determined in correspondence with physical strength and a health condition.

In addition, in this embodiment, the information related to (r3) is acquired by the ECU 541 through communication with the car navigation device 543. However, there is no limitation thereto, and the scheduled traveling route of the vehicle can also be acquired when the seated occupant inputs the scheduled traveling route by the in-vehicle tablet terminal 546 or a predetermined input device.

In addition, in this embodiment, the information relating to (r4) is acquired from a calendar inside the ECU 541 or an internal clock. However, there is no limitation thereto, and the day of the week or the current time can also be acquired by the ECU 541 through communication with an external device or the smartphone 544 of the seated occupant.

In addition, in this embodiment, the information relating to (r5), specifically, information relating to whether or not the vehicle is currently traveling on the expressway is acquired by the ECU 541 by receiving an output signal from the ETC 547 when the vehicle passes through the front of the ETC 547. However, there is no limitation thereto, and the information relating to whether or not the vehicle is currently traveling on the expressway can acquired by a GPS function equipped in the vehicle, the smartphone 544, or the in-vehicle tablet terminal 546. Alternatively, the information can also be acquired when the seated occupant inputs the information by the in-vehicle tablet terminal 546 or a predetermined input device.

In addition, in this embodiment, the information relating to (r6) is acquired when the ECU 541 receives an output signal from the vehicle speed sensor 542. However, there is no limitation thereto, and the vehicle traveling speed can also be acquired when the seated occupant inputs the vehicle traveling speed through the in-vehicle tablet terminal 546 or a predetermined input device.

Note that, in this embodiment, description has been given on the assumption that the correction mode is set in correspondence with the six matters (r1) to (r6), but matters to be considered when setting the correction mode are not limited to the six matters, and only one matter among the six matters may be used. Alternatively, the correction mode may be set in consideration of matters (for example, a condition of the seated occupant, a state of a road surface on which the vehicle is traveling, or the like) other than the six matters.

The correction mode may be further modified on the basis of the above-described vehicle state. For example, the air pressure applied to the air bag in the correction processing may be changed in correspondence with the magnitude of the backrest angle α of the vehicle seat S500. When the correction mode is changed in accordance with the vehicle state information, a deterioration in the correction effect can be suppressed in a case where the seat back of the vehicle seat S500 is greatly inclined rearward.

### (Information Display Unit 559)

The information display unit 559 displays information on a touch panel 546a of the in-vehicle tablet terminal 546. Specifically, the information display unit 559 generates data (information display data) for displaying information, and transmits the data to the in-vehicle tablet terminal 546. When receiving the information display data through an in-vehicle network, the in-vehicle tablet terminal 546 develops the information display data and displays information indicated by the same data on a monitor screen.

The information display data transmitted by the information display unit 559 will be described. Data for displaying a determination result obtained by the determination unit 560 is transmitted as the information display data. That is, in this embodiment, the information display unit 559 displays information indicating the determination result of the determination unit 560, specifically, a current seating posture of the seated occupant. Here, when the determination unit 560 determines the seating posture, as described above, the determination is made on the basis of a current value relating to the seating state measured by the measurement unit 552. In this regard, it can be said that the information display unit 559 displays information corresponding to the current value relating to the seating state measured by the measurement unit 552.

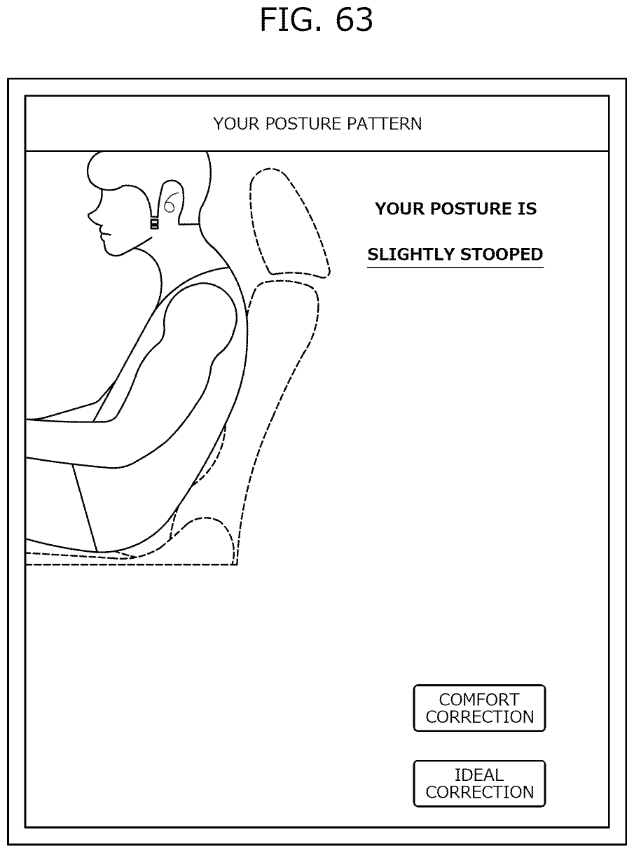

Note that, FIG. 63 illustrates a screen example in which the determination result by the determination unit 560 is displayed. However, the screen illustrated in FIG. 63 is an example of a screen on which the determination result obtained by the determination unit 560 is displayed, and a screen design, a screen arrangement, and displayed information are not limited to the contents shown in FIG. 63.

In addition, the information display data transmitted from the information display unit 559 includes data for displaying a correction plan presented by the presentation unit 554. That is, in this embodiment, the presentation unit 554 presents the correction plan by causing the information display unit 559 to display the correction plan on the screen of the in-vehicle tablet terminal 546.

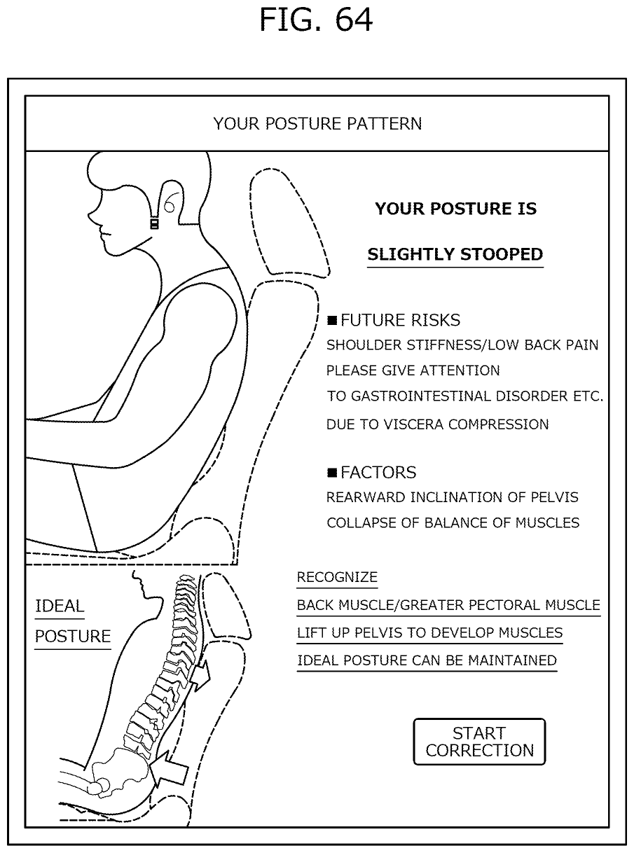

Note that, FIG. 64 illustrates a screen example in which the correction plan presented by the presentation unit 554 is displayed. Here, on the screen, the correction plan includes future risks and factors relating to a current seating posture, an ideal posture and correction contents (in the drawing, a portion where “the back muscles and greater pectoral muscles . . . can be maintained”). However, the display contents when displaying the correction plan on the screen are not limited to the contents shown in FIG. 64. In addition, a design and a screen arrangement of a screen on which the correction plan presented by the presentation unit 554 is displayed are not limited to the contents shown in FIG. 64.

In addition, in this embodiment, it is assumed that the information display unit 559 displays information on the touch panel 546a of the in-vehicle tablet terminal 546, but there is no limitation thereto. For example, the information may be displayed on the smartphone 544 carried by the seated occupant or on other screens (for example, a display of the car navigation device 543) which are mounted inside a vehicle.

### (Comparison Unit 558)

The comparison unit 558 compares a seating state (specifically, a current value of a bulging pressure of each air bag or a pressure applied to the seat back S501) that is measured at an immediately previous measurement date by the measurement unit 552 with respect to the same seated occupant, and a seated state that is measured at a measurement date before the immediately previous measurement date. Specifically, when the seated occupant is seated on the vehicle seat S500, measurement (that is, current measurement) on the seating state by the measurement unit 552 is performed. On the other hand, the comparison unit 558 refers to a measurement history of the seated occupant and reads out a measurement value (first measurement value) of the seating state in the first measurement.

In addition, the comparison unit 558 compares the current measurement value and the first measurement value. When performing the comparison, it is possible to grasp an effect (that is, a posture improvement condition through correction) of posture correction that is performed up to the previous time.

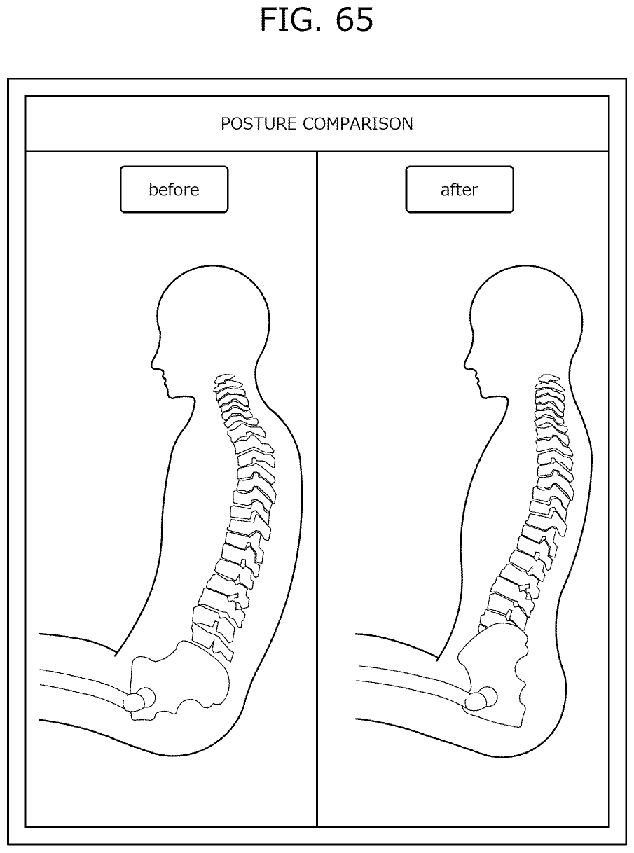

In addition, in this embodiment, as illustrated in FIG. 65, with respect to the current measurement value and the first measurement value which are comparison targets, information corresponding to the measurement values (strictly, images showing a curved condition of the spine which corresponds to each of the measurement value) is displayed on the in-vehicle tablet terminal 546 by the information display unit 559. According to this, the seated occupant can confirm the effect (that is, a posture improvement effect through correction) of the posture correction that is performed up to the previous time through the in-vehicle tablet terminal 546.

Note that, the screen shown in FIG. 65 is merely an example of a screen showing two targets compared by the comparison unit 558, and a screen design, a screen arrangement, and displayed information are not limited to the contents shown in FIG. 65.

### (Plan Change Unit 563)

The plan change unit 563 changes the correction plan that is presented to the seated occupant by the presentation unit 554 as necessary. Strictly, when a predetermined change condition is established, the plan change unit 563 changes the correction that is with plan associated the identification information of the seated occupant who is seated on the vehicle seat S500 when the presentation unit 554 presents the correction plan from one correction plan stored in the plan storage unit 553 to another correction plan.

More specifically, in this embodiment, the posture correction is repeatedly performed over a plurality of dates. In other words, whenever a date on which the seated occupant is seated on the vehicle seat S500 is changed, the correction processing is repeatedly performed with respect to the same seated occupant. In addition, the measurement on the seating state by the measurement unit 552 is also performed whenever the date is changed. That is, the measurement unit 552 remeasures the seating state (specifically, the current values of the bulging pressure of each air bag and the pressure applied to the seat back S501) after the date on which the first correction processing is started.

On the other hand, the plan change unit 563 determines necessity and unnecessity for the plan change on the basis of the seating state (that is, the current measurement value) that is remeasured by the measurement unit 552 whenever a date on which the seated occupant is seated on the vehicle seat S500 is changed after the first correction processing is started. More specifically, when the comparison unit 558 compares the current measurement value and the first measurement value, the plan change unit 563 is notified of the comparison result (for example, a difference between the measurement values). The plan change unit 563 determines whether or not the notified comparison result satisfies a predetermined condition. In addition, the plan change unit 563 changes the correction plan in a case where the condition is established. Specifically, the plan management table T is updated so that the correction plan associated with the identification information of the seated occupant that is a target (strictly, the seated occupant at a point of time at which the correction plan applied in the first correction processing is presented by the presentation unit 554) is changed.

As described above, in this embodiment, after the date on which the correction plan to be applied in the correction processing is determined, the correction plan is reviewed as necessary. According to this, even in a correction plan that is set once can be reviewed appropriately as necessary depending on a correction condition (improvement condition) of the seating posture. Accordingly, the seating posture can be effectively corrected.

Note that, with regard to change of the correction plan, among correction plans stored in the plan storage unit 553, which plan is to be used as a correction plan after change is not particularly limited, but it is preferable to select an optimal plan in consideration of a comparison result when the comparison unit 558 compares the current measurement value and the first measurement value.

### (Information Transmission Unit 561 and Information Reading Unit 562)

The information transmission unit 561 transmits various pieces of information stored in the ECU 541 to the portable memory 545 that is connected to the ECU 541. The information reading unit 562 reads the information from the portable memory 545 that is connected to the ECU 541. That is, in this embodiment, the information stored in the ECU 541 can be transmitted by using the portable memory 545.

Here, the information that is transmitted to the portable memory 545 or read from the portable memory 545 includes the measurement value (strictly, the measurement history including past measurement values) when the measurement unit 552 measures the seating state, the identification information of the seated occupant which is acquired by the identification information acquisition unit 551, the correspondence relation of the correction plan presented by the presentation unit 554 (specifically, the plan management table T), the total seating time that is managed by the total seating time management unit 556, and the correction plan after change when the correction plan is reviewed by the plan change unit 563.

In this embodiment, since the information transmission unit 561 and the information reading unit 562 are provided, when each ECU 541 mounted in different vehicles includes a series of functions (that is, the above-described functional units) relating to the posture correction, information can be transferred (handed over) between the ECUs 541. According to this, for example, when vehicle used are exchanged, the information relating to the posture correction which is stored in the ECU 541 mounted in the previously used vehicle can be taken over to the ECU 541 in a newly used vehicle. As a result, in a new vehicle, a vehicle user (that is, a seated occupant) can take over the posture correction (that is, posture correction that is performed in the same correction plan) having the same correction contents as in the posture correction that is performed in the previously used vehicle.

Note that, in this embodiment, description has been made on the assumption that the portable memory 545 consisting of a USB memory is used as a target to which the information transmission unit 561 transmits information, and from which the information reading unit 562 reads out the information, but there is no limitation thereto. That is, as a substitute for the portable memory 545, the smartphone 544 that is carried by the seated occupant may be used, or the in-vehicle tablet terminal 546 may be used as long as the in-vehicle tablet terminal 546 is configured to be portable.

### Operation Example of Condition Correction Unit

Next, as an operation example of the condition correction unit 501, a flow (posture correction flow) of posture correction by the condition correction unit 501 will be described.

The posture correction flow is mainly divided into a flow when the seated occupant undergoes posture correction for the first time (hereinafter, referred to as a first time flow), and a flow subsequent to the first time flow (hereinafter, referred to as a normal flow). Hereinafter, the first time flow will be described first, and then the normal flow will be described.

### (First Time Flow)

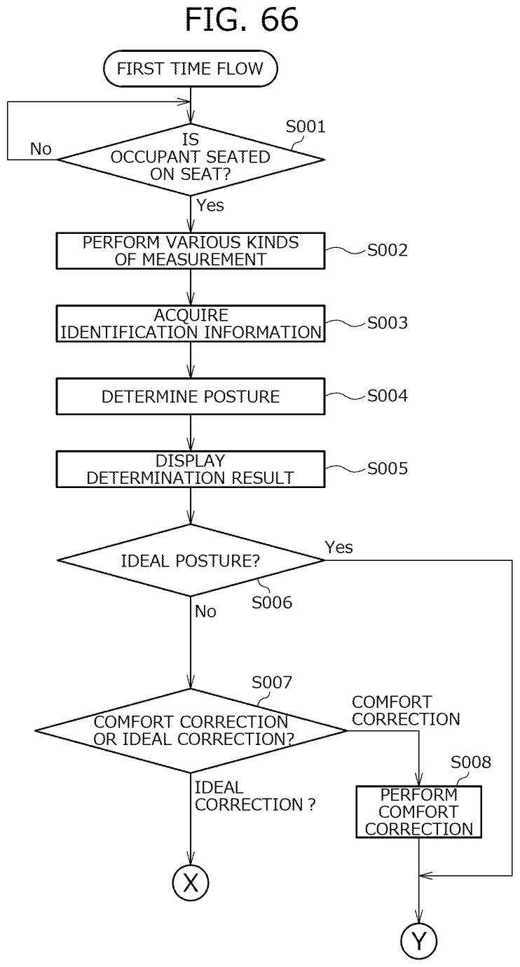

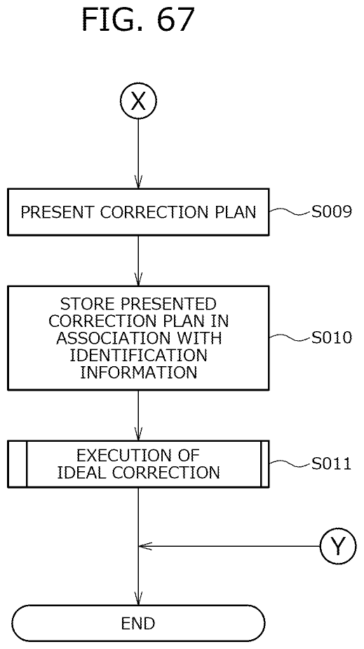

The first time flow proceeds according to a flow shown in FIG. 66 and FIG. 67. Specifically, when the seated occupant is seated on the vehicle seat S500 according to this embodiment for the first time, the first time flow is automatically started (S001). More specifically, when the seated occupant is seated on the vehicle seat S500, the weight sensor 534 outputs a signal corresponding to the magnitude of a seat weight that varies according to the seating. When receiving the output signal from the weight sensor 534, the ECU 541 uses the reception as a trigger to automatically start main processes (processes subsequent to step S002) of the first time flow. Note that, in this embodiment, it is assumed that the first time flow is automatically started at a point of time when the seated occupant is seated on the vehicle seat S500, but there is no limitation thereto, and the first time flow may be started when the seated occupant performs predetermined manipulation/operation after being seated. Here, the manipulation/operation may be set as a trigger.

When the first time flow is started, the ECU 541 (specifically, the measurement unit 552) performs various kinds of measurement including measurement relating to a seating state of the seated occupant (S002). Specifically, the bulging pressure of each air bag is measured by the bulging pressure sensor 532, the pressure applied to each portion of the seat back S501 is measured by the pressure sensor 533, and a seating pressure that varies according to respiration is measured by the respiration sensor 531. Note that, when measuring the bulging pressure of each air bag, the ECU 541 controls the actuator 518 and the electromagnetic valve V to bulge the air bag until reaching a predetermined bulging pressure before the seated occupant is seated on the vehicle seat S500.

Then, the ECU 541 (specifically, the identification information acquisition unit 551) communicates with the smartphone 544 carried by the seated occupant to acquire identification information of the seated occupant from the smartphone 544 (S003). In addition, the ECU 541 (specifically, the determination unit 560) determines a seating posture of the seated occupant from the seating state measured in step S002 (S004). More specifically, the ECU 541 determines that the current seating posture of the seated occupant corresponds to which one of “stooped”, “slightly stooped”, “ideal posture”, “slightly warped back”, and “warped back” on the basis of a current value of the bulging pressure of the air bag, and a current value of the pressure applied to each portion of the seat back S501.

In addition, the ECU 541 (specifically, the information display unit 559) generates information display data for displaying the determined seating posture and transmits the data to the in-vehicle tablet terminal 546. According to this, a determination result of the seating posture is displayed on the touch panel 546a of the in-vehicle tablet terminal 546 (S005).

Then, the ECU 541 performs the subsequent processes in correspondence with the determination result of the seating posture. Specifically, in a case where the determined seating posture is an ideal posture (Yes in S006), the ECU 541 terminates the first time flow. Note that, when the determined seating posture is a posture other than the ideal posture (No in S006), the ECU 541 performs the subsequent processes by using a mode designation operation by the seated occupant as a trigger.

Here, a mode designation operation by the seated occupant will be described. The mode designation operation is an operation that is performed to designate one among a plurality of candidates prepared with respect to a control mode of the ECU 541, and is performed through the touch panel 546a of the in-vehicle tablet terminal 546 in this embodiment. Note that, as the control mode by the ECU 541, two candidates are prepared, and specifically, a “comfort correction” mode and an “ideal correction” mode are set. The “ideal correction” mode is a mode of performing posture correction, and specifically, a mode of controlling the actuator 518, the electromagnetic valve V, and the like to correct the current seating posture to be an ideal posture.

The “comfort correction” mode is a mode for stabilizing the current seating posture as is, and is a mode of controlling the actuator 518, the electromagnetic valve V, and the like so that the current seating posture in the seated occupant is likely to be maintained.

The seated occupant presses any one between two designation buttons (in FIG. 63, buttons with words “comfort correction” and “ideal correction”) displayed in the touch panel 546a in combination with the determination result of the seating posture in order to designate any one between the two control modes. The button operation is a mode designation operation, and the ECU 541 accepts the operation through the in-vehicle tablet terminal 546.

In addition, in a case where the “comfort correction” mode is designated (“comfort correction” in S007), the ECU 541 performs the above-described comfort correction (S008).

On the other hand, in a case where the “ideal correction” mode is designated (“ideal correction” in S007), the ECU 541 performs the above-described ideal correction. When performing the ideal correction, the ECU 541 (specifically, the presentation unit 554) accesses the plan storage unit 553, and reads out a correction plan corresponding to the current seating posture of the seated occupant which is determined in previous step S004 among correction plans stored in the plan storage unit 553. In addition, the ECU 541 presents the read-out correction plan to the seated occupant (S009). More specifically, the ECU 541 (specifically, the information display unit 559) generates information display data for displaying the read-out correction plan, and transmits the information display data to the in-vehicle tablet terminal 546. According to this, the correction plan read out by the ECU 541, that is, the correction plan corresponding to the current seating posture of the seated occupant is displayed on the touch panel 546a of the in-vehicle tablet terminal 546 as illustrated in FIG. 64.

In addition, ECU 541 stores the identification information of the seated occupant which is acquired in previous step S003 in the plan storage unit 553 in association with the presented correction plan (S010). Specifically, the plan management table T is updated so that a record in which the identification information and the correction plan are associated with each other is added to the plan management table T.

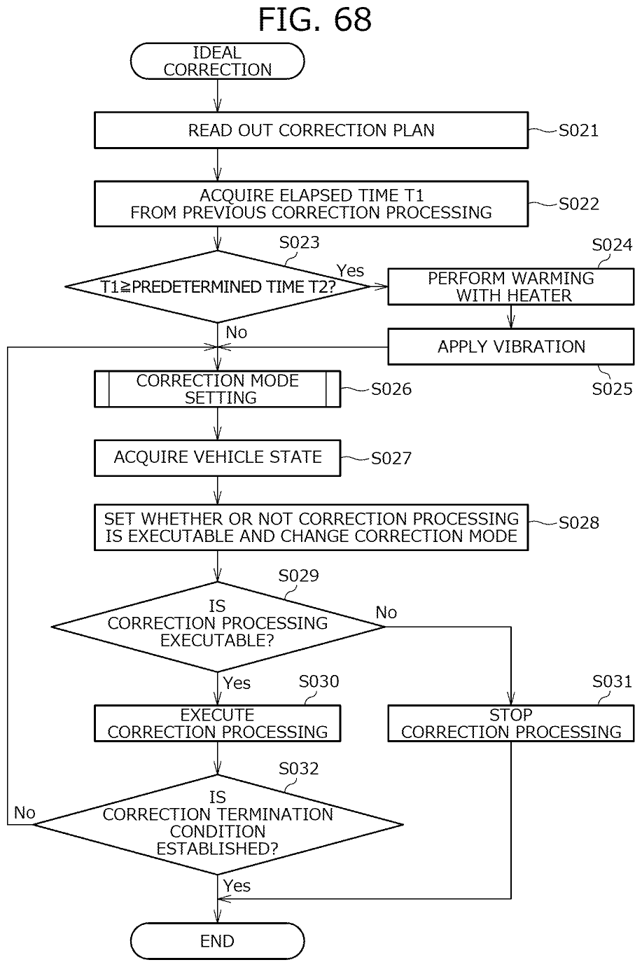

Then, when the seated occupant issues a command for ideal correction in the in-vehicle tablet terminal 546 (specifically, in FIG. 64, a button with words of “correction start” is pressed), the ECU 541 performs the ideal correction by using the pressing as a trigger (S011). The ideal correction proceeds when the ECU 541 performs various steps shown in FIG. 68.

### (Ideal Correction Flow)

Specifically, in the ideal correction, the ECU 541 (specifically, the processing execution unit 555) reads out the correction plan associated with the identification information of the seated occupant who is seated on the vehicle seat S500 from the plan storage unit 553.

Next, the ECU 541 (specifically, the processing execution unit 555) acquires elapsed time T1 from execution of previous correction processing on the basis of the identification information of the seated occupant who is seated on the vehicle seat S500 (S022). In addition, a determination is made as to whether execution of the correction processing is first time or whether or not a predetermined time T2 (for example, 12 hours) has elapsed from execution of the previous correction processing (S023). For example, a determination is made as to whether or not two hours or longer have elapsed from execution of the previous correction processing.

In a case where the elapsed time T1 is equal to or longer than the predetermined time T2 (Yes in S023), the ECU 541 (specifically, the processing execution unit 555) controls the heater 515 to warm a predetermined portion of the back of the seated occupant (S024), and controls the vibration application device 516 to apply vibration to the back of the seated occupant (S025). According to this, the muscles (particularly, muscles of the shoulder, the back, and the waist) of the seated occupant can be relaxed, and the subsequent posture correction can be efficiently performed.

In a case where the elapsed time T1 is shorter than the predetermined time T2 (No in S023), even when warming is performed or vibration is applied with a short interval, an effect of relaxing the muscles is less, and thus this process is omitted and the process transitions to the subsequent process. When warming and vibration application are omitted, time can be shortened.

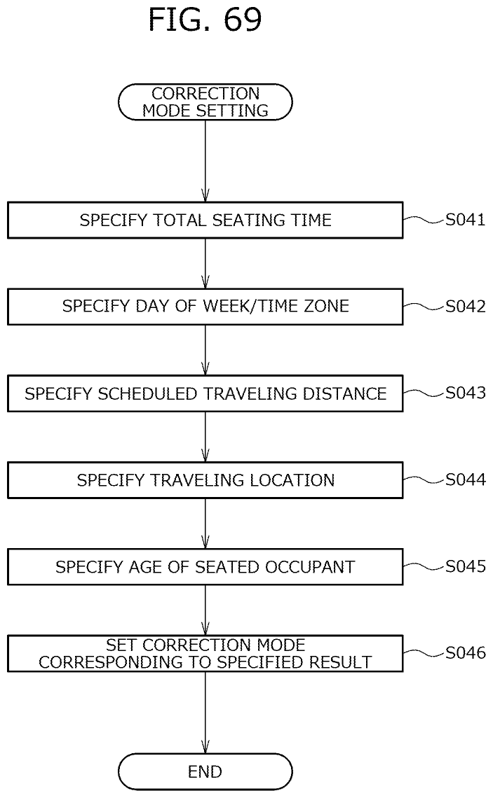

Next, the ECU 541 (specifically, the mode setting unit 557) sets a correction mode to be applied to the correction processing (S026). A step of setting the correction mode will be described. As illustrated in FIG. 69, the ECU 541 (specifically, the total seating time management unit 556) specifies a total seating time of the seated occupant who is seated on the vehicle seat S500 at that point of time (S041). Note that, the total seating time is set to 0 in a step immediately after starting of the first time flow.

Then, the ECU 541 (specifically, the mode setting unit 557) specifies the day of the week and the current time zone (S042). In addition, the ECU 541 (specifically, the mode setting unit 557) specifies a scheduled traveling distance of the vehicle for the date through communication with the car navigation device 543 (S043). In addition, the ECU 541 (specifically, the mode setting unit 557) specifies that a current traveling location of the vehicle, and more specifically, whether or not the vehicle is traveling on the expressway (S044) on the basis of a signal or the like received from the ETC 547. In addition, the ECU 541 (specifically, the mode setting unit 557) specifies the age of the seated occupant which is input by the seated occupant through the in-vehicle tablet terminal 546 (S045). After a series of the specific processes are completed, the ECU 541 (specifically, the mode setting unit 557) sets a correction mode corresponding to the specified results in steps S041 to S045 (S046).

Then, the ECU 541 (specifically, the state acquisition unit 564) acquires a state information indicating the state of the vehicle in which the vehicle seat S500 is disposed or the vehicle seat S500. Specifically, a vehicle speed is acquired from the vehicle speed sensor 542, or a vehicle traveling mode is acquired from the mounted automatic drive control device 572. A door opened/closed state is acquired from the door sensor 549 provided in the vehicle door. In addition, the backrest angle α of the vehicle seat S500 may be acquired from the angle sensor 548.

Then, the ECU 541 (specifically, the execution setting unit 565) sets whether or not the correction processing is executable on the basis of the acquired state information (S028).

For example, in a case where the vehicle speed is 0 km/hour, execution of the correction processing is set as possible. In addition, in a case where a seat on which the condition correction unit 501 is mounted is a driver's seat, execution of the correction processing is set as impossible so that the correction processing during movement is not to be executed during driving.

In addition, even in a case where the vehicle traveling mode is an automatic drive mode, execution of the correction processing is set as possible even during traveling. In addition, in a case where the automatic drive mode transitions to a manual drive mode during traveling, execution of the correction processing is changed into impossible.

In addition, in a case where the backrest angle α of the vehicle seat is a predetermined value or more, execution of the correction processing may be set as impossible. In a case where the vehicle door is opened, execution of the correction processing may be set as impossible.

In step S028, the ECU 541 (specifically, the execution setting unit 565) may change the correction mode to processing corresponding to the state information.

For example, in a case where the backrest angle α of the vehicle seat S500 is an rearward inclined angle within a predetermined angle range that is a normal seating state, or in a case where the backrest angle α is changed to a rearward inclined angle, an air pressure is set to be higher than an air pressure of the air bag that is set as a correction mode by 10%. In this case, a deterioration of a correction effect can be suppressed.

In addition, in a case where the vehicle door is opened, a part of the vehicle seat S500 may be lowered or softened to make occupant's getting on or off easy.

After setting whether or not the correction processing is executable, the ECU 541 (specifically, the processing execution unit 555) executes correction processing on the basis of possibility or impossibility of the correction processing which is set by the execution setting unit 565. In a case where the correction processing is executable (Yes in S029), the ECU 541 (specifically, the processing execution unit 555) executes the correction processing in a correction mode that is set in previous steps S046 and S028 in accordance with correction contents shown by the correction plan read out in previous step S021 (S030). In a case where execution of the correction processing is impossible (No in S029), the ECU 541 (specifically, the processing execution unit 555) does not execute the correction processing. In a case where the correction processing is being executed, the correction processing is stopped (S031).

During execution of the correction processing, the ECU 541 (specifically, the processing execution unit 555) periodically repeats a step of setting the correction mode and a step of executing the correction processing until a correction termination condition is established as shown in FIG. 68 (S032). Note that, the correction termination condition is configured to define timing at which correction for the date (for one day) in the ideal correction is terminated, and examples thereof include elapse of correction time designated in advance, arrival of a vehicle at a destination, and execution of operation for giving an instruction for correction termination by the seated occupant.

In addition, at a point of time at which the correction termination condition is established, the posture correction corresponding to the first time is terminated, and the first time flow is terminated.

### (Normal Flow)

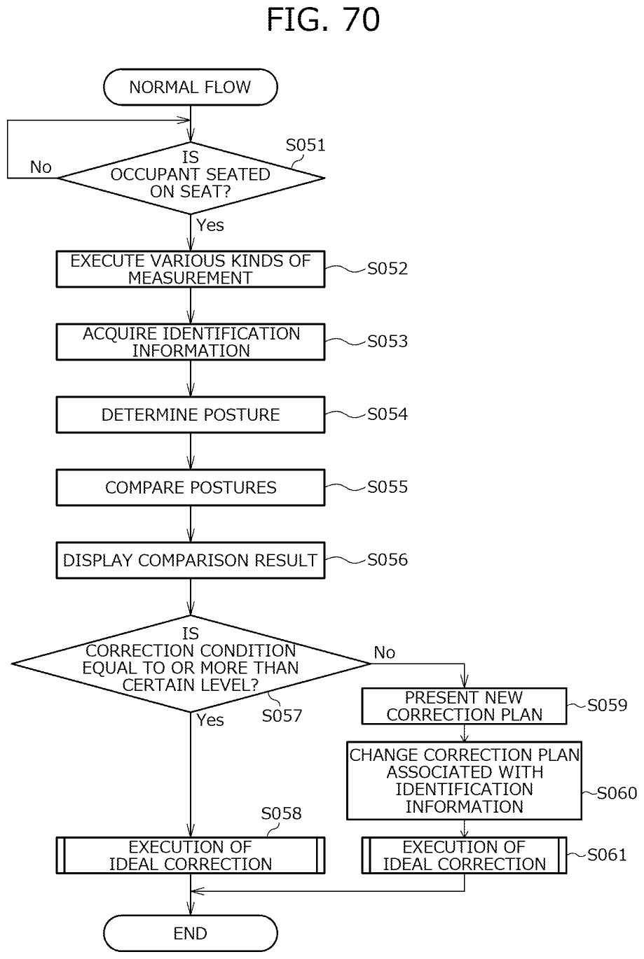

The normal flow is performed after the date on which the first time flow has been performed, and proceeds along a flow shown in FIG. 70. Specifically, as in the first time flow, the normal flow is automatically started at a point of time at which the seated occupant is seated on the vehicle seat S500 (S051). Then, the ECU 541 performs various kinds of measurement relating to the seating state of the seated occupant (S052), acquisition of identification information of the seated occupant (S053), and determination of the seating posture (S054) in the same step as in the first time flow.

As described above, in this embodiment, the ECU 541 performs measurement of the seating state, acquisition of the identification information, and determination of the seating posture as a common routine between the first time flow and the normal flow. In addition, in a case where the acquired identification information matches the previously acquired identification information, the ECU 541 subsequently performs the normal flow in steps shown in FIG. 70. Note that, the description of “the normal flow is performed” represents that measurement of the seating state and determination of the seating posture are performed with respect to the seated occupant having the same identification information over a plurality of dates. In other words, in the normal flow, the seating posture of the seated occupant is remeasured after the date on which the first time flow has been performed.

After determination of the seating posture has been performed in the normal flow, the ECU 541 (specifically, the comparison unit 558) performs posture comparison (S055). Specifically, in the posture comparison, a measurement value (first time measurement value) of the seating state in the first time flow, and a currently measured measurement value (current measurement value) of the seating state in the normal flow are compared with each other.

Then, the ECU 541 (specifically, the information display unit 559) generates information display data for displaying the result of the posture comparison, and transmits the information display data to the in-vehicle tablet terminal 546. According to this, as illustrated in FIG. 65, the comparison result of the seating postures, specifically, image information corresponding to each of the current measurement value and the first time measurement value is displayed on the touch panel 546a of the in-vehicle tablet terminal 546 (S056). Accordingly, the seated occupant grasps an effect of the posture correction (posture improvement condition) undergone up to the previous time through the touch panel 546a.

On the other hand, the ECU 541 (specifically, the plan change unit 563) determines whether or not to change the correction plan applied when correcting the posture of the seated occupant (strictly, the seated occupant who is seated on the vehicle seat S500 at that point of time) in correspondence with the comparison result in previous step S056. Specifically, in a case where a correction condition relating to the seating posture of the seated occupant is specified from the comparison result, and the correction condition is a certain level or more (Yes in S057), the plan change is not performed. In such a case, when performing the ideal correction (that is, posture correction) with respect to the seated occupant having the same identification information, the ECU 541 performs the ideal correction by continuously applying correction plans associated with the identification information (S058).

In contrast, in a case where the correction condition is less than a certain level (No in S057), the ECU 541 (specifically, the presentation unit 554) reads out a correction plan corresponding to the correction condition at that point of time among correction plans stored in the plan storage unit 553, and presents the correction plan to the seated occupant as a new correction plan (S059). In addition, the ECU 541 (specifically, the plan change unit 563) changes the correction plan associated with the identification information of the seated occupant to which the new correction plan is presented (S060). Specifically, the plan management table T is updated so that the above-described plan change is reflected. In addition, the ECU 541 (specifically, the processing execution unit 555) performs the ideal correction (that is, the posture correction) with the changed correction plan (S061).

Note that, in the normal flow, the ideal correction proceeds in the same step (that is, steps shown in FIG. 68) as in the first time flow. In addition, even in the normal flow, a step of setting the correction mode and a step of executing the correction processing are periodically repeated until a correction termination condition is established. In addition, at a point of time at which the correction termination condition is established, the posture correction corresponding to the date is completed, and the normal flow is terminated.

### OTHER EMBODIMENTS

In the above-described embodiment, the condition correction unit of the present invention has been mainly described, but the above-described embodiment is made for easy understanding of the present invention, and is not intended to limit the present invention. That is, the present invention can be modified and improved without departing from the gist of the present invention, and the equivalents are also included in the present invention.

In addition, in the above-described embodiment, it is assumed that a plurality of correction plans are already prepared before the seated occupant is seated on the vehicle seat S500, and are stored in the plan storage unit 553 in advance. However, there is no limitation thereto, and after the seated occupant is seated on the vehicle seat S500, for example, after the seating state of the seated occupant is measured, the correction plan may be newly created by reflecting the measurement value.

In addition, in the above-described embodiment, description has been given of a case in which the posture correction with respect to the same seated occupant is repeatedly performed over a plurality of dates as an example, but there is no limitation thereto. The present invention is applicable to a case where the posture correction is performed with respect to the seated occupant on one-off basis.

In addition, in the above-described embodiment, it is assumed that the condition correction unit 501 of the present invention is mainly used for the purpose of correcting the seating posture of the seated occupant. However, the use of the condition correction unit 501 is not particularly limited, and the condition correction unit 501 may be used for the purpose of correcting physical conditions other than the seating posture, for example, muscle strength, flexibility, deformation of a skeleton, and the like.

Supplementary notes of the second embodiment to the fifth embodiment will be described below.

### Second Embodiment

### (Supplementary Note 1)

A conveyance seat that includes a seat main body including a seat back and a seat cushion, and is capable of being switched between a use state allowing an occupant to be seated, and an accommodation state in which the seat back is folded and the seat main body is moved to a vehicle body floor side, the conveyance seat including:
a cover member that is provided to extend downward from a rear surface of the seat back and that covers a gap between the seat back and the seat cushion or the vehicle body floor in an up to down direction,
wherein the cover member includes,
a first extension member that extends from a rear surface of the seat back and is deformable in correspondence with a folding operation of the seat back, and
a second extension member that extends downward from an extension end portion of the first extension member and covers the gap,
a base end portion of the first extension member is attached to a rear surface of a downward portion of the seat back,
an extension end portion of the second extension member is attached to a rearward portion of the seat cushion or attached to a rearward portion of a base member that supports the seat main body from a downward side,
in the use state,
at least a part of the first extension member is accommodated between the seat back and the second extension member, and
the base end portion in the first extension member is disposed on a downward position as compared with the extension end portion, and
in the accommodation state, the first extension member is exposed to an outer side.

### (Supplementary Note 2)

The conveyance seat according to Supplementary Note 1,
wherein the first extension member comes into contact with a rear surface of the seat back, and
in switching between the use state and the accommodation state, a contact surface that comes into contact with the seat back in the first extension member is switched between the front surface and the rear surface.

### (Supplementary Note 3)

The conveyance seat according to Supplementary Note 1 or 2,
wherein the base end portion of the first extension member
is disposed at an upward position in the accommodation state as compared with the extension end portion, and
moves to a seat forward position as compared with a position in the accommodation state when being switched from the accommodation state to the use state.

### (Supplementary Note 4)

The conveyance seat according to Supplementary Note 3, further including:
a reclining device that rotatably connects the seat back to the vehicle body floor or the seat cushion and locks a rotating operation of the seat back,
wherein the reclining device includes a rotating shaft that becomes a rotation center of the seat back, and
the base end portion of the first extension member is disposed at a seat forward position as compared with the rotating shaft in the use state.

### (Supplementary Note 5)

The conveyance seat according to Supplementary Note 1,
wherein in the use state,
the first extension member is accommodated between the seat back and the second extension member, and
the rear surface of the seat back and the second extension member are in contact with each other.

### (Supplementary Note 6)

The conveyance seat according to Supplementary Note 5,
wherein the accommodation state,
the first extension member is exposed to an outer side, and
the rear surface of the seat back and the second extension member are in contact with each other.

### (Supplementary Note 7)

The conveyance seat according to Supplementary Note 1, further including:
a base member that supports the seat main body from a downward side; and
a reclining device that rotatably connects the seat back to the base member and locks a rotating operation of the seat back may be provided,
wherein an extension end portion of the second extension member is attached to a rearward portion of the base member, and
the second extension member moves in a seat front to rear direction with respect to the base member when being switched from the accommodation state to the use state.

### (Supplementary Note 8)

The conveyance seat according to Supplementary Note 1,
wherein the first extension member
is deformed in correspondence with a folding operation of the seat back, and
is disposed along the rear surface of the seat back in the accommodation state.

### (Supplementary Note 9)

The conveyance seat according to Supplementary Note 1, further including:
a base member that supports the seat main body from a downward side,
wherein the second extension member includes a folded portion that is formed in an extension end portion of the second extension member and is folded upward from the extension end portion, and
the folded portion in the second extension member is attached to a rearward portion of the base member.

### (Supplementary Note 10)

The conveyance seat according to Supplementary Note 1,
wherein the first extension member is made of a flexible member, and
the second extension member is made of a plate-shaped member.

### Third Embodiment

### (Supplementary Note 11)

A conveyance seat provided with an airbag and an inflator according to the present invention, including:
a frame;
a pad disposed on the frame;
a skin which covers the pad and in which a tear line to be fractured when the airbag is deployed is formed at a part;
an attachment member that is provided in the pad;
a first stay cloth which extends from the tear line toward the attachment member of the pad and of which the amount of tensile elongation is smaller as compared with the skin;
a second stay cloth that extends from a part of the skin or the first stay cloth and of which the amount of tensile elongation is smaller as compared with the skin;
a first engagement member that is directly or indirectly connected to the first stay cloth and engages with the attachment member; and
a second engagement member that is directly or indirectly connected to the second stay cloth and engages with an engaged portion provided at a position different from a position of the attachment member in the pad.

### (Supplementary Note 12)

The conveyance seat according to Supplementary Note 21,
wherein the first stay cloth and the second stay cloth are constituted by one sheet of stay cloth.

### (Supplementary Note 13)

The conveyance seat according to Supplementary Note 11 or 12,
wherein the second engagement member has higher hardness or higher heat resistance as compared with the first engagement member.

### (Supplementary Note 14)

The conveyance seat according to any one of Supplementary Notes 11 to 13,
wherein the engaged portion is provided to be located on a further tear line side as compared with the attachment member.

### (Supplementary Note 15)

The conveyance seat according to any one of Supplementary Notes 11 to 14,
wherein a plurality of the attachment members is provided in a height direction of the conveyance seat, and
the second engagement member is disposed between the attachment members adjacent to each other.

### (Supplementary Note 16)

The conveyance seat according to any one of

### Supplementary Notes 11 to 15,

wherein the second engagement member is disposed in a region other than a region where the first stay cloth is disposed.

### (Supplementary Note 17)

The conveyance seat according to any one of Supplementary Notes 1 to 16,
wherein a through-hole through which the second stay cloth passes toward a rear surface side of the pad is formed at a boundary between a bank portion and the seat surface portion of the pad.

### (Supplementary Note 18)

The conveyance seat according to any one of Supplementary Notes 11 to 17,
wherein an assembly through-hole into which an arm for drawing the skin is inserted when assembling the skin to the pad is formed in the vicinity of the attachment member, and the second stay cloth passes through the assembly through-hole and may be taken around to a rear side of the pad.

### (Supplementary Note 19)

A conveyance seat provided with an airbag and an inflator, including:
a frame;
a pad which is disposed on the frame and in which a vertical pull-in groove extending in a height direction of the conveyance seat on a front surface side is formed;
a skin which covers the pad and in which a tear line to be fractured when the airbag is deployed is formed at a part;
an attachment member that is provided in the vertical pull-in groove of the pad;
a first stay cloth which extends from the tear line toward the attachment member of the pad and of which the amount of tensile elongation is smaller as compared with the skin;
a second stay cloth that extends from a part of the skin or the first stay cloth and of which the amount of tensile elongation is smaller as compared with the skin;
a first engagement member that is directly or indirectly connected to the first stay cloth and engages with the attachment member; and
a second engagement member that is directly or indirectly connected to the second stay cloth and engages with an engaged portion disposed at a position different from a position of the vertical pull-in groove in which the attachment member is provided in a seat width direction in the pad.

### (Supplementary Note 20)

The conveyance seat according to Supplementary Note 19,
wherein the first stay cloth and the second stay cloth are constituted by one sheet of stay cloth.

### Fourth Embodiment

### (Supplementary Note 21)

A conveyance seat provided with an airbag and an inflator, including:
a frame;
a pad disposed on the frame;
a skin which covers the pad and in which a fracture portion to be fractured when the airbag is deployed is formed at a part; and
a stay cloth which extends from the fracture portion along a surface of the pad, and of which the amount of tensile elongation is smaller as compared to the skin,
wherein the stay cloth is attached to the surface of the pad with adhesive.

### (Supplementary Note 22)

The conveyance seat according to Supplementary Note 21,
wherein an adhesion region where the stay cloth and the surface of the pad are bonded with the adhesive is provided in a region other than a portion where the fracture portion is provided.

### (Supplementary Note 23)

The conveyance seat according to Supplementary Note 21 or 22,
wherein an end portion opposite to an end portion that is connected to the fracture portion, and the surface of the pad are bonded by the adhesive, and
a non-adhesion region where the stay cloth and the surface of the pad are not bonded with the adhesive is provided between the adhesion region where bonding with the adhesive is performed and the fracture portion.

### (Supplementary Note 24)

The conveyance seat according to Supplementary Note 21 or 22,
wherein the stay cloth is attached to a surface on a rear surface side of the pad with the adhesive.

### (Supplementary Note 25)

The conveyance seat according to Supplementary Note 21 or 22,
wherein the stay cloth is sandwiched between the airbag and the pad.

### (Supplementary Note 26)

The conveyance seat according to Supplementary Note 21 or 22,
wherein the frame includes an arc-shaped portion of which a cross-section is formed in an arc shape on a front surface side of the conveyance seat,
the stay cloth is in contact with the arc-shaped portion of the frame and is disposed along the surface of the pad.

### (Supplementary Note 31)

A conveyance seat provided with an airbag and an inflator, including:
a frame;
a urethane pad that is disposed on the frame; and
a skin that covers the urethane pad,
wherein a tear line along which the airbag is deployed is provided at a part of the skin,
a first stay cloth which extends from the tear line side to the urethane pad side and of which the amount of tensile elongation is smaller as compared with the skin is provided, and
the first stay cloth is bonded and attached to the urethane pad with adhesive.

### (Supplementary Note 32)

The conveyance seat according to Supplementary Note 31,
wherein the adhesive is provided at a site other than the tear line portion.

### (Supplementary Note 33)

The conveyance seat according to Supplementary Note 31,
wherein the adhesive is provided on an end portion side opposite to the tear line portion, and a region not provided with the adhesive is provided between the adhesive and the tear line portion.

### (Supplementary Note 34)

The conveyance seat according to Supplementary Note 31,
wherein the adhesive is provided over the entire region other than the tear line portion.

### (Supplementary Note 35)

The conveyance seat according to Supplementary Note 31,
wherein the skin and the first stay cloth are bonded to each other.

### (Supplementary Note 36)

The conveyance seat according to Supplementary Note 31,
wherein a region where the skin and the first stay cloth are bonded to each other and a region where the urethane pad and the first stay cloth are bonded to each other are approximately the same as each other.

### (Supplementary Note 37)

The conveyance seat according to Supplementary Note 31,
wherein a region where the urethane pad and the first stay cloth are bonded to each other is larger than a region where the skin and the first stay cloth are bonded to each other.

### (Supplementary Note 38)

The conveyance seat according to Supplementary Note 31,
wherein a part of the skin includes a portion that is pulled in a groove portion provided in the urethane pad, and
the adhesive for the first stay cloth is disposed at a portion other than the portion to be pulled in.

### (Supplementary Note 39)

The conveyance seat according to Supplementary Note 31, further including:
a second stay cloth,
wherein the second stay cloth is attached to a portion, which is provided on the urethane pad side and into which the skin is pulled, by a fogless clip, and
the first stay cloth is disposed on an outer side in the seat width direction as compared with the portion where the second stay cloth is pulled in.

### (Supplementary Note 40)

The conveyance seat according to Supplementary Note 31,
wherein the skin includes a seat surface side skin and a side surface side skin,
the first stay cloth is provided on a rear surface of the seat surface side skin, and
a side surface stay cloth that is lined (both ends are sewn) is provided on a rear surface of the side surface side skin.

### (Supplementary Note 41)

A method of assembling a conveyance seat provided with an airbag and an inflator, the conveyance seat including a frame, a urethane pad disposed on the frame, and a skin that covers the urethane pad, a tear line along which the airbag is deployed being provided at a part of the skin, and a first stay cloth which extends from the tear line side to the urethane pad side and of which the amount of tensile elongation is smaller as compared with the skin being provided, the method including:
a step of disposing the skin on the pad; and
a step of bonding and attaching the first stay cloth to the urethane pad with adhesive.

### (Supplementary Note 51)

A conveyance seat provided with an airbag and an inflator, including:
a frame;
a urethane pad provided on the frame; and
a skin that covers the urethane pad,
wherein a tear line along which the airbag is deployed is provided at a part of the skin,
a first stay cloth which extends from the tear line side to the urethane pad side and of which the amount of tensile elongation is smaller as compared with the skin is provided, and
the first stay cloth is bonded and attached to the urethane pad with adhesive.

### (Supplementary Note 52)

The conveyance seat according to Supplementary Note 51,
wherein the adhesive is provided at a site other than the tear line portion.

### (Supplementary Note 53)

The conveyance seat according to Supplementary Note 51,
wherein the adhesive is provided on an end portion side opposite to the tear line portion, and a region not provided with the adhesive is provided between the adhesive and the tear line portion.

### (Supplementary Note 54)

The conveyance seat according to Supplementary Note 51,
wherein the first stay cloth is bonded to a rear surface side of the urethane pad.

### (Supplementary Note 55)

The conveyance seat according to Supplementary Note 51,
wherein the first stay cloth is sandwiched between the airbag and the urethane pad.

### (Supplementary Note 56)

The conveyance seat according to Supplementary Note 51,
wherein the first stay cloth comes into contact with an arc-shaped portion in the frame.

### (Supplementary Note 57)

A method of assembling a conveyance seat provided with an airbag and an inflator, the conveyance seat including a frame, a urethane pad disposed on the frame, and a skin that covers the urethane pad, a tear line along which the airbag is deployed being provided at a part of the skin, and a first stay cloth which extends from the tear line side to the urethane pad side and of which the amount of tensile elongation is smaller as compared with the skin being provided, the method including:
a step of disposing the skin on the urethane pad; and
a step of bonding and attaching the first stay cloth to the urethane pad with adhesive.

### Fifth Embodiment

### (Supplementary Note 61)

A condition correction unit, including:
an operation unit that operates to correct a physical condition of a seated occupant who is seated on a conveyance seat;
a body measurement unit that measures a current value of an index for specifying the physical condition;
a plan storage unit that stores a correction plan showing correction contents of the physical condition;
presentation unit that reads out the correction plan corresponding to the current value from the plan storage unit and presents the correction plan to the seated occupant who is seated on the conveyance seat;
a processing execution unit that controls the operation unit and executes correction processing of correcting the physical condition in correspondence with the correction contents shown by the read-out correction plan;
a state acquisition unit that acquires state information indicating a state of a conveyance in which the conveyance seat is disposed or the conveyance seat; and
an execution setting unit that sets whether or not the correction processing is executable on the basis of the state information,
wherein the processing execution unit executes the correction processing in a case where execution of the correction processing is possible.

### (Supplementary Note 62)

The condition correction unit according to Supplementary Note 61,
wherein in a case where the execution setting unit sets execution of the correction processing as impossible on the basis of the state information during execution of the correction processing, the processing execution unit stops execution of the correction processing.

### (Supplementary Note 63)

The condition correction unit according to Supplementary Note 61,
wherein the state information is information indicating that the conveyance is in an automatic drive mode or a manual drive mode, and
the execution setting unit sets execution of the correction processing as possible in a case where the conveyance is in the automatic drive mode.

### (Supplementary Note 64)

The condition correction unit according to Supplementary Note 63,
wherein in a case where the automatic drive mode transitions to the manual drive mode during execution of the correction processing, the execution setting unit sets execution of the correction processing as impossible, and the processing execution unit stops execution of the correction processing.

### (Supplementary Note 65)

The condition correction unit according to Supplementary Note 61,
wherein the state information is a backrest angle of the conveyance seat,
the execution setting unit changes contents of the correction processing to processing corresponding to the backrest angle in a case where the backrest angle is equal to or more than a predetermined value, and
the processing execution unit executes the correction processing changed by the execution setting unit.

### (Supplementary Note 66)

The condition correction unit according to Supplementary Note 61, further including:
a vibration application unit that applies vibration to a predetermined part of the body of the seated occupant who is seated on the conveyance seat;
wherein the execution setting unit sets whether or not to execute vibrating by the vibration application unit on the basis of elapsed time from the correction processing executed last by the processing execution unit, and
when executing the correction processing again, the processing execution unit applies vibration before execution of the correction processing in a case where execution of vibrating by the vibration application unit is possible, and does not apply vibration in a case where the execution is not possible.

### (Supplementary Note 67)

The condition correction unit according to Supplementary Note 61, further including:
a warming unit that warms a predetermined part of the body of the seated occupant who is seated on the conveyance seat,
wherein the execution setting unit sets whether or not to perform warming by the warming unit on the basis of elapsed time from the correction processing that is executed last by the processing execution unit, and
when executing the correction processing again, the processing execution unit performs warming before execution of the correction processing in a case where execution of warming by the warming unit is possible, and does not perform warming in a case where execution of warming is not possible.

### (Supplementary Note 68)

The condition correction unit according to Supplementary Note 61,
wherein the state information may be information indicating a door opened/closed state of the conveyance,
the state acquisition unit acquires the state information indicating the door opened/closed state before execution of the correction processing or during execution of the correction processing, and
the execution setting unit sets whether or not the correction processing is executable on the basis of the door opened/closed state.

### (Supplementary Note 69)

The condition correction unit according to Supplementary Note 68,
wherein in a case where the door enters an opened state before or during execution of the correction processing, the execution setting unit sets execution of the correction processing as impossible, and
the processing execution unit stops execution of the correction processing.

### (Supplementary Note 70)

The condition correction unit according to Supplementary Note 68,
wherein in a case where the door enters an opened state before or during execution of the correction processing, the execution setting unit changes the correction processing so that the correction processing is executed after a part of the conveyance seat is lowered or softened, and
the processing execution unit executes the correction processing after a part of the conveyance seat is lowered or softened.

### REFERENCE SIGNS LIST

### First Embodiment

S: conveyance seat (vehicle seat)
Sa: seat frame
1: seat back
2: seat cushion
   2a: cushion frame
   2b, 3b: pad member
   2c, 3c: skin material
3: headrest
10, 110: back frame
11: side frame
12: upper frame
13: lower frame
   13a: side wall portion
   13b: bottom wall portion
   13c: frame convex portion
   13d: attachment portion (attachment hole)
14: elastic spring
15: reclining device
20: pad member
21: pad opening hole
30: skin material
31: skin opening hole
32: skin locking member
40, 140: anchor member
41, 141: anchor extension portion
42: anchor connecting portion
50, 150: cover member
60, 160: outer cover
   60a: side wall portion
   60b: front wall portion
   60c: upper wall portion
   60d: bottom wall portion
61, 161: cover accommodation concave portion
   61a, 161a: second side wall portion
   61b, 161b: rear wall portion
   61c, 161c: second upper wall portion
   61d: second bottom wall portion
62, 162: lateral engagement hole
63: upward engagement hole
64: first rearward engagement hole
65: second rearward engagement hole
66, 166: cover convex portion
67, 167: frame attachment portion (attachment protrusion)
68, 168: anchor accommodation hole
   68a: opening hole portion
   68b: accommodation hole portion
   68c: anchor fitting portion
69: flange accommodation concave portion
163: upward contact rib
164: rearward contact rib
165: detachment hole
70, 170: inner cover
   70a, 170a: side wall portion
   70b, 170b: rear wall portion
   70c, 170c: upper wall portion
   70d: bottom wall portion
71, 171: outer peripheral flange
   71a, 171a: stepped concave portion
72, 172: lateral engagement claw
73: upward engagement claw
74: first rearward engagement claw
75: second rearward engagement claw
76: third rearward engagement claw
77, 177: anchor passing hole
78, 178: anchor engagement portion
79 (79A, 79B), 179: contact rib
80, 180: cap
81: hook portion
82: reinforcement bulge portion
83: anchor grip portion
   83a: side wall portion
   83b: upper wall portion
   83c: grip portion
84: vertical rib
85: transverse rib
180a: front wall portion
180b: side wall portion
180c: upper wall portion
180d: bottom wall portion
185: notched hole
H: skin passing hole
R: accommodation space

### Second Embodiment

S200: conveyance seat (vehicle seat)
   Sa200: seat frame
201: seat back
   201a, 202a, 203a: pad material
   201b, 202b, 203b: skin material
202: seat cushion
203: headrest
210: back frame
211: connecting bracket
220: cushion frame
221: side frame
222: pan frame
   222a: attachment hole
223: rearward connecting frame
224: elastic spring
225: connecting link
226: cushion rotating shaft
230: base member
231: side base portion
232: base connecting portion
233: base cover
   233a: cover lateral portion
   233b: cover rearward portion
234: attachment hole
240: reclining device
241: reclining main body
242: back rotating shaft (rotating shaft)
243: spiral spring
244: reclining operation lever
250: rail device
251: lower rail
252: upper rail
260, 2160: cover member
261: first extension member
   261a: base end portion
   261b: extension end portion
262, 2162: second extension member
   262a: base end portion
   262b, 2162b: extension end portion
263: skin (extendable member)
264: plate member (resin plate)
265, 2165: attachment hole
266, 2166: attachment member
2167: folded portion

### Third Embodiment

S300, SA300 to SD300: vehicle seat (conveyance seat)
F300: seat frame (frame)
301: seat cushion
302 to 302D: seat back
   302a: seat surface portion
   302b: bank portion
   302c: side portion
   302d: rear surface portion
303: headrest
304: airbag device
   304a: airbag
   304b: inflator
   304c: case
306, 306D: sewn portion (pull-in line)
307: sewn portion (tear line)
308: slit
309: line fastener
310, 310D: cushion pad (pad)
   310b: rear surface
311: skin
   311a: seat surface covering portion
   311b: bank portion covering portion
   311c: lateral portion covering portion
   311d: rear surface covering portion
313, 313B, 313B′: insert wire
314, 314A to 314D: engaged portion
315: clip (attachment member)
   315a: holding portion
315D: clip (engaged portion)
316: through-hole
   316a: opening portion
317: pull-in groove
   317a, 317c: vertical pull-in groove
   317b: transverse pull-in groove
320, 320′, 320A, 320A′, 320B, 320: stay cloth
321, 321′, 321A, 321A′, 321B, 321C: bank portion-side stay cloth (first stay cloth)
322, 322′, 322A, 322A′, 322B, 322C, 322D: auxiliary stay cloth (second stay cloth)
323: lateral-side stay cloth
331: pull-in member (first engagement member)
   331a: tip end portion
   331b: rear end portion
331D: pull-in member (second engagement member)
332, 332B: trim J-hook (second engagement member)
333: trim plate (second engagement member)
334: concave portion
335: non-woven fabric

### Fourth Embodiment

S400, SA400 to SJ400: vehicle seat (conveyance seat)
F400: seat frame (frame)
   Fa400: arc-shaped portion
   Fb400: flange
401: seat cushion
402, 402A to 402J: seat back
   402a: seat surface portion
   402b: bank portion
   402c: side portion
   402d: rear surface portion
403: headrest
404: airbag device (near-side airbag)
   404a: airbag
   404b: inflator
   404c: case
   404d: bolt
405: airbag device (far-side airbag)
406: sewn portion (pull-in line)
407: fracture portion (tear line)
408: slit
409: line fastener
   410, 410A, 410B: cushion pad (pad)
   410a: bank portion surface
   410b: rear side surface
   410c: lateral portion surface
   410d: cushion side portion
   410e: cushion center portion
   410f: concave portion
411: skin
   411a: seat surface covering portion
   411b: bank portion covering portion
   411c: lateral portion covering portion
   411d: rear surface covering portion
K: boundary portion
412E, 412G, 412I: adhesion region
413, 413A to 413J: upper side guide member
414: lower side guide member
415: clip (attachment member)
   415a: holding portion
416: pull-in member
   417: pull-in groove
   417a: vertical pull-in groove
   417b: transverse pull-in groove
418: slit
419: rear surface side sewn portion
420, 420A to 420J: inner side stay cloth (stay cloth)
421, 421A to 421J: adhesion region
   421a: extension portion
422: inner side stay cloth
423: outer side stay cloth
424: J-hook
425: insert wire
426: upper side guide member
427: lower side guide member
428: sewn portion
430: air cell accommodation portion
431: air cell
   431a, 431b: air bag
433: heater device
434: vibration device
CR: maximum width
CA: central axis

### Fifth Embodiment

501: condition correction unit
511: shoulder support portion
511a: shoulder air bag (operation portion, air bag)
512: lumbar support portion
512a: air bag for lumbar (operation portion, air bag)
513: pelvis support portion
513a: air bag for pelvis (operation portion, air bag)
514: side support portion
515: heater (warming unit)
516: vibration application device (vibration application unit)
518: actuator (operation unit)
531: respiration sensor
532: bulging pressure sensor
533: pressure sensor
534: weight sensor
541: ECU
542: vehicle speed sensor
543: car navigation device
544: smartphone (portable terminal)
545: portable memory
546: in-vehicle tablet terminal
546a: touch panel
547: ETC
548: angle sensor
549: door sensor
551: identification information acquisition unit
552: measurement unit
553: plan storage unit
554: presentation unit
555: processing execution unit
556: total seating time management unit
557: mode setting unit
558: comparison unit
559: information display unit
560: determination unit
561: information transmission unit
562: information reading unit
563: plan change unit
564: state acquisition unit
565: execution setting unit
566: notification unit
567: projection unit
570: speaker
571: projector
572: automatic drive control device
S500: vehicle seat
S501: seat back
S502: seat cushion
S503: headrest
T: plan management table
V: electromagnetic valve

1. A conveyance seat, comprising:
a cover member that protects an anchor member extending from a conveyance main body or a seat main body to an outer side for connection with an object to be connected,
wherein the cover member includes,
an outer cover that is attached to the seat main body and covers the anchor member, and
an inner cover that is attached to the outer cover in a state of being accommodated inside the outer cover, and includes an anchor engagement portion that engages with the anchor member, and
when the cover member engages with the anchor member, an extension portion of the anchor member which extends to an outer side from the conveyance main body or the seat main body is sandwiched between the outer cover and the inner cover.

2. The conveyance seat according to claim 1,
wherein the cover member is configured to protect the anchor member that extends from the conveyance main body or the seat main body to a seat forward side for connection with a child safety seat, and
when the cover member engages with the anchor member, an extension portion of the anchor member which extends to a seat forward side from the conveyance main body or the seat main body is sandwiched between the outer cover and the inner cover in a seat width direction.

3. The conveyance seat according to claim 1,
wherein the inner cover further includes an anchor passing hole into which the anchor member is introduced, and which extends in the extension direction of the anchor member, and
the anchor engagement portion is formed at a portion of the anchor passing hole which is opposite to the anchor member side and extends continuously from the anchor passing hole in a direction intersecting the extension direction of the anchor passing hole.

4. The conveyance seat according to claim 1,
wherein an engagement claw, which engages with an engagement hole provided in the outer cover in a state of being accommodated inside the outer cover, is formed at least one side between both end portions in an up to down direction and both end portions in a width direction in the inner cover.

5. The conveyance seat according to claim 1,
wherein the outer cover includes,
an anchor accommodation hole into which the anchor member is introduced and which accommodates the extension portion of the anchor member when the cover member engages with the anchor member, and
an anchor fitting portion that is formed on an inner surface of the anchor accommodation hole and fits around the extension portion of the anchor member.

6. The conveyance seat according to claim 1,
wherein the cover member detachably engages with the anchor member from a seat forward side, and
a frame attachment portion that protrudes toward a seat frame that is a skeleton of the seat main body and is attached to an attached portion provided in the seat frame is formed on a seat rear end portion of the outer cover.
